(19) United States
(12) Patent Application Publication
(10) Pub. No.: US 2026/0254707 A1
(43) Pub. Date: Aug. 27, 2026

(54) Phased State Synchronization for UALink Network Management

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/648,046

(22) Filed: Apr. 15, 2026

Related U.S. Application Data
(60) Provisional application No. 64/038,992, filed on Apr. 14, 2026.
(60) Provisional application No. 64/031,378, filed on Apr. 6, 2026.
(60) Provisional application No. 64/030,256, filed on Apr. 5, 2026.
(60) Provisional application No. 64/013,582, filed on Mar. 22, 2026.
(60) Provisional application No. 63/991,122, filed on Feb. 25, 2026.
(60) Provisional application No. 63/931,124, filed on Dec. 4, 2025.
(60) Provisional application No. 63/906,709, filed on Oct. 28, 2025.
(60) Provisional application No. 63/895,053, filed on Oct. 7, 2025.
(60) Provisional application No. 63/874,393, filed on Sep. 2, 2025.
(60) Provisional application No. 63/856,653, filed on Aug. 3, 2025.
(60) Provisional application No. 63/826,342, filed on Jun. 18, 2025.
(60) Provisional application No. 63/811,859, filed on May 25, 2025.

(51) Int. Cl. H04L 41/046; H04L 41/0668; H04L 41/0816; H04L 41/16; H04L 69/24

(52) U.S. Cl. CPC H04L 41/046; H04L 41/0668; H04L 41/0816; H04L 41/16; H04L 69/24

(57) ABSTRACT

Implementations for synchronizing state between a centralized controller and a management agent in an Ultra Accelerator Link (UALink)-based network. The centralized controller and the management agent synchronize state through a plurality of ordered phases over a connection. The ordered phases comprise negotiating communication parameters, the management agent transmitting identity information of switches and ports, the centralized controller transmitting intended configuration, the management agent transmitting current operational state, and the centralized controller transmitting forwarding entries for installation on the switches. In some implementations, the connection comprises a bidirectional streaming connection carrying messages with phase identifiers indicating a current protocol phase. The ordered phases may be executed in sequential order, and a connection may be closed upon receiving a message with a phase identifier inconsistent with the current protocol phase.

### CROSS-REFERENCE TO RELATED APPLICATIONS

This Application claims priority to: U.S. Provisional Patent Application No. 64/038,992, filed Apr 14, 2026 that is herein incorporated by reference in its entirety; U.S. Provisional Patent Application No. 64/031,378, filed Apr 6, 2026; U.S. Provisional Patent Application No. 64/030,256, filed Apr 5, 2026; U.S. Provisional Patent Application No. 64/013,582, filed Mar 22, 2026; U.S. Provisional Patent Application No. 63/991,122, filed Feb 25, 2026; U.S. Provisional Patent Application No. 63/931,124, filed Dec 4, 2025; U.S. Provisional Patent Application No. 63/906,709, filed Oct 28, 2025; U.S. Provisional Patent Application No. 63/895,053, filed Oct 7, 2025; U.S. Provisional Patent Application No. 63/874,393, filed Sep 2, 2025; U.S. Provisional Patent Application No. 63/856,653, filed Aug 3, 2025; U.S. Provisional Patent Application No. 63/826,342, filed June 18, 2025; and U.S. Provisional Patent Application No. 63/811,859, filed May 25, 2025.

### BACKGROUND

Artificial intelligence and high-performance computing workloads increasingly rely on systems comprising multiple accelerators, such as GPUs and AI accelerators, interconnected via high-speed links. Ultra Accelerator Link (UALink) is an interconnect technology that enables low-latency communication among accelerators and switches within a network referred to as a UALink Pod. A typical UALink network includes multiple system nodes, each hosting one or more accelerators, coupled to one or more switches that route transactions between accelerators.

Managing the lifecycle of a UALink network involves configuring switches and accelerators, assigning identifiers, establishing forwarding entries in switch route tables, monitoring operational state, and managing partitions of the network for multi-tenant operation. A centralized controller, sometimes referred to as a Pod Controller, may coordinate these management tasks across the network. The centralized controller may communicate with local management agents that reside on switch platforms and system nodes, using management protocols over an out-of-band management network separate from the UALink data-plane network.

Management protocols for network infrastructure include gRPC-based interfaces such as gRPC Network Management Interface (gNMI) and RESTful interfaces such as those conforming to the Distributed Management Task Force (DMTF) Redfish standard. These protocols provide mechanisms for configuration, monitoring, and telemetry collection. gRPC supports multiple remote procedure call patterns, including unary calls, server-streaming, client-streaming, and bidirectional streaming.

As UALink networks scale to hundreds or thousands of accelerators across multiple switch platforms, the centralized controller and its management agents exchange substantial amounts of state information, including device identity, configuration, operational status, and routing data. Coordinating this state exchange in a consistent and predictable manner across an asynchronous management network presents challenges, particularly when devices may change state during the exchange process.

### SUMMARY

In various implementations, a network management system comprises a centralized controller, a management agent associated with one or more switches in a UALink-based network, and a connection between the centralized controller and the management agent. The centralized controller and the management agent are configured to synchronize state through a plurality of ordered phases over the connection. The ordered phases comprise the centralized controller and the management agent negotiating communication parameters, the management agent transmitting identity information to the centralized controller, the centralized controller transmitting intended configuration to the management agent, the management agent transmitting current operational state to the centralized controller, and the centralized controller transmitting forwarding entries to the management agent for installation on the one or more switches.

In other implementations, a method for synchronizing state between a centralized controller and a management agent in a UALink-based network comprises negotiating communication parameters over a connection, receiving identity information of switches and ports from the management agent, transmitting intended configuration to the management agent, receiving current operational state from the management agent, and transmitting forwarding entries for installation on the switches.

In yet other implementations, a network management system comprises a centralized controller, a management agent associated with one or more switches in a UALink-based network, and a bidirectional streaming connection between the centralized controller and the management agent. The bidirectional streaming connection is configured to carry messages in both directions concurrently, each message comprising a phase identifier indicating a current protocol phase. The centralized controller and the management agent are configured to synchronize state over the bidirectional streaming connection through a plurality of ordered phases comprising negotiation of communication parameters including keepalive and dead interval values, transmission of identity information, transmission of intended configuration, transmission of current operational state, and transmission of forwarding entries.

### BRIEF DESCRIPTION OF THE DRAWINGS

FIG. 1A illustrates an implementation of a switch that routes requests and responses among accelerators via UALink-based ports;

FIG. 1B illustrates a method for routing traffic in a switch for a UALink-based accelerator interconnect, which may classify incoming requests based on command type and assign the requests to virtual channels accordingly;

FIG. 2A illustrates a switch for a UALink-based accelerator interconnect that may dynamically adjust virtual channel assignment criteria based on observed credit utilization patterns;

FIG. 2B illustrates a method for managing traffic in a switch for a UALink-based accelerator interconnect, which may monitor credit utilization across virtual channels and adjust assignment criteria when congestion is detected;

FIG. 3A illustrates accelerators communicating via multi-lane links through switches, each link may include a plurality of physical layers coupled to a single data link layer;

FIG. 3B illustrates a method for managing link width in a UALink-based network, which may monitor link utilization and trigger transitions between full-width and folded-width modes based on configurable thresholds;

FIG. 3C illustrates a plurality of accelerators connected to a switch or to multiple switches via UALink-based links, where the power consumed by the link transceivers across the pod may be substantial;

FIG. 3D illustrates a method for managing link width across a plurality of accelerators, which may coordinate link folding decisions based on a combination of centralized policy and local monitoring;

FIG. 4A illustrates accelerators that communicate via multi-lane links through switches, wherein each link may include a plurality of physical layers coupled to a single data link layer;

FIG. 4B illustrates a method for maintaining link resiliency in a UALink-based network, which may couple two physical layers to a single data link layer, transmit data link flits in alternation across both physical layers, and upon detecting a physical layer fault reconfigure to continue operation on the remaining physical layer;

FIG. 4C illustrates a plurality of accelerators connected to a plurality of switches, wherein each switch or partition thereof may constitute a logical switch with its own routing table;

FIG. 4D illustrates a method for managing link degradation in a UALink-based network, which may detect bandwidth reductions caused by physical layer faults and redistribute traffic across alternate logical switches to maintain network throughput;

FIG. 5A illustrates a plurality of accelerators coupled to switches, managed by a centralized controller through management agents residing on the switch platforms;

FIG. 5B illustrates a method for synchronizing state between a centralized controller and a management agent in a UALink-based network;

FIG. 6A illustrates a network management system utilizing a bidirectional streaming connection between a centralized controller and a management agent in a UALink-based network;

FIG. 6B illustrates a method for bidirectional streaming connection for synchronizing state between a centralized controller and a management agent in a UALink-based network;

FIG. 7A illustrates a centralized controller managing a UALink-based network, which may exchange state information with management agents over connections on an out-of-band management network;

FIG. 7B illustrates implementations for maintaining state coherence between a centralized controller and a management agent in a UALink-based network using monotonic timestamps to detect and discard stale state updates;

FIG. 8A illustrates a network management system applying bidirectionally the same timestamp-based staleness detection mechanism;

FIG. 8B illustrates a method for maintaining bidirectional state coherence between a centralized controller and a management agent in a UALink-based network, where the same timestamp-based staleness detection mechanism is applied symmetrically to both operational state updates and forwarding entries;

FIG. 9A illustrates a centralized controller managing a UALink-based network, which may receive identity information and operational state from management agents associated with switches and accelerators, and may use this information to generate forwarding entries that control how switches route transactions between accelerators;

FIG. 9B illustrates a method for establishing connectivity in a UALink-based network by receiving identity information and operational state from management agents, assigning accelerator identifiers, generating forwarding entries, and distributing the forwarding entries to switches via the management agents;

FIG. 10A illustrates a system that manages virtual partitions in a UALink-based network;

FIG. 10B illustrates a method for creating virtual partitions in a UALink-based network by generating forwarding entries that restrict traffic to a designated subset of accelerators and enabling switch ports to carry transactions after the forwarding entries are installed;

FIG. 11A illustrates a management system for a UALink-based network, comprising a centralized controller communicating with different types of management agents via different management protocols;

FIG. 11B illustrates a method for managing a UALink-based network using a three-tier management architecture with differentiated protocols and a hardware abstraction interface;

FIG. 12A illustrates a management system in which a management agent presents a resource tree describing accelerators and their ports to a centralized controller;

FIG. 12B illustrates a method for maintaining a stable resource tree to enable management continuity in a UALink-based network;

FIG. 13A illustrates a centralized controller managing a UALink-based network, which may classify attributes of managed devices into classifications that include identity attributes, configuration attributes, operational attributes, and telemetry attributes;

FIG. 13B illustrates a method for classifying attributes of devices in a UALink-based network and detecting discrepancies between intended state and current observed state;

FIG. 14A illustrates a management system in which each device maintains a corresponding operational attribute for each configuration attribute, enabling the centralized controller to systematically compare intended state with current observed state across all configurable parameters of each device;

FIG. 14B illustrates a method for reconciling state in a UALink-based network after a disconnection of the centralized controller from management agents, by comparing intended configuration attributes with corresponding operational attributes and transmitting corrective configurations where discrepancies are detected;

FIG. 15A illustrates a centralized controller and a security orchestrator operating in a sequenced workflow to configure a UALink-based network for secure workload execution;

FIG. 15B illustrates a method for configuring a UALink-based network by sequencing management-plane configuration before security-plane configuration, ensuring that forwarding entries are installed before encryption keys are configured and that link protection is enabled before workloads execute;

FIG. 16A illustrates a system performing cross-plane topology verification in a UALink-based network;

FIG. 16B illustrates a method for verifying topology integrity by comparing management-plane topology with security-plane topology, configuring encryption keys when the topologies are consistent, and raising security alerts when inconsistencies are detected;

FIG. 17A illustrates a centralized controller that manages a plurality of devices including accelerators and switches, the centralized controller may orchestrate the lifecycle of vendor-defined extensions across the network;

FIG. 17B illustrates a method for managing the lifecycle of vendor-defined extensions in an accelerator network comprising admitted devices coupled by protocol-level interface links;

FIG. 18A illustrates a device supporting vendor-defined extensions within reserved extension spaces;

FIG. 18B illustrates a method for device-side lifecycle for vendor-defined extensions, covering the maintenance, provision, and consumption of extension descriptors;

FIG. 19A illustrates switches performing in-network computation such as reduction operations on data flowing between accelerators;

FIG. 19B illustrates a method for extending the in-network computation capabilities of a switch in an accelerator network through vendor-defined reduction operations;

FIG. 20A illustrates switches that coordinate collective operations among groups of accelerators;

FIG. 20B illustrates a method for configuring vendor-defined collective types on switches in an accelerator network through self-describing behavioral descriptors;

FIG. 21A illustrates accelerators coupled to one or more switches via high-bandwidth links supporting a protocol level interface;

FIG. 21B illustrates a method for validating connectivity in an accelerator interconnect network, which may be performed at each device in the network;

FIG. 22A illustrates a centralized controller that may verify the topology of an accelerator interconnect network at the system level by aggregating neighbor validation results from all devices;

FIG. 22B illustrates a method for verifying topology of an accelerator interconnect network at the system level, which may involve a centralized controller determining an intended physical topology, distributing expected neighbor identifiers to each device, receiving validation results, and verifying consistency before enabling traffic;

FIG. 23A illustrates a centralized controller generating forwarding entries that direct traffic between accelerators through switches;

FIG. 23B illustrates a method for maintaining workload continuity during a management failure, comprising the continued use of forwarding entries stored in switch hardware while the centralized controller is unavailable;

FIG. 24A illustrates system comprising a centralized controller that upon recovery from a failure may execute a reconciliation pipeline to restore management plane consistency; and

FIG. 24B illustrates a method for recovering management of an accelerator interconnect network, which may be executed by a centralized controller upon recovering from a failure.

### DETAILED DESCRIPTION

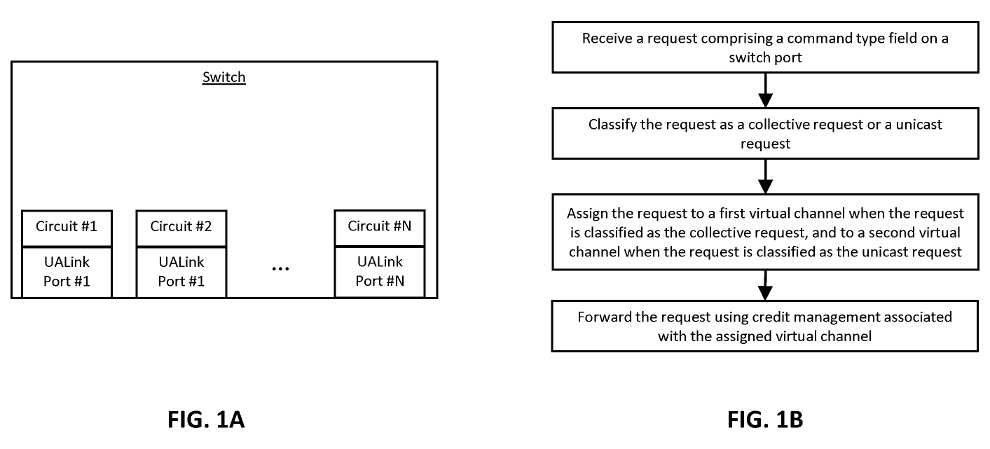

FIG. 1A illustrates an implementation of a switch that routes requests and responses among accelerators via UALink-based ports. The switch may support a plurality of virtual channels on each port to provide differentiated service for different traffic types. When a switch supports multiple virtual channels, the switch may determine which virtual channel to assign to each request. In some implementations, the switch may classify requests based on a command type field to distinguish collective operations, which involve multiple accelerators and may be latency-sensitive, from unicast operations, which involve communication between a pair of accelerators. Collective operations may include in-network collective (INC) operations such as reduction operations, multicast operations, and atomic multicast operations, as well as block collective operations that operate on larger data structures. By assigning collective requests and unicast requests to different virtual channels, the switch may provide independent flow control and buffering for each traffic type, which may reduce interference between collective and unicast traffic, improve collective operation completion times, and increase overall switch throughput. The virtual channel assignment policy may be configured by a centralized controller, such as a Pod Controller, via an out-of-band management interface, enabling coordinated virtual channel management across a pod of accelerators and switches.

In various implementations, a switch for an accelerator interconnect, comprising: a plurality of Ultra Accelerator Link (UALink)-based ports, each port configured to support a plurality of virtual channels; and a circuit configured to: receive a request on one of the plurality of UALink-based ports, the request comprising a command type field; determine, based on the command type field, whether the request is a collective request or a unicast request; and assign the request to a first virtual channel of the plurality of virtual channels when the request is the collective request, and to a second virtual channel of the plurality of virtual channels when the request is the unicast request. The switch may route requests and responses among accelerators in a scale-up accelerator pod comprising up to 1024 accelerators. Each UALink-based port may correspond to a UALink link connecting the switch to an accelerator, and each link may include one or more lanes. The plurality of virtual channels may share the physical link while maintaining independent flow control resources, such as pool credits and virtual channel credits, for each virtual channel. The circuit may inspect the command type field of each incoming request to determine whether the request corresponds to a collective operation or a unicast operation, and may assign the request to the appropriate virtual channel accordingly. The command type field may include a UPLI request command encoding that identifies the type of memory transaction, such as a read, write, atomic, or collective command. The collective request may encompass any request that involves multiple accelerators as participants, including in-network collective operations and block collective operations. The unicast request may encompass any request directed from a single source accelerator to a single destination accelerator, including read, write, and atomic transactions. The circuit may be implemented in hardware as combinational logic, a lookup table, a content-addressable memory (CAM), or a programmable state machine. The method may be implemented in hardware, firmware, software, or combinations thereof, and may be performed by various types of devices including a switch, a processor, or a semiconductor device.

In some implementations of the switch, the collective request comprises at least one of: a UALink Protocol Level Interface (UPLI) ReadReduce command, a UPLI WriteMulticast command, a UPLI WriteFullMulticast command, or a UPLI AtomicNRMulticast command. The UPLI ReadReduce command may perform a reduction operation across multiple accelerators within the switch, combining data from participating accelerators using an arithmetic or logical operation. The UPLI WriteMulticast, WriteFullMulticast, and AtomicNRMulticast commands may distribute data or operations to multiple destination accelerators simultaneously.

In some implementations of the switch, the circuit is further configured to: determine whether the request is a block collective request comprising at least one of a UALink Protocol Level Interface (UPLI) BlockRead command, a UPLI BlockWriteFull command, or a UPLI BlockCollectiveInvoke command; and assign the block collective request to a third virtual channel of the plurality of virtual channels. Block collective operations may transfer larger data structures than standard INC commands, and may involve submission queue entries at the switch. Assigning block collective requests to a separate virtual channel may prevent large block transfers from consuming credits that would otherwise be available for latency-sensitive INC operations or unicast traffic.

In some implementations of the switch, the plurality of virtual channels comprises four UALink Protocol Level Interface-based (UPLI-based) virtual channels identified by a two-bit virtual channel identifier in the request; and wherein the switch is configured to maintain, for each virtual channel of the four UPLI-based virtual channels on each port, separate pool credits and virtual channel credits for flow control. The two-bit virtual channel identifier may be carried in a UPLI-based request virtual channel field. Pool credits may be utilized for any virtual channel, while virtual channel credits may be associated with a specific virtual channel. The receiver may return credits using credit return signals that indicate both the credit type and the virtual channel.

In some implementations of the switch, the switch is configured to prioritize egress arbitration for the first virtual channel over the second virtual channel, such that requests assigned to the first virtual channel have lower egress latency than requests assigned to the second virtual channel. The egress arbitration may utilize weighted round-robin, strict priority, deficit round-robin, or other starvation-free arbitration mechanisms. In some implementations, collective traffic on the first virtual channel may receive higher egress priority than unicast traffic on the second virtual channel to reduce collective operation completion time.

In some implementations, the switch further comprises an accelerator coupled to the switch via a UALink-based link; wherein the accelerator is coupled to a host processor via at least one of CXL or PCIe; and wherein the accelerator is configured to assign requests to virtual channels of the plurality of virtual channels based on a traffic class of a CXL or PCIe transaction received from the host processor. The host processor may assign traffic classes to CXL or PCIe transactions based on application requirements or quality-of-service policies. The accelerator may map these traffic classes to virtual channel identifiers when generating requests on the UALink-based accelerator interconnect, thereby propagating the host-side differentiation into the UALink domain.

In some implementations of the switch, the switch is a UALink-based switch configured to receive a virtual channel assignment policy from a centralized controller via an out-of-band management interface, the virtual channel assignment policy specifying at least one of: a mapping between command types and designated virtual channels, a per-virtual-pod virtual channel partition, or a traffic priority assignment for each virtual channel of the plurality of virtual channels. The centralized controller may include a Pod Controller that manages the configuration and operation of a pod of accelerators and UALink-based switches. The out-of-band management interface may utilize a management protocol, such as gNMI, for distributing configuration attributes to switches and accelerators. The virtual channel assignment policy may be distributed to all switches in the pod or may be customized per switch or per port.

In some implementations of the switch, the switch is a UALink-based switch and the circuit is further configured to assign traffic per virtual pod, such that traffic belonging to a first virtual pod is assigned to a first subset of the plurality of virtual channels and traffic belonging to a second virtual pod is assigned to a second subset of the plurality of virtual channels on a same port. The virtual pod may include a group of accelerators partitioned by the UALink-based switch through non-overlapping subsets of ports. Virtual channel isolation per virtual pod may prevent traffic from one tenant's workload from consuming credits or buffer resources allocated to another tenant's workload on the same physical port.

In some implementations of the switch, the switch is configured to apply an ordering constraint to requests within a same virtual channel while permitting reordering of requests between different virtual channels of the plurality of virtual channels. The ordering constraint within a virtual channel may require that requests to the same 256-byte memory region within the same virtual channel are delivered in order. Requests on different virtual channels may be freely reordered, enabling higher link utilization when traffic on one virtual channel is stalled.

In some implementations, the switch further comprises , for each port of the plurality of UALink-based ports, a separate ingress buffer for each virtual channel of the plurality of virtual channels, such that congestion on the first virtual channel does not block forwarding of requests on the second virtual channel at the port. The separate ingress buffers may be implemented as independent FIFO queues, partitioned SRAM banks, or dynamically allocated buffer pools with per-virtual-channel reservations. Providing separate ingress buffers per virtual channel may prevent head-of-line blocking where a stalled request on one virtual channel delays forwarding of requests destined for other egress ports on a different virtual channel.

FIG. 1B illustrates a method for routing traffic in a switch for a UALink-based accelerator interconnect, which may classify incoming requests based on command type and assign the requests to virtual channels accordingly. The method may further manage egress bandwidth, monitor virtual channel utilization, and respond to congestion or collective operation events. By combining traffic classification with credit-based forwarding, the method may enable differentiated service quality for collective and unicast traffic traversing the switch, while maintaining flow control integrity across all virtual channels.

In various implementations, a method for routing traffic in a switch for an accelerator interconnect comprising a plurality of Ultra Accelerator Link (UALink)-based ports, each port supporting a plurality of virtual channels, comprising: receiving a request on a port of the switch, the request comprising a command type field; classifying the request as a collective request or a unicast request based on the command type field; assigning the request to a first virtual channel of the plurality of virtual channels when the request is classified as the collective request, and to a second virtual channel of the plurality of virtual channels when the request is classified as the unicast request; and forwarding the request on an egress port using credit management associated with the assigned virtual channel. The method may be performed by a switch that connects accelerators in a scale-up accelerator pod. The credit management associated with the assigned virtual channel may prevent the switch from forwarding a request unless sufficient credits are available for the assigned virtual channel at the egress port, preventing buffer overflow at the destination accelerator. The forwarding may further include looking up a route table indexed by a destination accelerator identifier carried in the request to determine the egress port. The classification may be performed at the ingress port, and the virtual channel assignment may travel with the request through the switch core to the egress port. The method may be implemented in hardware, firmware, software, or combinations thereof.

In some implementations, the method further comprises detecting initiation of a collective operation across a plurality of accelerators coupled to the switch; and temporarily increasing egress priority for the first virtual channel for a duration of the collective operation. The initiation of the collective operation may be detected by observing the arrival of collective requests from multiple source accelerators within a time window. The temporary priority increase may remain in effect until the collective operation completes, as indicated by the receipt of all expected responses, or until a configurable timeout expires.

In some implementations, the method further comprises monitoring credit utilization for each virtual channel on each port of the plurality of UALink-based ports; and reporting the credit utilization to a centralized controller via an out-of-band management interface. The credit utilization may be reported as histogram data comprising a plurality of bins, each bin corresponding to a credit utilization range relative to initial credits released. The centralized controller may aggregate credit utilization reports from multiple switches to identify network-wide congestion patterns and adjust virtual channel assignment policies across the pod.

In some implementations, the method further comprises allocating egress bandwidth on each port among the plurality of virtual channels according to configurable weight values, such that a virtual channel assigned a higher weight value receives a proportionally larger share of egress bandwidth than a virtual channel assigned a lower weight value. The configurable weight values may be distributed by a centralized controller as part of a virtual channel assignment policy. The weighted allocation may be implemented using deficit weighted round-robin or similar starvation-free arbitration that provides proportional bandwidth guarantees while permitting unused bandwidth to be utilized by other virtual channels.

In some implementations, the method further comprises detecting congestion on a virtual channel of the plurality of virtual channels at the egress port; and transmitting a congestion notification to a source accelerator coupled to the port, the congestion notification identifying the congested virtual channel. The congestion notification may be carried as a response message, a sideband signal, or a management-plane notification. The source accelerator may respond to the congestion notification by redistributing subsequent requests to a different virtual channel, reducing the request rate, or deferring non-latency-sensitive requests.

In some implementations of the method, the forwarding comprises selecting the egress port based on both a destination accelerator identifier in the request and the assigned virtual channel. The VC-aware routing may enable the switch to route collective traffic and unicast traffic over different physical paths through the switch core, such as through dedicated crossbar lanes or through different switch planes. This may reduce contention between collective and unicast traffic within the switch fabric.

In some implementations of the method, a non-transitory computer-readable medium storing instructions that, when executed by a processor, cause the processor to perform the method.

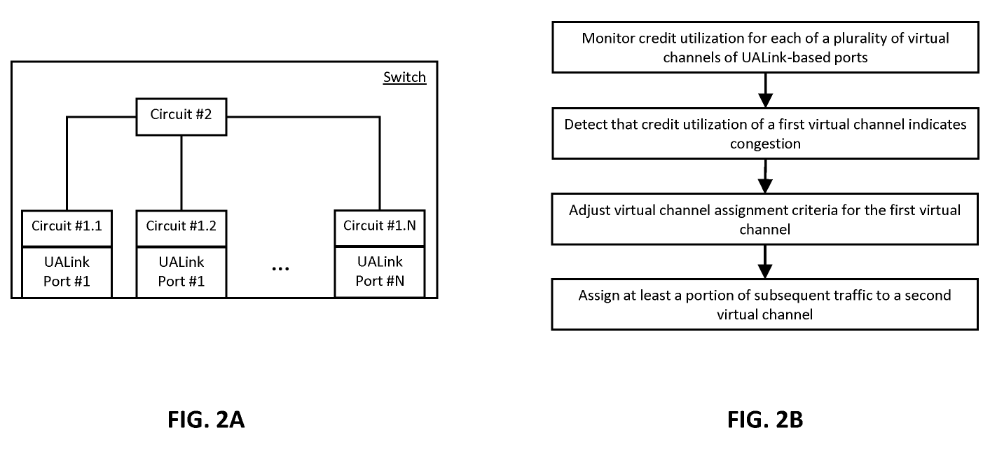

FIG. 2A illustrates a switch for a UALink-based accelerator interconnect that may dynamically adjust virtual channel assignment criteria based on observed credit utilization patterns. When a virtual channel becomes congested, as indicated by depleted credit levels over time, the switch may adjust the criteria by which subsequent traffic is assigned to virtual channels, redirecting a portion of traffic to less congested virtual channels. The switch may monitor credit utilization using histograms that track the proportion of time each virtual channel spends at various credit levels relative to the initial credits released. The adjustment may be governed by configurable congestion thresholds, hysteresis parameters, and workload-aware policies distributed by a centralized controller. This approach may enable the switch to adapt to changing traffic patterns without requiring external intervention for each congestion event.

In various implementations, a switch for an accelerator interconnect, comprising: a plurality of Ultra Accelerator Link (UALink)-based ports; a first circuit configured to monitor credit utilization for each of a plurality of virtual channels on each port of the plurality of UALink-based ports; and a second circuit configured to adjust virtual channel assignment criteria for a first virtual channel of the plurality of virtual channels when credit utilization of the first virtual channel indicates congestion. The first circuit may continuously sample credit counts for each virtual channel on each port and accumulate statistics over time. The second circuit may receive congestion indications from the first circuit and may adjust one or more criteria that govern how incoming traffic is assigned to virtual channels. The adjustment may include modifying the set of UPLI command types assigned to the first virtual channel, changing weight values that govern traffic distribution among virtual channels, redirecting a specific traffic category to a different virtual channel, or modifying threshold parameters that control assignment decisions. The adjustment may be transient, reverting when congestion subsides, or may persist until a new policy is distributed by a centralized controller. The switch may implement the first circuit and the second circuit as hardware logic, firmware, or a combination thereof. Additionally, the second circuit may be implemented as a distributed circuit, with a dedicated instance of the second circuit per port of the plurality of UALink-based ports, or as the illustrated centralized circuit shared across all ports. In the distributed implementation, each port may include a dedicated instance of the second circuit that receives congestion indications from the first circuit of that port and independently adjusts virtual channel assignment criteria for that port. In the illustrated centralized implementation, a single instance of the second circuit may receive congestion indications from the first circuit of each port of the plurality of UALink-based ports, and may apply updated assignment criteria to each port individually, based on per-port congestion state.

In some implementations of the switch, the first circuit monitors credit utilization using a histogram comprising a plurality of bins, each bin corresponding to a credit utilization range relative to initial credits released for the respective virtual channel. The histogram bins may include a zero-credit bin corresponding to a stalled state where no credits are available, and additional bins corresponding to progressively higher credit utilization ranges up to and including a near-idle state where credits exceed a high proportion of the initial credits released.

In some implementations of the switch, congestion of the first virtual channel is indicated when a proportion of time in a zero-credit bin of the histogram exceeds a congestion threshold, the zero-credit bin corresponding to a state in which no credits are available for the first virtual channel. The congestion threshold may be expressed as a percentage of observation time or as a count of histogram samples. When the proportion of time in the zero-credit bin exceeds the congestion threshold, the second circuit may begin adjusting assignment criteria for the congested virtual channel.

In some implementations of the switch, the congestion threshold is dynamically adjusted by a centralized controller based on a workload phase indicator received from a workload orchestrator. The workload orchestrator may include a cluster scheduler, a training framework controller, an inference serving system, or other workload management software. The workload phase indicator may distinguish training phases from inference phases, or may distinguish communication-intensive phases from computation-intensive phases within a training iteration.

In some implementations of the switch, the second circuit is further configured to restore the virtual channel assignment criteria for the first virtual channel when the proportion of time in the zero-credit bin falls below a recovery threshold, the recovery threshold being lower than the congestion threshold. The recovery threshold being lower than the congestion threshold may implement hysteresis that prevents rapid oscillation between adjusted and restored assignment criteria. The gap between the congestion threshold and the recovery threshold may be configurable by a centralized controller.

In some implementations of the switch, the switch is configured to maintain a minimum credit reservation for each virtual channel on each port, the minimum credit reservation preventing credit starvation of any virtual channel regardless of congestion on other virtual channels of the plurality of virtual channels. The minimum credit reservation may guarantee that each virtual channel retains a configurable minimum number of credits, even when other virtual channels are consuming the majority of available pool credits. This may provide forward progress guarantees for traffic remaining on a congested virtual channel after criteria adjustment.

In some implementations of the switch, the switch is a UALink-based switch and the second circuit is configured to receive a congestion response policy from a centralized controller via an out-of-band management interface, the congestion response policy specifying at least one of: a congestion indication threshold per virtual channel, a set of traffic types subject to virtual channel adjustment, or a maximum proportion of traffic subject to virtual channel adjustment. The congestion response policy may constrain the adjustment behavior of the UALink-based switch to prevent overly aggressive redistribution. For example, the maximum proportion of traffic subject to adjustment may limit the second circuit to redirecting at most a specified fraction of incoming traffic to alternate virtual channels, ensuring that the congested virtual channel is not entirely drained of its assigned traffic types.

FIG. 2B illustrates a method for managing traffic in a switch for a UALink-based accelerator interconnect, which may monitor credit utilization across virtual channels and adjust assignment criteria when congestion is detected. The method may detect congestion by comparing credit utilization statistics against configurable thresholds, and may adjust the criteria by which subsequent traffic is distributed among virtual channels to alleviate the congestion. The adjusted criteria may direct different categories of workload traffic to different virtual channels based on the characteristics of the traffic, such as latency sensitivity, bandwidth requirements, or burst patterns. The method may enable the switch to adapt virtual channel utilization to the specific workload patterns of AI training, AI inference, or mixed workloads executing on the accelerators coupled to the switch.

In various implementations, a method for managing traffic in a switch for an accelerator interconnect comprising a plurality of Ultra Accelerator Link (UALink)-based ports, the method comprising: monitoring credit utilization for each of a plurality of virtual channels on each port of the plurality of UALink-based ports; detecting that credit utilization of a first virtual channel indicates congestion; adjusting virtual channel assignment criteria for the first virtual channel; and assigning, based on the adjusted virtual channel assignment criteria, at least a portion of subsequent traffic to a second virtual channel of the plurality of virtual channels. The method may be performed by a switch that connects accelerators in a scale-up accelerator pod. The monitoring may include sampling credit counts for each virtual channel at periodic intervals and accumulating statistics over a configurable observation window. The congestion detection may be based on credit utilization metrics such as time spent at zero credits, average credit utilization, or rate of credit depletion. The adjusting may modify one or more assignment criteria including UPLI command type mappings, source accelerator assignments, traffic category boundaries, or weight values governing proportional traffic distribution. The assigning of subsequent traffic to the second virtual channel may redistribute a portion of traffic that would otherwise have been assigned to the first virtual channel, thereby reducing credit pressure on the first virtual channel. The method may be implemented in hardware, firmware, software, or combinations thereof.

In some implementations of the method, the switch services a plurality of accelerators executing a distributed training workload; and wherein the adjusted virtual channel assignment criteria assign a gradient reduction operation to the first virtual channel and a model parameter broadcast operation to the second virtual channel. The gradient reduction operation may include an all-reduce collective that aggregates gradient tensors from all participating accelerators during backpropagation. The model parameter broadcast operation may distribute updated model parameters from a parameter server or a root accelerator to all participating accelerators. Assigning these operations to different virtual channels may prevent bursty broadcast traffic from consuming credits needed by latency-sensitive reduction operations.

In some implementations of the method, the switch services a plurality of accelerators executing a model inference workload; and wherein the adjusted virtual channel assignment criteria assign a key-value cache transfer to the first virtual channel and a token generation request to the second virtual channel. The key-value cache transfer may carry attention state data between accelerators hosting different layers or segments of a model. The token generation request may carry embedding data for predicting the next token in a sequence. Assigning these to different virtual channels may prevent large cache transfers from increasing latency of time-sensitive token generation.

In some implementations of the method, the key-value cache transfer comprises a request carrying attention key data or attention value data of a transformer attention mechanism; and wherein the token generation request comprises a request for a token embedding for next-token prediction in the model inference workload. The attention key data and attention value data may be generated by self-attention layers of a transformer model and may be transferred between accelerators when the model is partitioned across multiple accelerators using pipeline parallelism or tensor parallelism. The token embedding may represent a vector encoding of a token position within the model's vocabulary.

In some implementations of the method, the switch services a plurality of accelerators executing a mixture-of-experts model comprising a gating network and expert sub-networks distributed across the plurality of accelerators; and wherein the adjusted virtual channel assignment criteria direct expert activation requests from the gating network to the second virtual channel when the first virtual channel is congested. The gating network may select a subset of expert sub-networks for each input token, generating bursty traffic directed to the accelerators hosting the selected experts. When the first virtual channel is congested, redirecting expert activation requests to the second virtual channel may maintain throughput for other traffic remaining on the first virtual channel while providing an alternate flow control path for the expert activation traffic.

In some implementations of the method, a non-transitory computer-readable medium storing instructions that, when executed by a processor, cause the processor to perform the method.

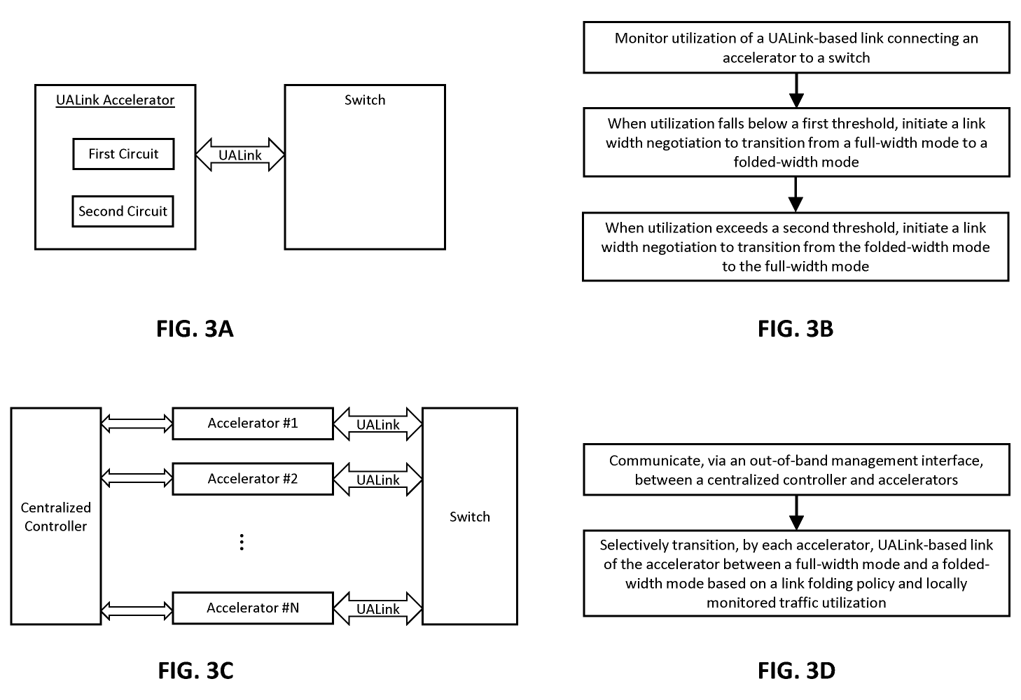

FIG. 3A illustrates accelerators communicating via multi-lane links through switches, each link may include a plurality of physical layers coupled to a single data link layer. The physical layers may operate in a time-division multiplexed mode where data link flits alternate between physical layers. When traffic demand on a link is low, the SerDes transceivers of all physical layers continue consuming power at the full active rate, even though the available bandwidth exceeds the demand. In some implementations, an accelerator may include a first circuit and a second circuit that together monitor link utilization and trigger transitions between a full-width mode, where all physical layers are active, and a folded-width mode, where at least one physical layer is placed in a low-power state. The transition may be triggered based on configurable utilization thresholds, with a first threshold for folding and a second threshold for unfolding. A duration qualifier may prevent premature folding on transient traffic dips. The second circuit may initiate transitions via a link width negotiation protocol that coordinates the transition with the switch at the opposite end of the link, and may include a priority indicator for urgent transitions caused by thermal or power excursions. The transition to full-width mode may be achieved without physical layer link training, using rapid alignment markers for fast receiver lock.

In various implementations, an accelerator for a UALink-based network, comprising: a UALink-based link connecting the accelerator to a switch, the UALink-based link comprising a plurality of physical layers coupled to a single data link layer; a first circuit configured to monitor utilization of the UALink-based link; and a second circuit configured to: when the utilization falls below a first threshold for a first duration, initiate a link width negotiation to transition the UALink-based link from a full-width mode to a folded-width mode by placing at least one physical layer of the plurality of physical layers in a low-power state; and when the utilization exceeds a second threshold, initiate a link width negotiation to transition the UALink-based link from the folded-width mode to the full-width mode. The accelerator may be a computing device such as a GPU, an AI accelerator, or a data processing unit connected to the switch via the UALink-based link. The plurality of physical layers may include two physical layers coupled to the single data link layer, where data link flits are transmitted in round-robin alternation between the two physical layers during full-width operation. The first circuit may sample utilization at periodic intervals and compare the sampled values against the first and second thresholds. The first duration may be a configurable hold-off period that prevents folding in response to transient traffic dips. The link width negotiation may include a data link control message exchanged between the accelerator and the switch. The low-power state may include powering down SerDes transmit and receive circuits of the at least one physical layer. The method may be implemented in hardware, firmware, software, or combinations thereof, and may be performed by various types of devices including an accelerator, a processor, or a semiconductor device.

In some implementations of the accelerator, the link width negotiation comprises a three-phase handshake comprising: transmitting a request from the accelerator to the switch, receiving an acknowledgment from the switch, and transmitting a confirming acknowledgment from the accelerator to the switch. The three-phase handshake may provide coordination between the accelerator and the switch before initiating physical layer power state changes. The switch may respond with an acknowledgment, a negative acknowledgment, or a decision-pending indication. A response may be transmitted within a specified time limit.

In some implementations of the accelerator, the low-power state comprises a data link power-down state in which a reconciliation sublayer of the at least one physical layer transmits power-down control flits; and wherein after a predetermined number of the power-down control flits are transmitted and at least one power-down control flit is received, transmit and receive circuits of the at least one physical layer are placed in the low-power state. The reconciliation sublayer may generate power-down control flits using a dedicated block type encoding. The predetermined number may be a fixed count that provides sufficient indication to the link partner that the physical layer is transitioning to the low-power state. Link fault signaling may be suspended during the data link power-down state.

In some implementations of the accelerator, transitioning from the folded-width mode to the full-width mode does not require physical layer link training or auto-negotiation on the at least one physical layer being restored to the full-width mode; and wherein the accelerator is configured to transmit rapid alignment markers on the at least one physical layer being restored, to enable alignment lock at the switch without link training. The rapid alignment markers may be transmitted at a higher frequency than standard alignment markers, enabling faster receiver alignment lock on the powering-up physical layer. The target power-up time from the folded-width mode to the full-width mode may be less than 250 microseconds, which may be substantially faster than a full link training sequence.

In some implementations of the accelerator, the link width negotiation includes a priority indicator; and wherein when the priority indicator is asserted, the switch acknowledges the link width negotiation to transition to the folded-width mode. The priority indicator may be a single-bit field in the link width negotiation message. When asserted, the priority indicator may indicate an urgent condition such as a thermal excursion or a power budget violation, and the switch may be required to acknowledge the negotiation request.

In some implementations of the accelerator, the priority indicator is asserted in response to a thermal sensor of the accelerator detecting a temperature exceeding a thermal threshold. The thermal sensor may be integrated into the accelerator die or package. The thermal threshold may be a configurable value set by firmware or by a centralized controller, and may correspond to a temperature at which continued full-bandwidth operation risks thermal throttling or damage.

In some implementations of the accelerator, when the priority indicator is asserted, the second circuit asserts a soft lockout preventing hardware-requested width increases on the UALink-based link until firmware of the accelerator clears the soft lockout. The soft lockout may prevent the second circuit from automatically initiating unfold in response to increased utilization while the thermal or power condition persists. Firmware may clear the soft lockout after the thermal condition has resolved or after a cooling period has elapsed.

In some implementations of the accelerator, the first threshold is lower than the second threshold, implementing hysteresis to prevent oscillation between the full-width mode and the folded-width mode. The gap between the first threshold and the second threshold may create a deadband range where the link utilization may fluctuate without triggering repeated fold and unfold transitions. The first threshold and the second threshold may be independently configurable.

In some implementations of the accelerator, the first circuit monitors the utilization based on credit utilization of the UALink-based link; and wherein a proportion of time in which credits are exhausted exceeding a stall threshold corresponds to the utilization exceeding the second threshold. The credit utilization may be tracked using histograms that record the proportion of time each credit counter spends at various levels relative to the initial credits released. A high proportion of time with zero available credits may indicate that the link is heavily utilized and should be transitioned to the full-width mode.

In some implementations of the accelerator, the accelerator is further coupled to a host processor via a host link conforming to at least one of CXL or PCIe; and wherein the second circuit is further configured to coordinate power state transitions of the UALink-based link with power state transitions of the host link. The coordination may include transitioning the host link to a lower power state when the UALink-based link transitions to the folded-width mode, and restoring the host link to an active state when the UALink-based link transitions to the full-width mode. This coordination may reduce overall system power consumption by avoiding a state where one link is fully active while the other is in a low-power state.

FIG. 3B illustrates a method for managing link width in a UALink-based network, which may monitor link utilization and trigger transitions between full-width and folded-width modes based on configurable thresholds. The method may further manage protocol-level details of the transition, such as transmitting readiness notifications to speed up receiver clock recovery, replaying buffered data at adjusted rates to accommodate the bandwidth change, and resolving conflicts when both the accelerator and the switch have simultaneous preferences for which physical layer to keep active. These protocol-level details may ensure that the transition between modes is seamless, without data loss or link-level errors.

In various implementations, a method for managing link width in Ultra Accelerator Link (UALink)-based network, comprising: monitoring, by an accelerator, utilization of a UALink-based link connecting the accelerator to a switch, the UALink-based link comprising a plurality of physical layers coupled to a single data link layer; when the utilization falls below a first threshold for a first duration, initiating a link width negotiation to transition the UALink-based link from a full-width mode to a folded-width mode by placing at least one physical layer of the plurality of physical layers in a low-power state; and when the utilization exceeds a second threshold, initiating a link width negotiation to transition the UALink-based link from the folded-width mode to the full-width mode. The method may be performed by an accelerator that is connected to a switch via the UALink-based link. The monitoring may be continuous or periodic, and the thresholds may be configured by firmware, by a centralized controller, or by a combination thereof. The first duration may prevent premature folding during transient traffic variations, such as brief pauses between collective operation phases. The link width negotiation may be initiated by the accelerator, and the switch may respond with an acknowledgment or a negative acknowledgment. The method may be implemented in hardware, firmware, software, or combinations thereof.

In some implementations, the method further comprises during transitioning from the folded-width mode to the full-width mode, transmitting a transmit-ready notification from the accelerator to the switch when the at least one physical layer being restored begins transmitting valid symbols, the transmit-ready notification enabling the switch to initiate clock data recovery lock on a receiver corresponding to the at least one physical layer. The transmit-ready notification may be a data link message transmitted after the at least one physical layer starts transmitting valid symbol sequences. The switch may use the transmit-ready notification as a hint to enable clock data recovery on the corresponding receiver, which may reduce the time needed to achieve alignment lock.

In some implementations, the method further comprises during transitioning from the folded-width mode to the full-width mode, replaying data link flits stored in a transmit replay buffer by inserting no-operation flits between the data link flits, wherein the data link flits were stored in the transmit replay buffer during operation in the folded-width mode, and the no-operation flits reduce a replay rate to match a data rate of the folded-width mode. During operation in the folded-width mode, data link flits may be created and stored in the transmit replay buffer at the folded-width data rate. When the link transitions to the full-width mode, the aggregate data rate increases, and replaying the stored flits at the full-width rate may exceed the rate at which they were originally transmitted. Inserting no-operation flits proportionately may reduce the effective replay rate to match the original folded-width data rate.

In some implementations, the method further comprises when the accelerator and the switch each transmit a link width negotiation requesting different physical layers to remain active during a transition to the folded-width mode, selecting a predetermined physical layer to remain active regardless of a priority indicator in either request. The predetermined physical layer may be the physical layer associated with the lower-order lanes. This deterministic resolution may cause both the accelerator and the switch to converge on the same physical layer without additional negotiation rounds when their preferences differ.

In some implementations of the method, the monitoring comprises sampling a port bytes transmitted counter and a port bytes received counter at periodic intervals, and computing the utilization as a ratio of bytes transferred to a maximum link capacity over a sampling period. The port bytes transmitted counter and the port bytes received counter may be mandatory telemetry counters maintained by the accelerator. The sampling interval and the maximum link capacity used for the ratio computation may be configurable parameters.

In some implementations of the method, a non-transitory computer-readable medium storing instructions that, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

FIG. 3C illustrates a plurality of accelerators connected to a switch or to multiple switches via UALink-based links, where the power consumed by the link transceivers across the pod may be substantial. In some implementations, a centralized controller may coordinate link width management across the plurality of accelerators by communicating link folding policies via an out-of-band management interface. Each accelerator may then selectively transition its UALink-based link between a full-width mode and a folded-width mode based on the link folding policy and locally monitored traffic utilization. The link folding policy may be determined by the centralized controller and distributed to the accelerators, or the accelerators may determine their own policies locally based on policy parameters distributed by the centralized controller. The centralized controller may update the link folding policy in response to workload phase transitions communicated from a workload orchestrator, enabling the link width management to adapt to changing workload demands across the pod. Coordinated transitions may be performed simultaneously across all accelerators within a virtual pod to maintain bandwidth symmetry during collective operations.

In various implementations, a system comprising: a plurality of accelerators, each accelerator connected to a switch via an Ultra Accelerator Link (UALink)-based link supporting link width folding; and a centralized controller coupled to the plurality of accelerators via an out-of-band management interface; wherein each accelerator is configured to selectively transition the UALink-based link between a full-width mode and a folded-width mode based on a link folding policy and locally monitored traffic utilization. The system may include a pod of accelerators connected to one or more switches, where the centralized controller manages configuration and operation of the pod via the out-of-band management interface. Each UALink-based link may include a plurality of physical layers coupled to a single data link layer, and link width folding may include transitioning at least one physical layer to a low-power state while maintaining data link layer operation on the remaining physical layers. The link folding policy may specify utilization thresholds for triggering fold and unfold transitions, timing constraints such as hold-off durations and cool-down periods, and coordination rules governing simultaneous transitions across the pod. The locally monitored traffic utilization may be measured using credit utilization histograms, port byte counters, or other locally available metrics. The system may be implemented using hardware, firmware, software, or combinations thereof.

In some implementations of the system, the centralized controller is configured to determine the link folding policy based on a workload characteristic, and distribute the link folding policy to the plurality of accelerators via the out-of-band management interface. The workload characteristic may include a workload type such as training or inference, a workload phase such as computation-intensive or communication-intensive, a cluster utilization level, or a power budget constraint. The centralized controller may determine a pod-wide link folding policy and distribute it uniformly, or may determine per-accelerator policies based on the role of each accelerator in the workload.

In some implementations of the system, each accelerator is configured to determine the link folding policy locally based on the locally monitored traffic utilization; and wherein the centralized controller is configured to distribute policy parameters comprising threshold values and timing constraints to the plurality of accelerators via the out-of-band management interface. The policy parameters may include fold and unfold utilization thresholds, hold-off durations, hysteresis gap values, and maximum fold durations. Each accelerator may apply these parameters to its locally monitored traffic utilization to make autonomous fold and unfold decisions without requiring per-event communication with the centralized controller.

In some implementations of the system, the centralized controller is configured to coordinate width transitions across the plurality of accelerators such that all UALink-based links within a virtual pod transition between the full-width mode and the folded-width mode simultaneously. Simultaneous transitions may prevent bandwidth asymmetry where some accelerators operate at full bandwidth while others operate at folded bandwidth during collective operations. The centralized controller may issue a coordinated transition command to all accelerators in the virtual pod, and each accelerator may initiate its link width negotiation within a specified time window.

In some implementations of the system, the workload characteristic comprises a workload phase transition communicated from a workload orchestrator to the centralized controller; and wherein the centralized controller is configured to update the link folding policy in response to the workload phase transition. The workload orchestrator may include a cluster scheduler, a training framework controller, an inference serving system, or other workload management software. The workload phase transition may include transitions between training and inference workloads, transitions between communication-intensive and computation-intensive phases within a training iteration, or transitions between different model partitioning configurations.

In some implementations of the system, when the UALink-based link of an accelerator is in the folded-width mode and an active physical layer of the UALink-based link faults, the accelerator is configured to automatically restore all physical layers of the UALink-based link to an active state as a recovery mechanism. The recovery mechanism may power up all physical layers that were previously placed in a low-power state during folding, providing an alternate physical layer to maintain data link layer continuity. The recovering physical layers may transmit rapid alignment markers and progress through data link state machine transitions before reaching an active operational state.

In some implementations of the system, each accelerator is configured to report folding state transitions and folding duration to the centralized controller via the out-of-band management interface; and wherein the centralized controller is configured to aggregate the folding state transitions across the plurality of accelerators to monitor pod-level power utilization. The folding state transitions may include transitions from the full-width mode to the folded-width mode and from the folded-width mode to the full-width mode, along with timestamps. The centralized controller may utilize the aggregated data to identify accelerators with anomalous folding patterns, to validate that folding policies are achieving the intended power savings, or to adjust policies based on observed pod-level behavior.

FIG. 3D illustrates a method for managing link width across a plurality of accelerators, which may coordinate link folding decisions based on a combination of centralized policy and local monitoring. The method may enable power savings during workload phases that do not require full inter-accelerator bandwidth, such as inference serving or computation-intensive training phases, while restoring full bandwidth when communication-intensive operations are imminent. The method may further adapt to workload transitions by folding or unfolding links in response to collective operation requests, inference-to-training transitions, or per-iteration phase cycling within training workloads.

In various implementations, a method for managing link width across a plurality of accelerators in a UALink-based network, wherein the plurality of accelerators are connected to a switch via UALink-based links supporting link width folding, the method comprising: communicating, via an out-of-band management interface, between a centralized controller and the plurality of accelerators; and selectively transitioning, by each accelerator, the UALink-based link of the accelerator between a full-width mode and a folded-width mode based on a link folding policy and locally monitored traffic utilization. The method may be performed in a pod of accelerators connected to one or more switches. The communicating may include distributing link folding policies, distributing policy parameters, collecting telemetry data, and issuing coordinated transition commands. The selectively transitioning may include initiating link width negotiations between each accelerator and its connected switch, where the accelerator initiates the negotiation and the switch responds. The link folding policy may be determined by the centralized controller, by each accelerator locally, or by a combination of centralized guidance and local decision-making. The method may be implemented in hardware, firmware, software, or combinations thereof.

In some implementations, the method further comprises receiving, by an accelerator of the plurality of accelerators, a collective operation request while the UALink-based link of the accelerator is in the folded-width mode; and initiating, by the accelerator, a transition from the folded-width mode to the full-width mode before executing the collective operation. The collective operation request may include an in-network collective operation such as a ReadReduce, WriteMulticast, or AtomicNRMulticast, or a block collective operation. Initiating the transition before executing the collective operation may prevent the collective from executing at reduced bandwidth, which may increase collective completion time and delay dependent computation on participating accelerators.

In some implementations of the method, during an inference workload, each accelerator of the plurality of accelerators transitions all UALink-based links except one to the folded-width mode; and upon detection of a transition to a training workload, each accelerator transitions all UALink-based links to the full-width mode. During inference, inter-accelerator communication may be limited to key-value cache transfers or expert activation requests, which may require substantially less bandwidth than the collective operations utilized during training. Maintaining one UALink-based link at full width may provide sufficient bandwidth for inference communication while the remaining links are folded to save power.

In some implementations of the method, each accelerator of the plurality of accelerators transitions the UALink-based link to the folded-width mode during a computation phase of a training iteration, and transitions the UALink-based link to the full-width mode before a communication phase of the training iteration, the computation phase comprising a forward pass or a backward pass, and the communication phase comprising a gradient synchronization operation. The training iteration may include alternating computation and communication phases, where the computation phase involves local tensor operations on each accelerator and the communication phase involves inter-accelerator data exchange such as gradient aggregation. The accelerator may anticipate the upcoming communication phase based on an execution schedule and initiate the transition to the full-width mode sufficiently in advance to allow link width negotiation and physical layer power-up to complete before the communication phase begins.

In some implementations of the method, a non-transitory computer-readable medium storing instructions that, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

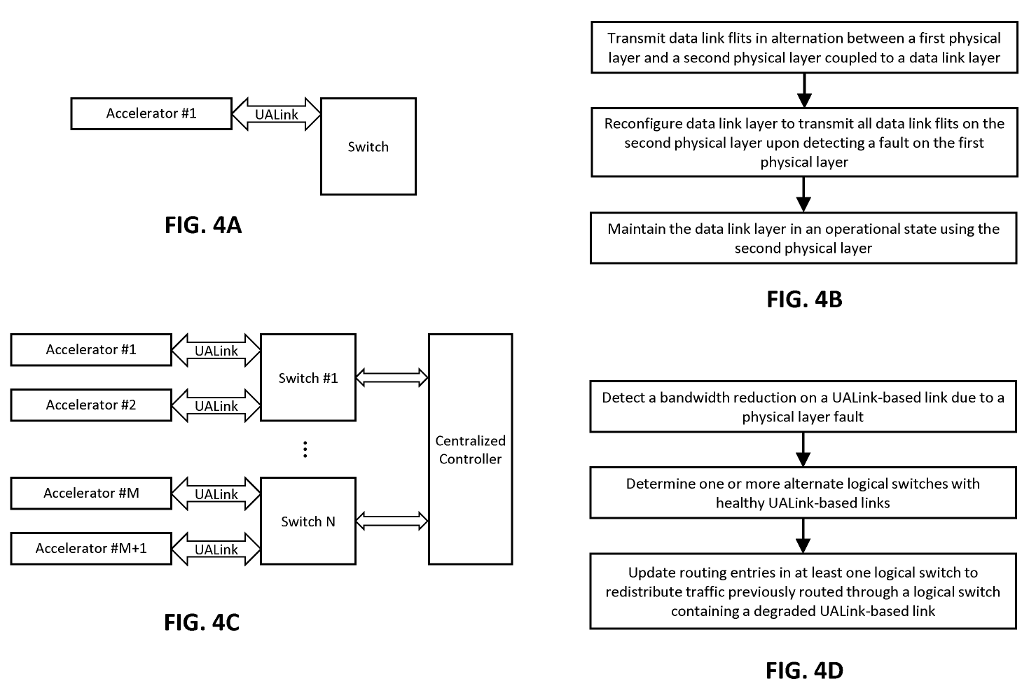

FIG. 4A illustrates accelerators that communicate via multi-lane links through switches, wherein each link may include a plurality of physical layers coupled to a single data link layer. During normal operation, the data link layer may transmit data link flits in alternation between the physical layers, distributing bandwidth across the available physical layer capacity. When a physical layer fault occurs, the data link layer may reconfigure to continue operation on the remaining non-faulted physical layer, maintaining the data link layer in an operational state such that transaction layer traffic continues to traverse the link without requiring data link layer re-establishment. This approach may provide graceful bandwidth reduction rather than complete link failure, enabling in-flight transactions to complete and new transactions to proceed at reduced bandwidth. The data link layer may employ per-physical-layer sub-state machines that track the state of each physical layer independently, a shared link-level replay entity that maintains replay state across both physical layers, and receive-side reordering logic that uses alignment marker positions and physical layer identifiers to reconstruct the correct transmit order from data link flits arriving on both physical layers. The accelerator may further report the degraded state to a centralized controller via an out-of-band management interface, enabling system-level management responses such as route redistribution or workload migration.

In various implementations, an accelerator for an Ultra Accelerator Link (UALink)-based network, comprising: a UALink-based link connecting the accelerator to a switch, the UALink-based link comprising a first physical layer and a second physical layer coupled to a single data link layer; wherein the data link layer is configured to: transmit data link flits in alternation between the first physical layer and the second physical layer; upon detecting a fault on the first physical layer, reconfigure to transmit all data link flits on the second physical layer; and maintain the data link layer in an operational state using the second physical layer, such that transaction layer traffic continues to traverse the data link layer while the first physical layer is in a faulted state. The accelerator may be a computing device such as a GPU, an AI accelerator, or a data processing unit connected to the switch via the UALink-based link. The first physical layer and the second physical layer may each comprise one or more lanes carrying serialized data at rates such as 100 Gbps or 200 Gbps per lane. The data link layer may add cyclic redundancy check (CRC) protection and headers to form data link flits from transaction layer flits, and may perform link-level replay for lossless delivery. During normal operation, the data link flits may be distributed across both physical layers in alternation, providing aggregate bandwidth equal to the sum of both physical layers. Upon detecting a fault on the first physical layer, the data link layer may redirect all outbound data link flits to the second physical layer, which may result in a reduction of available bandwidth but may maintain continuous operation of the data link layer. The fault may be detected through link fault signaling, where the faulted physical layer transmits remote fault indications. The transaction layer traffic, including pending requests and responses, may continue to traverse the data link layer on the second physical layer without requiring credit re-initialization, state machine reset, or link training. The method may be implemented in hardware, firmware, software, or combinations thereof, and may be performed by various types of devices including an accelerator, a switch, a processor, or a semiconductor device.

In some implementations of the accelerator, the alternation between the first physical layer and the second physical layer comprises time-division multiplexing, and a first data link flit is transmitted on the physical layer associated with lower-order lanes. The time-division multiplexing may distribute consecutive data link flits to alternating physical layers in a round-robin pattern. The physical layer associated with lower-order lanes may be designated as the first physical layer to transmit, providing a deterministic starting point for the alternation sequence.

In some implementations of the accelerator, the data link layer is further configured to reorder received data link flits using relative alignment marker positions and physical layer identifiers to maintain a strict monotonic transmit order. The reordering may compensate for skew between the two physical layers, where data link flits transmitted simultaneously on different physical layers may arrive at the receiver at slightly different times. The relative alignment marker positions may provide timing references, and the physical layer identifiers may indicate which physical layer carried each data link flit, enabling the receiver to reconstruct the original transmit order.

In some implementations of the accelerator, the data link layer comprises a first sub-state machine associated with the first physical layer and a second sub-state machine associated with the second physical layer; and wherein the data link layer is considered in the operational state when at least one of the first sub-state machine or the second sub-state machine is in an active state. The per-physical-layer sub-state machines may track data link states including fault, idle, no-operation, power-down, and up states independently for each physical layer. When the first physical layer faults, the first sub-state machine may transition to a fault or idle state while the second sub-state machine remains in the active state, maintaining the data link layer in the operational state.

In some implementations of the accelerator, the data link layer comprises a single link-level replay entity shared between the first physical layer and the second physical layer, the link-level replay entity maintaining replay state for data link flits transmitted on both physical layers. The shared link-level replay entity may maintain a transmit replay buffer that stores data link flits transmitted on both physical layers until they are acknowledged by the link partner. When a physical layer fault triggers reconfiguration, the replay entity may replay unacknowledged data link flits on the remaining physical layer, providing lossless delivery across the transition.

In some implementations of the accelerator, the data link layer is further configured to: detect that the first physical layer has recovered from the fault before a timeout expiry; and restore transmission of data link flits in alternation between the first physical layer and the second physical layer without requiring a full data link layer restart. The fast recovery path may enable return to full-bandwidth dual-physical-layer operation when the fault was transient and the faulted physical layer recovers before a programmable timeout expires. The reordering at the receiver may be determined before data link flits are received on the recovering physical layer, enabling seamless restoration.

In some implementations of the accelerator, the data link layer is configured to wait a programmable delay after detecting continuous fault indication on the first physical layer before transitioning the first physical layer to a faulted state, the programmable delay enabling transient faults to resolve without triggering reconfiguration. The programmable delay may be configurable in increments, and may have a default value that balances responsiveness against false-positive fault detection. The continuous fault indication may include remote fault signaling received from the link partner on the first physical layer.

In some implementations of the accelerator, upon reconfiguring to transmit all data link flits on the second physical layer, the accelerator is configured to report a port state transition from an operational-up state to an operational-but-degraded state to a centralized controller via an out-of-band management interface, the port state transition comprising a degraded reason indicating the fault on the first physical layer. The port state transition may be reported as an on-change notification via the out-of-band management interface. The degraded reason may identify the specific physical layer that faulted, the type of fault, and the timestamp of the fault detection. The centralized controller may use the degraded state notification to trigger system-level management responses.

In some implementations of the accelerator, the accelerator is further configured to maintain a link quality indicator for the UALink-based link; and wherein the link quality indicator transitions from a healthy state to a marginal state or an unhealthy state based on an error rate on the second physical layer, enabling the centralized controller to take proactive management action before complete link failure. The link quality indicator may be derived from forward error correction error statistics, link-level replay rates, or other error metrics on the remaining active physical layer. The heuristics for determining transitions between healthy, marginal, and unhealthy states may be vendor-specific.

In some implementations of the accelerator, the accelerator is further coupled to a host processor via a host link conforming to at least one of CXL or PCIe; and wherein upon reconfiguring to transmit all data link flits on the second physical layer, the accelerator is configured to adjust a bandwidth allocation on the host link to match the reduced bandwidth of the UALink-based link. The bandwidth adjustment on the host link may include reducing the rate at which the host processor sends data to the accelerator, adjusting flow control parameters, or transitioning the host link to a lower bandwidth operating mode. This coordination may prevent the host link from over-driving the degraded UALink-based link, which may cause congestion or credit starvation.

FIG. 4B illustrates a method for maintaining link resiliency in a UALink-based network, which may couple two physical layers to a single data link layer, transmit data link flits in alternation across both physical layers, and upon detecting a physical layer fault reconfigure to continue operation on the remaining physical layer. The method may further manage recovery of the faulted physical layer through fast recovery when the fault resolves before a timeout, or through a full state machine progression when the timeout expires. The method may also detect interactions between link resiliency and link folding, where a fault on a sole active physical layer during folded-width operation triggers automatic power-up of all previously folded physical layers. Error statistics from forward error correction may be monitored to predict impending failure of the remaining physical layer, enabling proactive management actions before complete link loss.

In various implementations, a method for maintaining link resiliency in an Ultra Accelerator Link (UALink)-based network, comprising: transmitting, by a data link layer of a UALink-based link connecting an accelerator to a switch, data link flits in alternation between a first physical layer and a second physical layer coupled to the data link layer; upon detecting a fault on the first physical layer, reconfiguring the data link layer to transmit all data link flits on the second physical layer; and maintaining the data link layer in an operational state using the second physical layer, such that transaction layer traffic continues to traverse the data link layer while the first physical layer is in a faulted state. The method may be performed by an accelerator connected to a switch via the UALink-based link, or by the switch at the opposite end of the link. The transmitting in alternation may include time-division multiplexing of consecutive data link flits across the two physical layers. The detecting of the fault may be based on link fault signaling received from the link partner, or on locally detected error conditions. The reconfiguring may include link-level replay of unacknowledged data link flits on the remaining physical layer to provide lossless delivery across the transition. The method may be implemented in hardware, firmware, software, or combinations thereof.

In some implementations, the method further comprises detecting that the first physical layer has recovered from the fault after a timeout expiry; and restoring the first physical layer to the operational state by progressing the first physical layer through data link idle, data link no-operation, and data link up states while the second physical layer remains in the operational state. The link down recovery path may apply when the faulted physical layer does not recover before a programmable timeout expires. The recovering physical layer may progress through the full data link state machine sequence while the non-faulted physical layer continues carrying all data link flits, maintaining uninterrupted operation during the recovery.

In some implementations of the method, the UALink-based link supports link folding; and further comprising: when the UALink-based link is operating on a single active physical layer in a folded-width mode and the single active physical layer faults, automatically powering up all physical layers previously in a low-power state as a recovery mechanism. The link folding recovery may restore all physical layers to an active state, providing alternate physical layers to sustain data link layer operation. The recovering physical layers may transmit rapid alignment markers and progress through data link state machine transitions before reaching the operational state.

In some implementations, the method further comprises monitoring a forward error correction error count histogram on the second physical layer; and predicting impending failure of the second physical layer when error counts in higher-error bins of the histogram exceed a prediction threshold, enabling proactive management action before complete link failure. The forward error correction error count histogram may include a plurality of bins, each bin corresponding to a number of symbol errors corrected per codeword. An increase in error counts in higher-error bins over time may indicate degradation of the physical layer signal quality. The prediction threshold may be a configurable value set by firmware or by a centralized controller.

In some implementations of the method, a non-transitory computer-readable medium storing instructions that, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising a first pluggable module and a second pluggable module coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

FIG. 4C illustrates a plurality of accelerators connected to a plurality of switches, wherein each switch or partition thereof may constitute a logical switch with its own routing table. When a physical layer fault causes a UALink-based link connected to a particular logical switch to degrade, traffic previously routed through that logical switch may experience reduced bandwidth. In some implementations, a centralized controller may detect the degradation and update routing entries across the logical switches to redistribute traffic from the degraded path to alternate healthy paths. The redistribution may include installing flow-based routing entries that specify per-source-destination routing, removing routing entries on the degraded logical switch while maintaining entries on healthy logical switches, or proactively redistributing routes when a link quality indicator drops below a healthy level before a complete physical layer fault occurs. This system-level management response may enable the accelerator network to continue operating at full aggregate bandwidth across the pod by utilizing the path redundancy provided by multiple logical switches, even when individual links degrade due to physical layer faults.

In various implementations, a system for an Ultra Accelerator Link (UALink)-based network, comprising: a plurality of accelerators connected to a plurality of switches via UALink-based links, the UALink-based links supporting link resiliency, and the plurality of switches comprising a plurality of logical switches; a centralized controller coupled to the plurality of switches via an out-of-band management interface; wherein upon detecting a bandwidth reduction on a UALink-based link due to a physical layer fault, the centralized controller is configured to update routing entries in at least one logical switch of the plurality of logical switches to redistribute traffic previously routed through a logical switch containing the degraded UALink-based link to one or more other logical switches of the plurality of logical switches. The system may include a pod of accelerators connected to switches via UALink-based links, where each accelerator may have multiple ports connecting to multiple switches. The plurality of switches may include physical switches, each of which may be partitioned into one or more logical switches with independently programmable routing tables. The link resiliency may include coupling two physical layers to a single data link layer, where a fault on one physical layer causes the data link layer to continue operation on the remaining physical layer at reduced bandwidth. The centralized controller may include a Pod Controller that manages configuration and operation of the pod. The routing entries may be programmed via the out-of-band management interface using a management protocol. The redistribution may involve modifying existing routing entries, adding new routing entries, or removing routing entries on the logical switch containing the degraded link. The system may be implemented using hardware, firmware, software, or combinations thereof.

In some implementations of the system, the routing entries comprise flow-based routing entries specifying a source accelerator identifier, an ingress port, a destination accelerator identifier, and an egress port; and wherein the centralized controller is configured to install the flow-based routing entries to preferentially route traffic from specific source accelerators to logical switches with healthy UALink-based links. The flow-based routing entries may provide finer-grained traffic redistribution than destination-based routing, enabling the centralized controller to redistribute the traffic flows that would traverse the degraded link while leaving other flows unchanged. The source accelerator identifier and ingress port may identify the specific traffic flow to be redirected.

In some implementations of the system, a virtual pod comprising a subset of the plurality of accelerators continues operating across remaining healthy logical switches of the plurality of logical switches; and wherein the centralized controller is configured to remove routing entries on the logical switch containing the degraded UALink-based link while maintaining routing entries on the remaining healthy logical switches. The virtual pod may continue executing workloads at reduced aggregate bandwidth provided by the remaining healthy logical switches. The centralized controller may remove routing entries on the degraded logical switch to prevent new traffic from being routed through the degraded path, while existing in-flight transactions on the degraded path complete at reduced bandwidth.

In some implementations of the system, upon detecting the bandwidth reduction, an accelerator coupled to the degraded UALink-based link and a switch coupled to the degraded UALink-based link each generate an error record comprising a device identifier of the respective device, enabling the centralized controller to correlate the bandwidth reduction with the degraded UALink-based link based on the device identifiers. The error records may be generated in a structured format that embeds the device identifier, the port number, the fault type, and the timestamp. The centralized controller may collect error records from both the accelerator and the switch, and may correlate them using the device identifiers and timestamps to identify the specific UALink-based link that experienced the bandwidth reduction.

In some implementations of the system, the centralized controller detects the bandwidth reduction by receiving a port state notification from an accelerator coupled to the degraded UALink-based link, the port state notification indicating a transition from an operational-up state to an operational-but-degraded state. The port state notification may be an on-change notification transmitted via the out-of-band management interface when the accelerator transitions its port state. The centralized controller may subscribe to port state changes from all accelerators in the pod, enabling it to detect degradation events across the network.

In some implementations of the system, the centralized controller is further configured to proactively redistribute routing entries away from a logical switch containing a UALink-based link with a link quality indicator indicating a marginal state or an unhealthy state, before a physical layer fault occurs on the UALink-based link. The proactive redistribution may reduce the impact of a potential second physical layer fault by reducing traffic load on the link before it fails completely. The link quality indicator may be reported by the accelerator or the switch as part of periodic telemetry or on-change notifications.

FIG. 4D illustrates a method for managing link degradation in a UALink-based network, which may detect bandwidth reductions caused by physical layer faults and redistribute traffic across alternate logical switches to maintain network throughput. The method may include evaluating whether the remaining bandwidth after degradation is sufficient for the active workload, which may be particularly relevant for distributed AI training workloads where gradient synchronization requires a minimum bandwidth to avoid slowing down the training iteration. When the remaining bandwidth is insufficient, the method may migrate the workload to accelerators served by healthy links. The method may also manage the interaction between link degradation and in-progress collective operations by adjusting the timing of collective sub-requests to match the reduced bandwidth of the degraded link, preventing credit starvation that could stall the collective operation.

In various implementations, a method for managing link degradation in an Ultra Accelerator Link (UALink)-based network comprising a plurality of accelerators connected to a plurality of switches via UALink-based links supporting link resiliency, the plurality of switches comprising a plurality of logical switches, the method comprising: detecting a bandwidth reduction on a UALink-based link due to a physical layer fault; determining, by a centralized controller coupled to the plurality of switches via an out-of-band management interface, one or more alternate logical switches of the plurality of logical switches with healthy UALink-based links; and updating, by the centralized controller, routing entries in at least one logical switch of the plurality of logical switches to redistribute traffic previously routed through a logical switch containing the degraded UALink-based link to the one or more alternate logical switches. The method may be performed by a centralized controller such as a Pod Controller that manages a pod of accelerators and switches. The detecting may be based on port state notifications received from accelerators or switches indicating bandwidth reduction due to physical layer faults. The determining may involve querying link health status across the plurality of logical switches to identify those with healthy links that can absorb the redistributed traffic. The updating may include modifying routing table entries via the out-of-band management interface using management protocol operations. The method may be implemented in hardware, firmware, software, or combinations thereof.

In some implementations, the method further comprises evaluating, by the centralized controller, whether a remaining bandwidth after the bandwidth reduction is sufficient for an active workload on the plurality of accelerators; and when the remaining bandwidth is insufficient, migrating the active workload to accelerators served by healthy UALink-based links. The bandwidth sufficiency evaluation may compare the remaining aggregate bandwidth available to the accelerators executing the workload against the bandwidth requirements of the workload. The migration may include reassigning the workload to a different set of accelerators, reprogramming routing tables for the new assignment, and restarting the workload on the new accelerators.

In some implementations of the method, the active workload comprises a distributed training workload; and wherein the evaluating comprises comparing the remaining bandwidth against a bandwidth requirement for gradient synchronization of the distributed training workload, the bandwidth requirement being based on a model size and a training iteration frequency. The gradient synchronization may include an all-reduce collective operation that aggregates gradient tensors from all participating accelerators after each training iteration. The bandwidth requirement may be estimated as the product of the model size and the training iteration frequency divided by the number of available links, where a reduction in available bandwidth due to degradation may cause the gradient synchronization to become the bottleneck in the training iteration.

In some implementations, the method further comprises when the bandwidth reduction occurs during an in-progress collective operation on the plurality of accelerators, adjusting, by a switch of the plurality of switches, timing of sub-requests of the collective operation to match a reduced bandwidth of the degraded UALink-based link, preventing credit starvation on the degraded UALink-based link. The timing adjustment may include increasing the interval between sub-requests directed to the degraded link, reducing the number of concurrent sub-requests, or temporarily pausing sub-requests until credits are replenished. The adjustment may prevent a situation where the switch attempts to send sub-requests at the full-bandwidth rate to a link operating at reduced bandwidth, which may exhaust credits and stall the collective operation.

In some implementations of the method, a non-transitory computer-readable medium storing instructions that, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

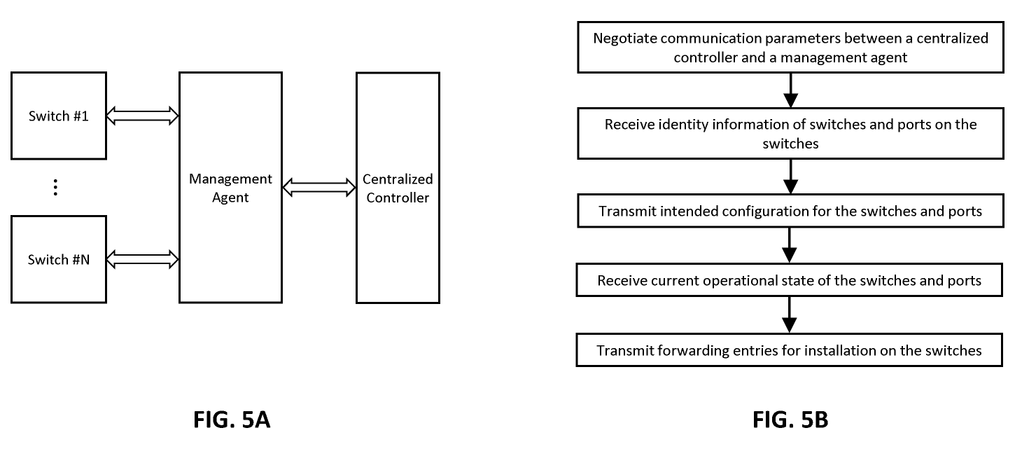

FIG. 5A illustrates a plurality of accelerators coupled to switches, managed by a centralized controller through management agents residing on the switch platforms. The centralized controller and the management agents may synchronize state over connections established on an out-of-band management network. The state to be synchronized may include identity information describing the management agent, switches, and ports; intended configuration for switches and ports; current operational state reflecting the live status of network components; and forwarding entries calculated by the centralized controller for installation on the switches. Synchronizing this state in a structured manner through a plurality of ordered phases may provide predictable convergence, prevent race conditions between configuration and operational state reporting, and enable the centralized controller to calculate forwarding entries based on a complete and consistent view of the network.

In various implementations, a network management system comprising: a centralized controller; a management agent associated with one or more switches in an Ultra Accelerator Link (UALink)-based network, the management agent configured to locally manage the one or more switches on behalf of the centralized controller; and a connection between the centralized controller and the management agent; wherein the centralized controller and the management agent are configured to synchronize state through a plurality of ordered phases over the connection comprising: the centralized controller and the management agent negotiate communication parameters; the management agent transmits identity information of the one or more switches and ports on the one or more switches to the centralized controller; the centralized controller transmits intended configuration for the one or more switches and the ports to the management agent; the management agent transmits current operational state of the one or more switches and the ports to the centralized controller; and the centralized controller transmits forwarding entries to the management agent for installation on the one or more switches. The ordered phases may follow a logical progression in which the centralized controller first learns the identity and capabilities of all managed devices, then pushes the desired configuration, then receives the current operational state as observed by the management agent, and finally distributes forwarding entries computed from the aggregated state. This progression may allow the centralized controller to incorporate identity and configuration context before receiving operational state, and to incorporate operational state before computing forwarding entries. The connection between the centralized controller and the management agent may be established over an out-of-band management network separate from the UALink data-plane network carrying accelerator-to-accelerator traffic. The management agent may manage one or more physical switches on the switch platform, each physical switch comprising ports coupled to accelerators in the UALink-based network. The identity information may include unique identifiers, hardware and firmware versions, vendor information, and port capabilities. The intended configuration may include administrative states, device identifiers, and ordering modes. The operational state may include port link states, neighbor validation states, and link quality indicators.

In some implementations of the system, the ordered phases are executed in a sequential order such that each phase completes before a subsequent phase begins; and wherein upon disconnection and reconnection of the connection, the centralized controller and the management agent are configured to re-execute the ordered phases from a first phase of the ordered phases. Sequential execution may prevent the centralized controller from acting on incomplete information. Upon reconnection, re-executing all phases from the first phase may provide full state reconciliation without requiring the centralized controller or the management agent to persist protocol state across disconnections.

In some implementations of the system, the negotiation of communication parameters comprises a three-way exchange in which: the centralized controller is configured to transmit first communication parameters including a keepalive interval and a dead interval, with active interval values set to zero; the management agent is configured to validate the first communication parameters, compute active keepalive and active dead intervals as a maximum of received values and locally configured values, and transmit a response comprising the computed active intervals; and the centralized controller is configured to independently compute the active intervals and close the connection when the independently computed active intervals do not match the active intervals received from the management agent. The three-way exchange may allow both parties to agree on timing parameters while respecting local constraints. Computing active intervals as the maximum of received and locally configured values may accommodate the party with tighter timing requirements. Independent verification by the centralized controller may detect corrupted or incorrectly computed responses.

In some implementations of the system, the connection includes a keepalive mechanism, the keepalive mechanism comprising: the management agent configured to transmit a keepalive message when no other message has been transmitted within an active keepalive interval; the centralized controller configured to respond to the keepalive message; and the centralized controller and the management agent each configured to close the connection when no message is received within an active dead interval; wherein the active dead interval is greater than the active keepalive interval, and wherein a timer for the active dead interval is reset upon receipt of a message on the connection. The keepalive mechanism may detect connection failures promptly, enabling the centralized controller to initiate recovery actions. Resetting the dead interval timer upon receipt of any message, not only keepalive messages, may reduce unnecessary keepalive traffic during active state exchange. The dead interval may be recommended to be at least three times the keepalive interval to tolerate transient delays.

In some implementations of the system, during the phase in which the management agent transmits identity information, the management agent is configured to transmit the identity information in an order comprising: identity of the management agent, followed by identity of the one or more switches, followed by identity of the ports on the one or more switches. Transmitting identity information in a hierarchical order from management agent to switches to ports may allow the centralized controller to build a top-down model of the managed infrastructure as data arrives, associating ports with their parent switches and switches with their managing agent.

In some implementations of the system, during the phase in which the centralized controller transmits intended configuration, the centralized controller is configured to transmit switch-level configuration before port-level configuration for the one or more switches; and wherein the management agent is configured to not transmit operational state updates during the phase in which the centralized controller transmits intended configuration. Transmitting switch-level configuration before port-level configuration may allow port configuration to depend on device-level settings such as bifurcation mode. Suppressing operational state updates during the configuration phase may prevent the management agent from reporting transient state changes caused by partially applied configuration.

In some implementations of the system, the ordered phases further comprise a subsequent phase following the phase in which the centralized controller transmits forwarding entries; wherein the centralized controller is configured to transmit a transition message indicating entry into the subsequent phase; and wherein during the subsequent phase, configuration updates, forwarding entry updates, and operational state changes are exchanged bidirectionally between the centralized controller and the management agent over the connection. The subsequent phase may represent steady-state normal operations in which both the centralized controller and the management agent freely exchange updates over the same connection. The centralized controller may transmit configuration and forwarding entry updates, while the management agent may report operational state changes. All updates during this phase may carry timestamps for ordering.

In some implementations of the system, the centralized controller is configured to maintain independent connections with a plurality of management agents, each connection progressing through the ordered phases independently of other connections; and wherein the centralized controller is further configured to aggregate operational state received from the plurality of management agents and generate the forwarding entries based on the aggregated operational state. Each management agent may progress through the ordered phases at its own pace based on the number of switches and ports it manages. The centralized controller may wait until sufficient operational state has been received from the plurality of management agents before computing forwarding entries, or may compute forwarding entries incrementally as operational state arrives from each management agent.

In some implementations of the system, the one or more switches comprise UALink-based switches coupling a plurality of accelerators, and wherein the forwarding entries each map a destination accelerator identifier to an egress port on a respective UALink-based switch; and wherein the centralized controller is configured to assign a unique accelerator identifier to each of the plurality of accelerators. The centralized controller may assign accelerator identifiers via node management agents on the system nodes hosting the accelerators. Each UALink-based switch may contain a route table indexed by destination accelerator identifier, with each entry specifying an egress port for forwarding transactions toward the destination accelerator.

In some implementations of the system, the negotiation of communication parameters further comprises negotiation of message encoding formats between the centralized controller and the management agent, wherein both the centralized controller and the management agent support at least one common encoding format; and wherein at least two messages sent over the connection are encoded utilizing at least two different encoding formats, respectively. Supported encoding formats may include IETF JSON and protocol buffer (protobuf) formats. Mixed encoding within a single connection may allow the centralized controller and the management agent to select the most efficient format for each message type independently.

In some implementations of the system, the connection is encrypted using Transport Layer Security (TLS) version 1.2 or higher, and the centralized controller and the management agent are configured to mutually authenticate using mutual TLS. Mutual TLS authentication may verify the identity of both parties before exchanging management state. The management agent may authenticate the centralized controller to confirm it is authorized to manage the switches, and the centralized controller may authenticate the management agent to confirm it is a legitimate agent for the reported switches.

In some implementations, the system further comprises a standby controller configured to receive replicated state from the centralized controller; wherein the standby controller does not maintain an active connection with the management agent; and wherein upon failure of the centralized controller, the standby controller is configured to promote to a primary role and establish a connection with the management agent, executing the ordered phases from a first phase of the ordered phases. The standby controller may mirror the centralized controller's aggregated topology, configuration, and forwarding entry state through a replication channel. Upon promotion, the standby controller may establish new connections with all management agents and re-execute the ordered phases to reconcile any state changes that occurred during the failover period.

In some implementations, the system further comprises a higher-level controller coupled to a plurality of centralized controllers, each centralized controller managing a respective UALink-based network; wherein the higher-level controller is configured to receive aggregated topology information from the plurality of centralized controllers and distribute inter-network forwarding entries that enable accelerators in different UALink-based networks to communicate via an interconnecting network. The interconnecting network may include an Ethernet-based or other scale-out network coupling the UALink-based networks. The higher-level controller may compute inter-fabric forwarding entries that extend the routing domain beyond a single UALink-based network, enabling workloads spanning accelerators across multiple networks.

FIG. 5B illustrates a method for synchronizing state between a centralized controller and a management agent in a UALink-based network. The activities may be performed by a centralized controller and a management agent over a connection established on an out-of-band management network.

In various implementations, a method for synchronizing state between a centralized controller and a management agent in an Ultra Accelerator Link (UALink)-based network, comprising: negotiating, between the centralized controller and the management agent, communication parameters over a connection; receiving, at the centralized controller from the management agent, identity information of one or more switches and ports on the one or more switches; transmitting, from the centralized controller to the management agent, intended configuration for the one or more switches and the ports; receiving, at the centralized controller from the management agent, current operational state of the one or more switches and the ports; and transmitting, from the centralized controller to the management agent, forwarding entries for installation on the one or more switches. The negotiating may establish timing parameters, encoding preferences, and authentication credentials for the connection. The identity information may describe each managed switch and each port on each switch, including hardware identifiers, firmware versions, and supported capabilities. The intended configuration may represent the desired state for switch and port attributes as determined by the centralized controller. The forwarding entries may be calculated by the centralized controller based on the received identity information and the current operational state, and may map destination accelerator identifiers to egress ports on the switches.

In some implementations, the method further comprises receiving, at the centralized controller, a workload communication pattern from a workload orchestrator; and generating the forwarding entries based on the workload communication pattern to reduce latency for collective operations specified in the workload communication pattern. The workload communication pattern may specify all-to-all, ring, or tree communication topologies used by AI training or inference workloads. The centralized controller may optimize forwarding entry placement across switching planes to match the specified pattern, for example distributing traffic symmetrically across logical switches for all-to-all patterns.

In some implementations, the method further comprises comparing, by the centralized controller, timestamps associated with the current operational state against previously cached timestamps for the same state objects; discarding operational state updates having timestamps older than the cached timestamps; and logging the discarded operational state updates for diagnostic purposes. The management agent may associate a monotonic timestamp with each operational state update. When the centralized controller receives an update with a timestamp older than the cached timestamp for the same state object, the update may be stale due to delivery reordering. Logging discarded updates may enable detection of systematic delivery ordering problems across the management network.

In some implementations, the method further comprises receiving, at the centralized controller from the management agent, an operational state change indicating a port failure on a switch of the one or more switches; recalculating affected forwarding entries based on the operational state change; and distributing updated forwarding entries to the management agent. A port failure may be indicated by an operational state transition to a down or degraded state. The centralized controller may remove forwarding entries that route through the failed port and may recalculate alternative paths through remaining operational ports or switching planes.

In some implementations, the method further comprises maintaining, by the centralized controller, independent connections with a plurality of management agents; receiving identity information and current operational state from the plurality of management agents via the independent connections; and generating the forwarding entries based on aggregated operational state received from the plurality of management agents. The centralized controller may aggregate operational state from all management agents to construct a network-wide topology view before generating forwarding entries. Each management agent may progress through the synchronization independently, and the centralized controller may compute forwarding entries as a complete or partial view of the network becomes available.

In some implementations of the method, a non-transitory computer-readable medium comprising instructions which, when executed by a processor, cause the processor to perform the method.

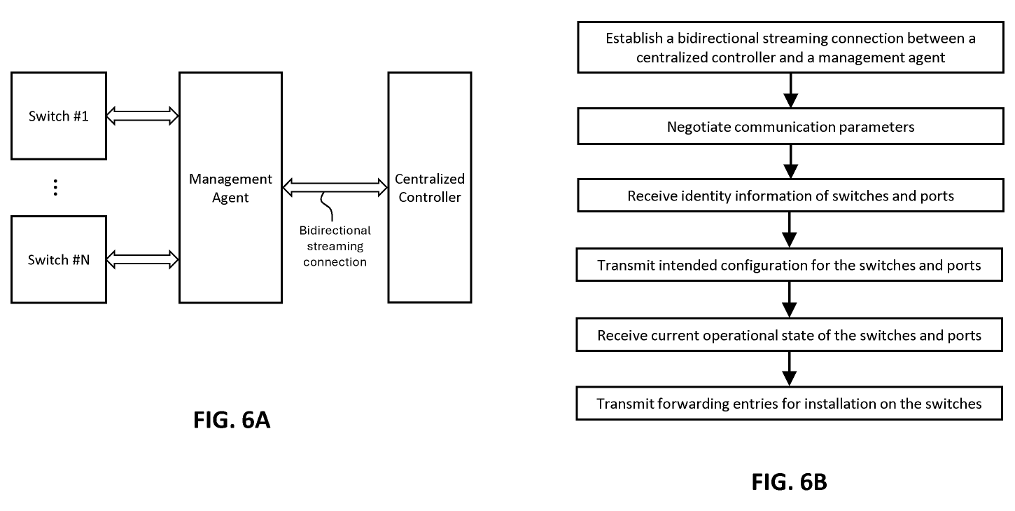

FIG. 6A illustrates a network management system utilizing a bidirectional streaming connection between a centralized controller and a management agent in a UALink-based network. The bidirectional streaming connection may carry all phases of state synchronization over a single stream, with each message comprising a phase identifier that indicates the current protocol phase. This approach may multiplex the state synchronization onto a single connection endpoint rather than requiring separate connections or remote procedure calls for each phase, enabling atomic phase transitions and detection of protocol violations through phase identifier validation.

In various implementations, a network management system comprising: a centralized controller; a management agent associated with one or more switches in an Ultra Accelerator Link (UALink)-based network, the management agent configured to locally manage the one or more switches on behalf of the centralized controller; and a bidirectional streaming connection between the centralized controller and the management agent, the bidirectional streaming connection configured to carry messages in both directions concurrently, each message comprising a phase identifier indicating a current protocol phase; wherein the centralized controller and the management agent are configured to synchronize state over the bidirectional streaming connection through a plurality of ordered phases comprising: the centralized controller and the management agent negotiate communication parameters including keepalive and dead interval values; the management agent transmits identity information of the one or more switches and ports on the one or more switches to the centralized controller; the centralized controller transmits intended configuration for the one or more switches and the ports to the management agent; the management agent transmits current operational state of the one or more switches and the ports to the centralized controller; and the centralized controller transmits forwarding entries to the management agent for installation on the one or more switches. The bidirectional streaming connection may be a single persistent stream over which both the centralized controller and the management agent send and receive messages concurrently. Each message may include a phase identifier field indicating which protocol phase the message belongs to, a data payload containing the state information for that phase, and optionally a capabilities payload for keepalive and negotiation messages. The phase identifier may enable both parties to validate that received messages are consistent with the expected protocol phase, providing a mechanism for detecting protocol errors or implementation bugs. The keepalive and dead interval values negotiated during the first phase may govern connection liveness detection throughout the lifetime of the bidirectional streaming connection. The management agent may serve as the server endpoint for the bidirectional streaming connection, and the centralized controller may connect as a client.

In some implementations of the system, the ordered phases are executed in a sequential order such that each phase completes before a subsequent phase begins; and wherein the centralized controller and the management agent are each configured to close the bidirectional streaming connection upon receiving a message with a phase identifier inconsistent with the current protocol phase. Closing the connection upon receiving an out-of-phase message may prevent protocol corruption where one party has advanced to a later phase while the other has not. After closing, the connection may be re-established and the ordered phases may be re-executed from the first phase.

In some implementations of the system, the management agent is configured to apply a randomized jitter to a keepalive transmission interval to prevent synchronized keepalive transmissions when the centralized controller maintains bidirectional streaming connections with a plurality of management agents. Without jitter, multiple management agents that negotiate the same keepalive interval may transmit keepalive messages at approximately the same time, creating periodic bursts of traffic on the management network. A randomized jitter factor may spread these transmissions across the interval, reducing peak management network utilization.

In some implementations of the system, the bidirectional streaming connection comprises a bidirectional streaming remote procedure call over gRPC, and wherein the management agent is configured to operate as a server and the centralized controller is configured to operate as a client. The gRPC framework may provide the bidirectional streaming transport, with the management agent hosting the gRPC server and the centralized controller initiating connections as a gRPC client. The centralized controller may reuse the same underlying gRPC transport session for additional management plane remote procedure calls such as get, set, and subscribe operations.

In some implementations of the system, the one or more switches couple a plurality of accelerators via the UALink-based network; wherein the forwarding entries are installed into route tables on the one or more switches, each route table indexed by a destination accelerator identifier; and wherein the route tables control routing of UALink Protocol Level Interface (UPLI) transactions between the plurality of accelerators. Each route table entry may contain an allow or deny indication and an egress port designation comprising a station number and a port number. The route table may be indexed by a 10-bit destination accelerator identifier carried in UPLI request and response messages. UPLI transactions routed through the switches may include read, write, atomic, and vendor defined commands exchanged between accelerators in the UALink-based network.

In some implementations of the system, before planned maintenance of the management agent, the centralized controller is configured to migrate the bidirectional streaming connection to a replacement management agent associated with the one or more switches, the replacement management agent resuming operation from a current phase of the ordered phases. Migrating the bidirectional streaming connection to a replacement management agent may avoid re-executing earlier phases that have already completed, reducing the management plane disruption during planned switch platform maintenance. The replacement management agent may inherit the phase state and cached configuration from the original management agent through a local handoff mechanism on the switch platform.

FIG. 6B illustrates a method for bidirectional streaming connection for synchronizing state between a centralized controller and a management agent in a UALink-based network. The bidirectional streaming connection may carry messages tagged with phase identifiers to multiplex all synchronization phases over a single stream.

In various implementations, a method for synchronizing state between a centralized controller and a management agent in an Ultra Accelerator Link (UALink)-based network, comprising: establishing a bidirectional streaming connection between the centralized controller and the management agent, the bidirectional streaming connection carrying messages in both directions concurrently, each message comprising a phase identifier; negotiating, between the centralized controller and the management agent, communication parameters including keepalive and dead interval values; receiving, at the centralized controller from the management agent, identity information of one or more switches and ports on the one or more switches; transmitting, from the centralized controller to the management agent, intended configuration for the one or more switches and the ports; receiving, at the centralized controller from the management agent, current operational state of the one or more switches and the ports; and transmitting, from the centralized controller to the management agent, forwarding entries for installation on the one or more switches. Establishing the bidirectional streaming connection may include the management agent opening a server-side streaming endpoint and the centralized controller connecting as a client. The phase identifier in each message may indicate the protocol phase to which the message belongs, enabling the receiving party to validate protocol compliance. The keepalive and dead interval values may be negotiated as part of the first message exchange and may govern connection liveness detection for the duration of the connection.

In some implementations of the method, the negotiating, the receiving of identity information, the transmitting of intended configuration, the receiving of current operational state, and the transmitting of forwarding entries are performed in a sequential order; and further comprising: upon receiving a message with a phase identifier inconsistent with a current protocol phase, closing the bidirectional streaming connection. Sequential execution of the method steps may prevent the centralized controller from transmitting configuration before receiving identity information, or from transmitting forwarding entries before receiving operational state. Closing the connection upon a phase violation may trigger a full re-execution of the method from the establishing step.

In some implementations, the method further comprises transmitting, by the management agent, a keepalive message on the bidirectional streaming connection when no other message has been transmitted within a keepalive period; responding, by the centralized controller, to the keepalive message; and closing the bidirectional streaming connection when no message is received within a dead period greater than the keepalive period; wherein the keepalive period and the dead period are based on the keepalive and dead interval values negotiated during the negotiating of communication parameters. The keepalive message may include a message containing the phase identifier and a capabilities field but no data payload. The dead period timer may be reset upon receipt of any message on the bidirectional streaming connection, including data messages, so that keepalive messages are transmitted during periods of inactivity.

In some implementations, the method further comprises when the management agent has no identity information to transmit for the one or more switches, transmitting, by the management agent, at least one message comprising a phase identifier and empty data content. Transmitting an empty data message may signal to the centralized controller that the management agent has completed the identity information phase with no data to report. This may allow the centralized controller to distinguish between "no devices managed" and "identity information phase not yet started," enabling the protocol to advance to the next phase.

In some implementations of the method, a non-transitory computer-readable medium comprising instructions which, when executed by a processor, cause the processor to perform the method.

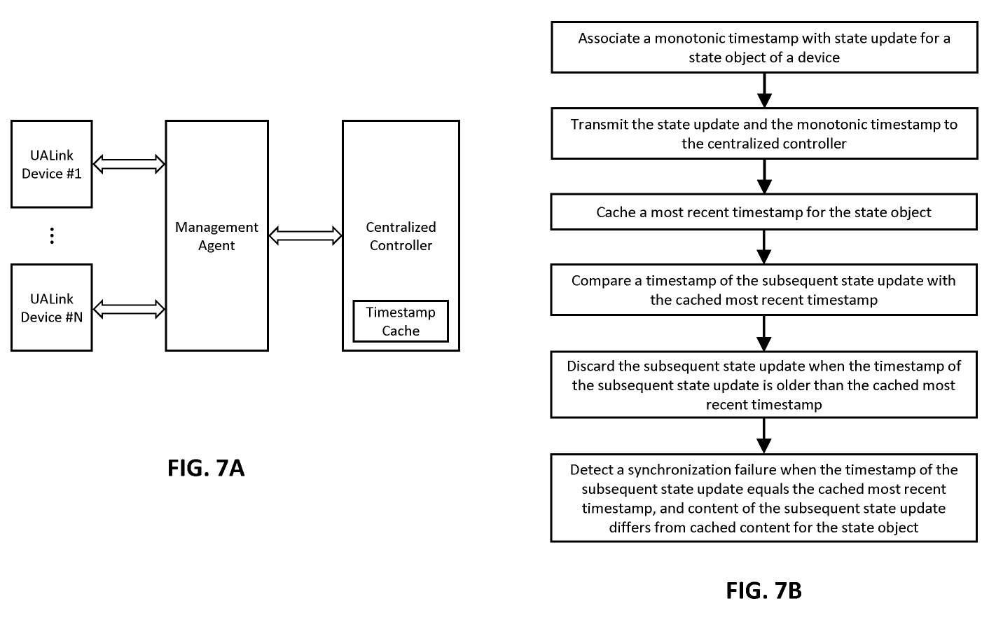

FIG. 7A illustrates a centralized controller managing a UALink-based network, which may exchange state information with management agents over connections on an out-of-band management network. The state information may include operational state updates transmitted from management agents to the centralized controller, and forwarding entries transmitted from the centralized controller to management agents. During the exchange, the state of managed devices may change concurrently, and updates may arrive out of order due to processing or delivery delays. Associating a monotonic timestamp with each state update may enable the receiving party to detect and discard stale updates by comparing timestamps, and to detect state inconsistencies when two updates for the same state object carry equal timestamps but different content.

In various implementations, a network management system comprising: a centralized controller; a management agent managing one or more devices in an Ultra Accelerator Link (UALink)-based network; and a connection between the centralized controller and the management agent; wherein the management agent is configured to: associate a monotonic timestamp with each state update for a state object of the one or more devices, and transmit the state update and the monotonic timestamp to the centralized controller via the connection; wherein the centralized controller is configured to: cache, for each state object, a most recent timestamp received from the management agent; upon receiving a subsequent state update for the state object, compare a timestamp of the subsequent state update with the cached most recent timestamp; discard the subsequent state update when the timestamp of the subsequent state update is older than the cached most recent timestamp; and when the timestamp of the subsequent state update equals the cached most recent timestamp, and content of the subsequent state update differs from cached content for the state object, detect a synchronization failure. The management agent may associate timestamps with state updates representing operational attributes of managed devices, including port states, link quality indicators, neighbor validation states, and administrative state mirrors. The centralized controller may cache the most recent timestamp for each independently updatable state object, such that individual state objects are tracked independently. Detecting a synchronization failure upon equal-timestamp content mismatch may indicate that the management agent generated two distinct values for the same state object at the same logical time, which may represent an implementation error in the management agent's timestamp generation or state tracking. The monotonic timestamps may have nanosecond resolution referenced to a common time base, enabling the centralized controller to distinguish back-to-back state changes for the same state object. The connection may be established over an out-of-band management network separate from the UALink data-plane network.

In some implementations of the system, upon detecting the synchronization failure, the centralized controller is configured to close the connection with the management agent. Closing the connection upon detecting a synchronization failure may trigger a full reconnection and re-synchronization of all states, providing a clean-slate recovery from the detected inconsistency.

In some implementations of the system, the management agent is further configured to: pre-construct a snapshot of operational state of the one or more devices before a synchronization period; during the synchronization period, transmit entries from the snapshot to the centralized controller; and concurrently with transmitting the snapshot entries, transmit independent state updates for state changes occurring during the synchronization period, each independent state update carrying a timestamp newer than a corresponding snapshot entry; wherein the centralized controller resolves ordering between snapshot entries and the independent state updates based on the monotonic timestamps. The management agent may pre-construct the snapshot to minimize the time between receiving operational state from managed devices and beginning transmission to the centralized controller. State changes occurring after the snapshot is constructed may be sent as independent updates with more recent timestamps, which the centralized controller may use to overwrite corresponding snapshot entries that have older timestamps.

In some implementations of the system, the monotonic timestamps have sufficient resolution to distinguish back-to-back state changes for the same state object; and wherein the monotonic timestamps are monotonic for a duration of the connection. The timestamps may have nanosecond resolution and may reference a common time base such as Unix epoch. Monotonicity scoped to the connection duration may allow the management agent to reset its timestamp source upon reconnection without affecting the staleness detection mechanism for the new connection.

In some implementations of the system, the centralized controller is further configured to log discarded state updates for diagnostic purposes, enabling detection of systematic message delivery ordering problems across the connection. The logged information may include the state object identifier, the discarded timestamp, the cached timestamp, and optionally the content of the discarded update. Patterns in the logged discards may indicate persistent network delays or management agent implementation issues.

In some implementations of the system, the one or more devices comprise switches in the UALink-based network, and wherein the state objects comprise operational attributes of the switches and ports on the switches, the operational attributes including at least one of: a port operational state, a link quality indicator, a neighbor validation state, or a link layer state. The port operational state may indicate one of several states such as administratively down, operationally down, initializing, operationally up, or degraded. The link quality indicator may indicate whether a link is healthy, marginal, or unhealthy. The neighbor validation state may indicate whether a configured neighbor has been discovered, validated, or found invalid.

In some implementations of the system, the centralized controller and the management agent are configured to synchronize state through a plurality of ordered phases over the connection; and wherein the management agent transmits the state updates with the monotonic timestamps during a phase of the ordered phases in which the management agent transmits operational state, and during a subsequent phase in which the centralized controller and the management agent exchange updates bidirectionally. During the operational state phase, the management agent may transmit a bulk synchronization of operational state with timestamps. During the subsequent bidirectional phase, the management agent may continue to transmit state changes with timestamps as they occur. The centralized controller may apply the staleness detection logic in both phases.

In some implementations of the system, the centralized controller is further configured to apply different staleness detection policies for different types of state objects, wherein a first staleness detection policy for operational state objects detects the synchronization failure upon equal-timestamp content mismatch, and a second staleness detection policy for telemetry objects discards stale updates without detecting the synchronization failure upon equal-timestamp content mismatch. Operational state objects such as port state transitions may require strict content mismatch detection because an inconsistency may indicate a protocol error. Telemetry objects such as byte counters or histograms may tolerate reordering without triggering a failure because telemetry sampling inherently introduces timing variations.

In some implementations of the system, the centralized controller is configured to maintain connections with a plurality of management agents and is further configured to compare timestamp progressions across the plurality of management agents to detect timestamp drift; and wherein upon detecting drift exceeding a threshold, the centralized controller is configured to trigger a resynchronization of timestamps with the management agent exhibiting the drift. The centralized controller may compare the rate of timestamp advancement from each management agent. A management agent whose timestamps advance at a rate that deviates from the other management agents by more than a configurable threshold may have a desynchronized clock, which could cause the centralized controller to incorrectly discard valid updates or accept stale updates.

In some implementations of the system, the centralized controller is further configured to persist the logged discarded state updates to a non-volatile storage, enabling diagnostic analysis of message delivery ordering problems after a restart of the centralized controller. Persisting the diagnostic log may enable correlation of ordering problems across multiple connection sessions. The log may include connection session identifiers to distinguish discards from different connections.

In some implementations of the system, the centralized controller is further configured to apply a grace period during an initial synchronization with the management agent, during which equal-timestamp content mismatches are logged but do not trigger detection of the synchronization failure; and wherein after the grace period expires, equal-timestamp content mismatches trigger detection of the synchronization failure. The grace period may correspond to a period during which the management agent transmits a pre-constructed snapshot while concurrent state changes may produce overlapping timestamps. After the initial synchronization is complete, the timestamp generation may have stabilized, and content mismatches may indicate actual errors.

In some implementations of the system, the centralized controller is configured to maintain connections with a plurality of management agents, each managing respective devices in the UALink-based network; and wherein the centralized controller is configured to cache timestamps independently for each management agent such that staleness detection for state objects from one management agent is independent of staleness detection for state objects from another management agent. Independent timestamp caching may allow each management agent to use its own monotonic timestamp source without requiring clock synchronization across management agents. The centralized controller may maintain a separate timestamp cache per connection.

FIG. 7B illustrates implementations for maintaining state coherence between a centralized controller and a management agent in a UALink-based network using monotonic timestamps to detect and discard stale state updates.

In various implementations, a method for maintaining state coherence between a centralized controller and a management agent managing one or more devices in a UALink-based network, comprising: associating, by the management agent, a monotonic timestamp with each state update for a state object of the one or more devices; transmitting, by the management agent, the state update and the monotonic timestamp to the centralized controller via a connection; caching, at the centralized controller, a most recent timestamp for each state object received from the management agent; upon receiving a subsequent state update for the state object, comparing, by the centralized controller, a timestamp of the subsequent state update with the cached most recent timestamp; discarding, by the centralized controller, the subsequent state update when the timestamp of the subsequent state update is older than the cached most recent timestamp; and when the timestamp of the subsequent state update equals the cached most recent timestamp, and content of the subsequent state update differs from cached content for the state object, detecting a synchronization failure. The method steps may be performed during an operational state synchronization phase and during normal bidirectional operations between the centralized controller and the management agent. The caching may be performed per state object, such that each independently updatable attribute or container is tracked with its own most recent timestamp. The comparing and discarding may occur for each received state update individually, enabling real-time staleness detection as updates arrive.

In some implementations, the method further comprises logging, by the centralized controller, the discarded subsequent state update for diagnostic purposes. The logging may capture the state object identifier, both the stale and cached timestamps, and optionally the content, enabling analysis of delivery ordering patterns.

In some implementations, the method further comprises pre-constructing, by the management agent, a snapshot of operational state of the one or more devices before a synchronization period; during the synchronization period, transmitting entries from the snapshot and concurrently transmitting independent state updates for state changes occurring during the synchronization period; and resolving, by the centralized controller, ordering between snapshot entries and the independent state updates based on the monotonic timestamps. The independent state updates may carry timestamps newer than the corresponding snapshot entries, enabling the centralized controller to apply the more recent values and discard the stale snapshot entries.

In some implementations, the method further comprises upon detecting the synchronization failure, closing the connection between the centralized controller and the management agent. Closing the connection may trigger a full re-synchronization upon reconnection, restoring a consistent state view between the centralized controller and the management agent.

In some implementations, the method further comprises when the subsequent state update is not discarded and indicates a port failure, recalculating, by the centralized controller, affected forwarding entries based on the subsequent state update; and distributing updated forwarding entries to the management agent. Recalculating forwarding entries for state updates that survive the staleness check may prevent the centralized controller from reverting forwarding entries based on outdated state information. A port failure indication may trigger removal of forwarding entries routing through the failed port.

In some implementations of the method, a non-transitory computer-readable medium comprising instructions which, when executed by a processor, cause the processor to perform the method.

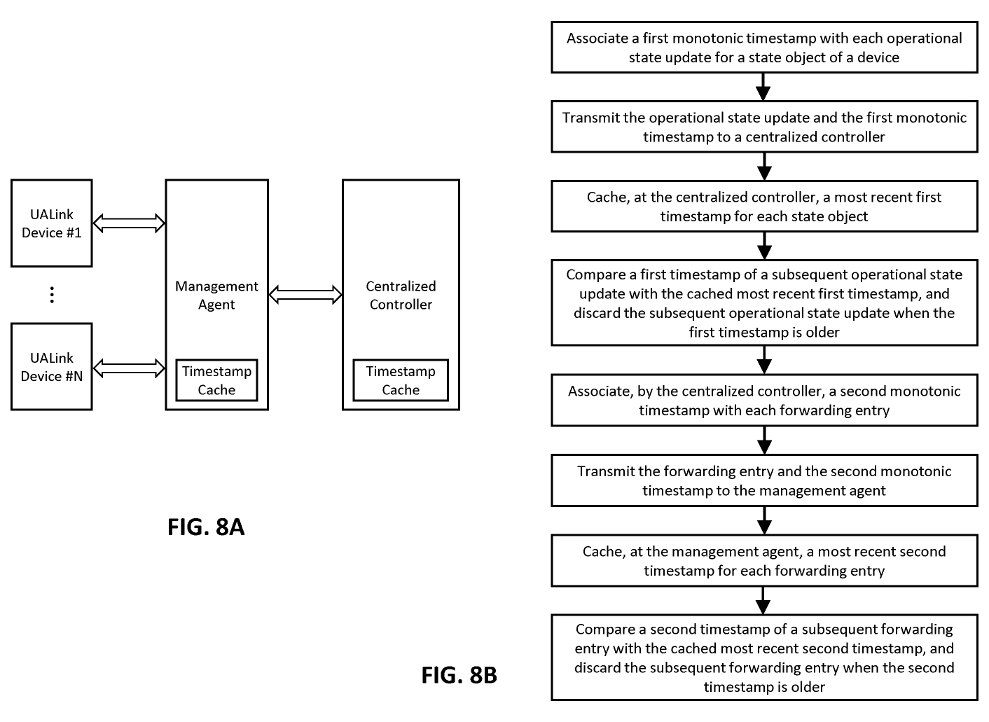

FIG. 8A illustrates a network management system applying bidirectionally the same timestamp-based staleness detection mechanism. The centralized controller may apply the mechanism to operational state updates received from the management agent, and the management agent may apply the mechanism to forwarding entries received from the centralized controller. This symmetric application may provide consistency guarantees in both directions over a connection where updates may arrive out of order.

In various implementations, a network management system comprising: a centralized controller; and a management agent managing one or more devices in a UALink-based network; wherein the management agent is configured to: associate a first monotonic timestamp with each operational state update for a state object of the one or more devices, and transmit the operational state update and the first monotonic timestamp to the centralized controller; wherein the centralized controller is configured to: cache, for each state object, a most recent first timestamp received from the management agent; upon receiving a subsequent operational state update, compare a first timestamp of the subsequent operational state update with the cached most recent first timestamp; and discard the subsequent operational state update when the first timestamp of the subsequent operational state update is older than the cached most recent first timestamp; wherein the centralized controller is further configured to: associate a second monotonic timestamp with each forwarding entry transmitted to the management agent, and transmit the forwarding entry and the second monotonic timestamp to the management agent; wherein the management agent is further configured to: cache, for each forwarding entry, a most recent second timestamp received from the centralized controller; upon receiving a subsequent forwarding entry, compare a second timestamp of the subsequent forwarding entry with the cached most recent second timestamp; and discard the subsequent forwarding entry when the second timestamp of the subsequent forwarding entry is older than the cached most recent second timestamp. The bidirectional staleness detection may provide a symmetric consistency guarantee over the connection. The centralized controller may use the first timestamps to maintain an accurate view of the operational state reported by the management agent, discarding out-of-order operational state updates. The management agent may use the second timestamps to maintain accurate forwarding entries in the switches, discarding out-of-order forwarding entry updates that may occur when the centralized controller recalculates routes while previously calculated routes are still in transit. The first and second monotonic timestamps may be generated independently by the management agent and the centralized controller respectively, each maintaining its own monotonic clock source. The second timestamps may represent a synthesis time at which the centralized controller calculated the forwarding entry.

In some implementations of the system, the management agent is further configured to, when the second timestamp of the subsequent forwarding entry equals the cached most recent second timestamp and content of the subsequent forwarding entry differs from cached content for the forwarding entry, detect a synchronization failure. Content mismatch detection in the forwarding entry direction may catch errors in the centralized controller's route calculation or serialization, where two different forwarding entries are generated with the same synthesis timestamp. The management agent may respond to the synchronization failure by closing the connection.

In some implementations of the system, the one or more devices comprise switches in the UALink-based network; wherein the forwarding entries are installed into route tables on the switches, each route table indexed by a destination accelerator identifier; and wherein the route tables control routing of UALink Protocol Level Interface (UPLI) transactions between accelerators in the UALink-based network. Each route table entry may contain an allow or deny indication and an egress port designation. The route table may be indexed by a 10-bit destination accelerator identifier carried in UPLI request and response messages. Stale forwarding entries discarded by the management agent may prevent outdated route table programming that could route transactions to incorrect egress ports.

In some implementations of the system, the centralized controller and the management agent are configured to synchronize state through a plurality of ordered phases; wherein the management agent transmits the operational state updates with the first monotonic timestamps during a phase in which the management agent transmits operational state; wherein the centralized controller transmits the forwarding entries with the second monotonic timestamps during a phase in which the centralized controller transmits forwarding entries; and wherein during a subsequent phase, the centralized controller and the management agent exchange both operational state updates and forwarding entries bidirectionally with their respective timestamps. During the operational state phase, the centralized controller may apply staleness detection to incoming operational state while the management agent has not yet received any forwarding entries. During the route phase, the management agent may apply staleness detection to incoming forwarding entries. During the subsequent bidirectional phase, both staleness detection mechanisms may operate concurrently.

In some implementations of the system, the centralized controller is further configured to, upon detecting that a threshold number of operational state updates from the management agent have been discarded as stale, request a selective resynchronization of the affected state objects from the management agent without closing the connection. Selective resynchronization may involve the centralized controller identifying the stale state objects by their identifiers and requesting the management agent to retransmit current values for those specific objects with fresh timestamps. This may avoid the overhead of a full reconnection and re-execution of all synchronization phases.

In some implementations of the system, the centralized controller is further configured to maintain a version history of forwarding entries transmitted to the management agent, each version associated with its second monotonic timestamp; and wherein upon detecting that a set of forwarding entries produced incorrect routing behavior, the centralized controller is configured to retransmit a prior version of the forwarding entries to the management agent. The version history may enable the centralized controller to roll back forwarding entries to a known-good configuration upon detecting a routing error, without requiring a full route recalculation from the current topology and operational state.

FIG. 8B illustrates a method for maintaining bidirectional state coherence between a centralized controller and a management agent in a UALink-based network, where the same timestamp-based staleness detection mechanism is applied symmetrically to both operational state updates and forwarding entries.

In various implementations, a method for maintaining bidirectional state coherence between a centralized controller and a management agent managing one or more devices in a UALink-based network, comprising: associating, by the management agent, a first monotonic timestamp with each operational state update for a state object of the one or more devices; transmitting, by the management agent, the operational state update and the first monotonic timestamp to the centralized controller; caching, at the centralized controller, a most recent first timestamp for each state object; upon receiving a subsequent operational state update, comparing a first timestamp of the subsequent operational state update with the cached most recent first timestamp, and discarding the subsequent operational state update when the first timestamp is older than the cached most recent first timestamp; associating, by the centralized controller, a second monotonic timestamp with each forwarding entry; transmitting, by the centralized controller, the forwarding entry and the second monotonic timestamp to the management agent; caching, at the management agent, a most recent second timestamp for each forwarding entry; and upon receiving a subsequent forwarding entry, comparing a second timestamp of the subsequent forwarding entry with the cached most recent second timestamp, and discarding the subsequent forwarding entry when the second timestamp is older than the cached most recent second timestamp. The method steps may be performed concurrently, with the centralized controller applying staleness detection to incoming operational state updates while the management agent applies staleness detection to incoming forwarding entries. The first and second monotonic timestamps may be generated independently by the management agent and the centralized controller respectively, using their own clock sources. The caching, comparing, and discarding steps in both directions may operate identically, providing a symmetric consistency guarantee.

In some implementations, the method further comprises when the first timestamp of the subsequent operational state update equals the cached most recent first timestamp and content of the subsequent operational state update differs from cached content, detecting a first synchronization failure; and when the second timestamp of the subsequent forwarding entry equals the cached most recent second timestamp and content of the subsequent forwarding entry differs from cached content for the forwarding entry, detecting a second synchronization failure. The first and second synchronization failures may be detected independently. Either detection may trigger closing the connection and re-executing a full synchronization between the centralized controller and the management agent.

In some implementations, the method further comprises recalculating, by the centralized controller, forwarding entries based on a change in operational state; transmitting the recalculated forwarding entries with second monotonic timestamps newer than second monotonic timestamps of previously transmitted forwarding entries for the same destinations; and discarding, by the management agent, the previously transmitted forwarding entries that arrive after the recalculated forwarding entries based on the second monotonic timestamps. Route recalculation may occur when the centralized controller receives an operational state change indicating a port failure or recovery. The recalculated forwarding entries may carry synthesis timestamps that are newer than the timestamps on the previously transmitted entries, enabling the management agent to install the most recent version.

In some implementations, the method further comprises assigning, by the centralized controller, a unique accelerator identifier to each accelerator in the UALink-based network; wherein each forwarding entry maps a destination accelerator identifier to an egress port on a switch in the UALink-based network. The centralized controller may assign accelerator identifiers through node management agents. The forwarding entries may be indexed by the destination accelerator identifier in route tables on the switches.

In some implementations of the method, the centralized controller performs concurrent virtual partition operations comprising creating a first virtual partition and modifying a second virtual partition, the concurrent operations producing forwarding entries for the same switch; and wherein the management agent uses the second monotonic timestamps to install the forwarding entries associated with the most recent virtual partition operation for each route table entry. Concurrent virtual partition operations may produce forwarding entries that target the same route table entries on a switch, for example when an accelerator is moved from one virtual partition to another. The synthesis timestamps may establish which forwarding entry reflects the intended final state, enabling the management agent to resolve conflicts without requiring explicit coordination from the centralized controller. In some examples, the virtual partition refers to a virtual pod (vPod).

In some implementations of the method, a non-transitory computer-readable medium comprising instructions which, when executed by a processor, cause the processor to perform the method.

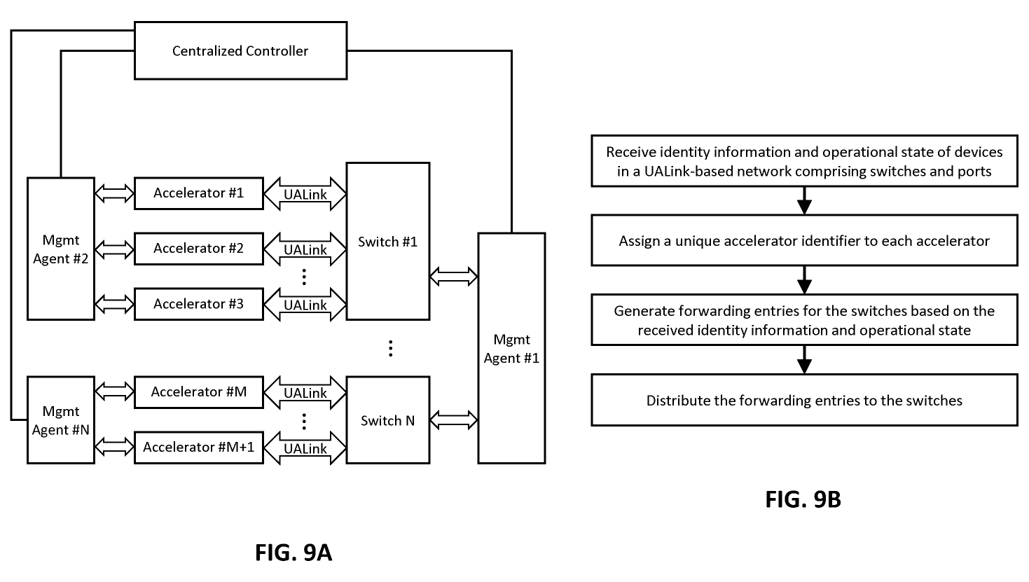

FIG. 9A illustrates a centralized controller managing a UALink-based network, which may receive identity information and operational state from management agents associated with switches and accelerators, and may use this information to generate forwarding entries that control how switches route transactions between accelerators. The centralized controller may assign a unique accelerator identifier to each accelerator, and each forwarding entry may map a destination accelerator identifier to an egress port on a switch. The forwarding entries may be distributed to the switches via the management agents for installation into route tables that control transaction routing. The centralized controller may construct a topology from the received information, validate the topology against connectivity rules, and apply optimization strategies when generating forwarding entries.

In various implementations, a system for managing an Ultra Accelerator Link (UALink)-based network, comprising: a plurality of accelerators coupled to a plurality of switches; a plurality of management agents coupled to a centralized controller via a management network; and wherein the centralized controller is configured to: receive, from the plurality of management agents, identity information and operational state of devices in the UALink-based network comprising the plurality of switches and ports on the plurality of switches; assign a unique accelerator identifier to each of the plurality of accelerators via the plurality of management agents; generate forwarding entries for the plurality of switches based on the received identity information and operational state, wherein each forwarding entry maps a destination accelerator identifier to an egress port on a respective switch; and distribute the forwarding entries to the plurality of switches via the plurality of management agents. The centralized controller may receive identity information describing hardware identifiers, firmware versions, vendor information, supported capabilities, and port attributes from each management agent. The operational state may include port link states, neighbor validation states, link quality indicators, and data link layer states. The centralized controller may use the identity information to determine the number, type, and capabilities of switches and ports in the network, and the operational state to determine which ports are operational and which neighbors have been validated. The unique accelerator identifier may be a value assigned by the centralized controller and communicated to each accelerator via the management agents, enabling the switches to route transactions based on the destination accelerator identifier carried in each transaction. The forwarding entries may be calculated by the centralized controller using a route generation algorithm that considers the network topology, operational port states, and virtual partition membership. The management network may be an out-of-band network separate from the UALink data-plane network.

In some implementations of the system, the centralized controller is further configured to construct a topology of the UALink-based network based on the received identity information and operational state, and generate the forwarding entries based on the topology. The centralized controller may construct the topology by correlating identity information from switch management agents with identity and neighbor information from node management agents, building a representation of how accelerators are coupled to switches and which ports are connected to which devices. The topology may be used as the basis for route computation.

In some implementations of the system, the centralized controller is further configured to validate the topology against a set of connectivity rules comprising: each of the plurality of accelerators has a same number of ports; each of the plurality of switches is coupled to each of the plurality of accelerators; and all ports use a same bifurcation mode; and wherein the centralized controller is configured to reject the topology when a connectivity rule is violated. The connectivity rules may reflect architectural requirements of the UALink-based network. The uniform port count rule may allow each accelerator to have equal bandwidth to the switches. The full connectivity rule may allow any accelerator to reach any other accelerator through any switch. The uniform bifurcation rule may allow consistent routing table structure across all switches. Rejecting a non-compliant topology may prevent the centralized controller from generating forwarding entries that would produce incorrect routing behavior.

In some implementations of the system, the centralized controller is further configured to persist the topology and the forwarding entries to a non-volatile storage, enabling recovery of the centralized controller after a restart without requiring re-discovery of the identity information and the operational state from the plurality of management agents. Persisting the topology and forwarding entries may allow the centralized controller to resume management operations after a restart by loading the saved state, verifying that the network configuration has not changed, and resuming normal operations without re-executing a full discovery and route generation cycle. The persisted state may include the constructed topology, the assigned accelerator identifiers, and the computed forwarding entries for each switch.

In some implementations of the system, the plurality of management agents comprise: a switch management agent associated with at least one of the plurality of switches, the switch management agent configured to receive the forwarding entries from the centralized controller and install the forwarding entries on the at least one switch via a hardware abstraction interface; and a node management agent associated with a system node hosting at least one of the plurality of accelerators, the node management agent configured to communicate the unique accelerator identifier assigned by the centralized controller to the at least one accelerator. The switch management agent may communicate with the centralized controller via a first management protocol and may install forwarding entries on the switch via a vendor-neutral application programming interface that abstracts the switch hardware. The node management agent may communicate with the centralized controller via a second management protocol different from the first management protocol, and may communicate the accelerator identifier to the accelerator via a vendor-defined interface.

In some implementations of the system, each forwarding entry comprises a virtual partition identifier, a logical switch identifier, a destination accelerator identifier, and an egress port number. The virtual partition identifier may associate the forwarding entry with a specific virtual partition, enabling the switch to enforce traffic isolation between virtual partitions. The logical switch identifier may associate the forwarding entry with a specific switching plane within a physical switch for bandwidth aggregation.

In some implementations of the system, at least a subset of the forwarding entries further comprises a source accelerator identifier and an ingress port number, enabling per-flow routing based on both a source and a destination of traffic. Per-flow routing may allow the centralized controller to distribute traffic from a single source accelerator across multiple switching planes by assigning different egress ports to different source-destination pairs. This may increase aggregate bandwidth between accelerators compared to destination-only routing.

In some implementations of the system, each of the plurality of switches comprises a physical switch partitioned into a plurality of logical switches, each logical switch comprising a number of ports equal to a number of the plurality of accelerators in the UALink-based network; and wherein the centralized controller is configured to generate the forwarding entries for each logical switch independently. The plurality of logical switches may provide multiple independent switching planes for bandwidth aggregation. Each logical switch may contain a complete set of ports connecting to all accelerators in the network, and the centralized controller may generate independent forwarding entries for each logical switch to distribute traffic across the switching planes.

In some implementations of the system, the forwarding entries are installed into route tables on the plurality of switches, each route table indexed by a destination accelerator identifier; wherein each switch contains a separate independently programmable route table for each port; and wherein the route tables control routing of UALink Protocol Level Interface (UPLI) transactions between the plurality of accelerators. Each route table entry may contain an allow or deny indication and an egress port designation. The route table may be indexed by a destination accelerator identifier carried in UPLI request and response messages. The independently programmable route tables per port may enable subdivision of a physical switch into multiple independent logical switches serving different virtual partitions.

In some implementations of the system, the centralized controller is configured to distribute the forwarding entries to the plurality of switches and enable switch ports to carry transactions before enabling a physical layer on the switch ports, such that traffic flows upon completion of neighbor validation on the switch ports. Early route installation may allow the centralized controller to pre-program route tables and pre-enable the switch ports so that transactions begin flowing as soon as the physical layer trains and neighbors are validated, without waiting for a separate route installation step. This may reduce the time from network initialization to workload readiness.

In some implementations of the system, the centralized controller is further configured to: receive a workload communication pattern from a workload orchestrator; and generate the forwarding entries to optimize for the workload communication pattern; wherein for an all-to-all communication pattern, the centralized controller is configured to generate symmetric forwarding entries across switching planes, and for a ring communication pattern, the centralized controller is configured to generate asymmetric forwarding entries that form a directed ring through the plurality of accelerators. The workload communication pattern may specify the communication topology used by an AI training or inference workload, such as all-to-all, ring, tree, or mesh. Symmetric forwarding entries for all-to-all patterns may distribute traffic evenly across all available switching planes. Asymmetric forwarding entries for ring patterns may create directed paths optimized for sequential data passing between accelerators.

In some implementations of the system, the centralized controller is configured to generate flow-based forwarding entries that distribute traffic from a single source accelerator across a plurality of logical switches within a physical switch, wherein different destination accelerators are reached via different egress ports on different logical switches. Distributing traffic across logical switches may maximize aggregate bandwidth between a source accelerator and multiple destination accelerators by utilizing all available switching planes concurrently rather than routing all traffic through a single switching plane.

In some implementations of the system, the centralized controller is further configured to generate, as part of the forwarding entries, configuration for in-network collective operations on the plurality of switches, the configuration comprising at least one of: group table entries mapping collective group identifiers to participating accelerators; queue allocation for collective operation submission queues on ports of the plurality of switches; or a combination thereof. In-network collective operations may allow switches to perform reduction operations on data as it passes through the switch, reducing the amount of data that traverse the network for collective communication patterns such as all-reduce. The group table entries may define which accelerators participate in each collective group, and the queue allocation may reserve switch resources for collective operation processing.

In some implementations of the system, the centralized controller is configured to generate the forwarding entries by evaluating a cost function for candidate paths through the plurality of switches, the cost function incorporating at least one of: link quality indicators reported in the operational state; port utilization derived from port byte counters; path length through the plurality of switches; or a combination thereof; and wherein the cost function is configurable per virtual partition, per workload type, or a combination thereof. The cost function may weigh multiple factors to select paths that balance performance, reliability, and fairness across virtual partitions. Link quality indicators may allow the centralized controller to avoid routing traffic through degraded or marginal links. Port utilization data may allow the centralized controller to balance load across available paths. Configuring the cost function per virtual partition or workload type may allow different optimization strategies for different tenants or workload characteristics.

FIG. 9B illustrates a method for establishing connectivity in a UALink-based network by receiving identity information and operational state from management agents, assigning accelerator identifiers, generating forwarding entries, and distributing the forwarding entries to switches via the management agents.

In various implementations, a method for establishing connectivity in a UALink-based network comprising a plurality of accelerators coupled to a plurality of switches, comprising: receiving, at a centralized controller from a plurality of management agents, identity information and operational state of devices in the UALink-based network comprising the plurality of switches and ports on the plurality of switches; assigning, by the centralized controller, a unique accelerator identifier to each of the plurality of accelerators via the plurality of management agents; generating, at the centralized controller, forwarding entries for the plurality of switches based on the received identity information and operational state, each forwarding entry mapping a destination accelerator identifier to an egress port on a respective switch; and distributing, by the centralized controller, the forwarding entries to the plurality of switches via the plurality of management agents. The receiving may occur via connections established with each management agent over an out-of-band management network. The assigning may involve communicating identifiers to accelerators via node management agents. The generating may involve constructing a topology from the received information and computing forwarding entries based on the topology. The distributing may involve transmitting the forwarding entries to switch management agents, which may install the forwarding entries into route tables on the switches via a hardware abstraction interface.

In some implementations, the method further comprises receiving, at the centralized controller, an operational state change from a management agent of the plurality of management agents, the operational state change indicating a port failure on a switch; recalculating affected forwarding entries based on the operational state change; and distributing updated forwarding entries to the plurality of management agents; wherein the method further comprises receiving, from a management agent, a route type descriptor for a vendor-defined route type supported by a switch managed by the management agent, and generating forwarding entries conforming to the vendor-defined route type based on the route type descriptor. A port failure may trigger removal of forwarding entries that route through the failed port and recalculation of alternative paths. The vendor-defined route type descriptor may specify additional fields and semantics beyond predefined route types, enabling vendor-specific routing optimizations while maintaining interoperability through the centralized controller's route generation pipeline.

In some implementations, the method further comprises maintaining, by the centralized controller, independent connections with the plurality of management agents; and wherein the generating of the forwarding entries is based on aggregated identity information and operational state received from the plurality of management agents via the independent connections. The centralized controller may aggregate identity and operational state from all management agents to build a complete network-wide view before generating forwarding entries. Each management agent may report the state of its managed devices independently, and the centralized controller may compute consistent forwarding entries that account for the state of all switches and accelerators in the network.

In some implementations of the method, a non-transitory computer-readable medium comprising instructions which, when executed by a processor, cause the processor to perform the method.

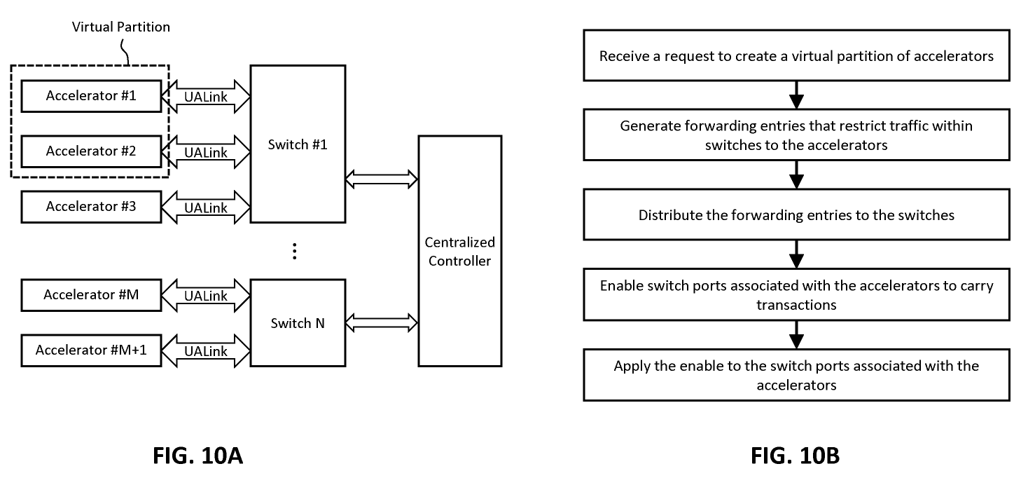

FIG. 10A illustrates a system that manages virtual partitions in a UALink-based network. A virtual partition, which refers to a virtual pod in some examples, may include a designated subset of accelerators that are allowed to communicate with each other, while traffic between accelerators in different virtual partitions is restricted by the forwarding entries installed on the switches. Creating a virtual partition may involve generating forwarding entries that restrict traffic to the designated subset and enabling the associated switch ports to carry transactions after the forwarding entries are in place. This sequencing may prevent transactions from flowing through incorrect or stale routes during the transition.

In various implementations, a system for managing virtual partitions in a UALink-based network, comprising: a plurality of accelerators coupled to a plurality of switches; a centralized controller configured to: receive a request to create a virtual partition comprising a designated subset of the plurality of accelerators; generate forwarding entries that restrict traffic within the plurality of switches to the designated subset of the plurality of accelerators in the virtual partition; distribute the forwarding entries to the plurality of switches; and after the forwarding entries are installed on the plurality of switches, enable switch ports associated with the designated subset of the plurality of accelerators to carry transactions; wherein the enabling is applied to the switch ports associated with the designated subset of the plurality of accelerators. The centralized controller may receive the request from a workload orchestrator, an administrator, or an automated provisioning system. The forwarding entries may include allow indications for routes within the virtual partition and deny indications for routes outside the virtual partition, restricting traffic to the designated subset. The centralized controller may distribute the forwarding entries to the switches via management agents, and the management agents may install the forwarding entries into route tables on the switches. After the forwarding entries are installed, the centralized controller may enable the switch ports to carry transactions by configuring a port attribute that controls whether the port is permitted to transmit and receive transactions. Enabling the ports after the forwarding entries are in place may prevent transactions from flowing through incorrect routes during the transition period. The enabling may be applied to the switch ports associated with the designated subset without affecting switch ports associated with other existing virtual partitions that are already carrying transactions.

In some implementations of the system, before distributing the forwarding entries, the centralized controller is further configured to disable the switch ports associated with the designated subset of the plurality of accelerators from carrying transactions. Disabling the switch ports from carrying transactions before modifying route tables may prevent any residual transactions from being routed according to stale or partially updated forwarding entries. After disabling, the centralized controller may safely modify the route tables and subsequently re-enable the ports.

In some implementations of the system, each forwarding entry comprises an allow or deny indication; wherein upon reset of a switch of the plurality of switches, all forwarding entries on the switch default to deny; and wherein the centralized controller is configured to selectively set forwarding entries to allow for the designated subset of the plurality of accelerators in the virtual partition. The default-deny behavior upon switch reset may provide a secure baseline in which no accelerator can communicate with any other accelerator until the centralized controller explicitly programs allow entries. This may prevent unintended traffic leakage between virtual partitions during initialization or after error recovery.

In some implementations of the system, the centralized controller is further configured to tear down an existing virtual partition by: disabling switch ports associated with the existing virtual partition from carrying transactions; and removing forwarding entries for the existing virtual partition; while maintaining a data link layer on the switch ports such that neighbor validation states are preserved for subsequent virtual partition creation. Maintaining the data link layer during teardown may preserve the neighbor validation states on the affected ports, enabling subsequent virtual partition creation from the same accelerators without requiring the physical layer, data link layer, and neighbor discovery to be re-executed. This may reduce the time required to create a new virtual partition from previously freed accelerators.

In some implementations of the system, when single root I/O virtualization (SR-IOV) is enabled on an accelerator in the designated subset, a single virtual function is provisioned on the accelerator, and physical functions on the accelerator do not issue traffic on the UALink-based network. Restricting each SR-IOV-enabled accelerator to a single virtual function may simplify routing by maintaining a one-to-one mapping between accelerator identifiers and virtual functions. Physical functions may be excluded from UALink traffic to maintain the security boundary for confidential computing environments.

In some implementations of the system, the centralized controller is further configured to add an accelerator to an existing virtual partition by: generating forwarding entries for the added accelerator on the plurality of switches in the virtual partition; distributing the forwarding entries for the added accelerator; and enabling switch ports associated with the added accelerator to carry transactions; wherein the enabling associated with adding the accelerator is applied to the switch ports associated with the added accelerator. Adding an accelerator may extend an existing virtual partition to include additional compute resources without interrupting transactions between accelerators already in the virtual partition. The centralized controller may install forwarding entries for the new accelerator on all relevant switches and then enable the associated ports, following the same enable-after-install sequencing as virtual partition creation.

In some implementations of the system, the centralized controller is further configured to remove an accelerator from an existing virtual partition by: disabling switch ports associated with the removed accelerator from carrying transactions; and removing forwarding entries for the removed accelerator from the plurality of switches; wherein the disabling associated with removing the accelerator is applied to the switch ports associated with the removed accelerator. Removing an accelerator may contract an existing virtual partition without interrupting transactions between the remaining accelerators. The centralized controller may disable the associated ports and remove the forwarding entries for the removed accelerator, while forwarding entries for remaining accelerators continue to operate.

In some implementations of the system, the centralized controller is configured to: receive an accelerator assignment request from a workload orchestrator, the assignment request specifying a number of accelerators and a workload type for a tenant; select the designated subset of the plurality of accelerators based on the assignment request; and create the virtual partition comprising the selected designated subset. The workload orchestrator may manage allocation of compute resources across a plurality of tenants and may specify requirements such as accelerator count, performance tier, and communication pattern. The centralized controller may select accelerators based on availability, proximity, and network topology to optimize for the requested workload type.

In some implementations, the system further comprises a second UALink-based network comprising additional accelerators coupled to additional switches; wherein the centralized controller is configured to create the virtual partition comprising the designated subset of the plurality of accelerators from the UALink-based network and a second designated subset of the additional accelerators from the second UALink-based network. A virtual partition spanning multiple UALink-based networks may enable workloads that require more accelerators than a single network can provide. The centralized controller may coordinate forwarding entries across both networks and may establish inter-network routing through an interconnecting network coupling the two UALink-based networks.

FIG. 10B illustrates a method for creating virtual partitions in a UALink-based network by generating forwarding entries that restrict traffic to a designated subset of accelerators and enabling switch ports to carry transactions after the forwarding entries are installed.

In various implementations, a method for creating a virtual partition in a UALink-based network comprising a plurality of accelerators coupled to a plurality of switches, the method comprising: receiving, at a centralized controller, a request to create a virtual partition comprising a designated subset of the plurality of accelerators; generating, at the centralized controller, forwarding entries that restrict traffic within the plurality of switches to the designated subset of the plurality of accelerators; distributing the forwarding entries to the plurality of switches; and after the forwarding entries are installed on the plurality of switches, enabling switch ports associated with the designated subset of the plurality of accelerators to carry transactions; wherein the enabling is applied to the switch ports associated with the designated subset of the plurality of accelerators. The generating may involve computing forwarding entries that include allow indications for routes within the virtual partition and deny indications for routes outside it. The distributing may involve transmitting the forwarding entries to management agents associated with the switches. The enabling may involve configuring a port attribute that permits the port to transmit and receive transactions, after the forwarding entries are confirmed installed on the switches. The sequencing of enabling after installation may prevent transactions from flowing through incorrect or partially programmed route tables.

In some examples, a virtual partition refers to a virtual pod (vPod) comprising a non-overlapping subset of accelerators within a pod that may communicate amongst themselves but not with accelerators outside the subset. The virtual partition may be assigned to a single tenant, and the switches may enforce traffic isolation between virtual partitions by partitioning switch ports into non-overlapping subsets. The centralized controller may create and tear down virtual partitions independently without affecting other active virtual partitions.

In some implementations, the method further comprises before distributing the forwarding entries, disabling the switch ports associated with the designated subset of the plurality of accelerators from carrying transactions. Disabling the switch ports before distributing forwarding entries may prevent residual transactions from being routed according to stale forwarding entries during the route table update. After disabling, the route tables may be safely updated, and the ports may be re-enabled by the enabling step following installation.

In some implementations of the method, a non-transitory computer-readable medium comprising instructions which, when executed by a processor, cause the processor to perform the method.

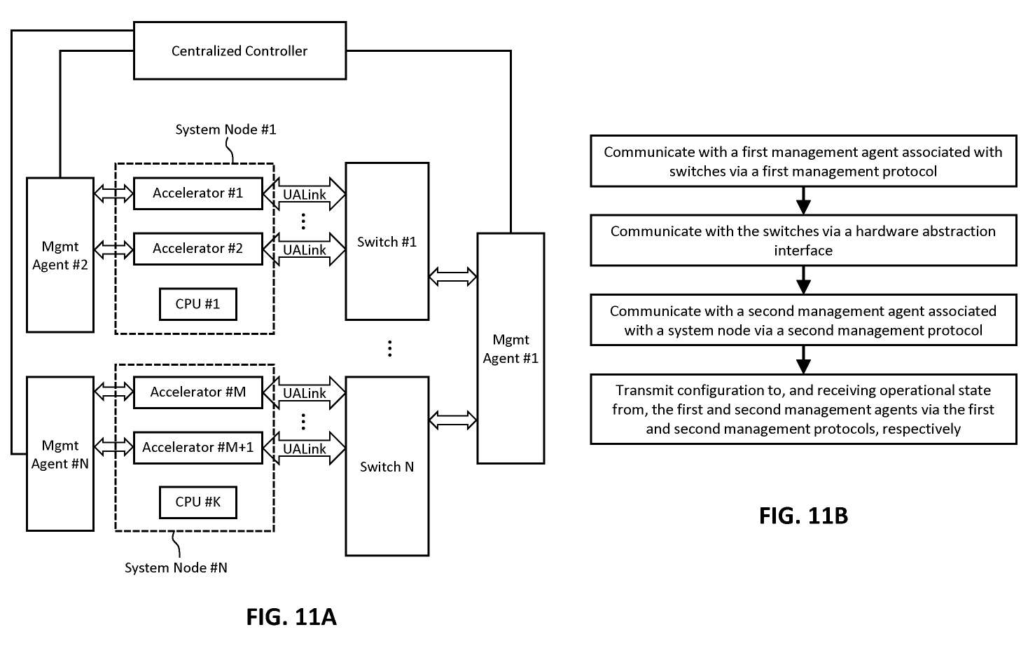

FIG. 11A illustrates a management system for a UALink-based network, comprising a centralized controller communicating with different types of management agents via different management protocols. A first management agent associated with a switch platform may communicate with the centralized controller via a first management protocol and may communicate with one or more switches on the switch platform via a hardware abstraction interface. A second management agent associated with a system node may communicate with the centralized controller via a second management protocol different from the first management protocol. The centralized controller may transmit configuration to and receive operational state from both types of management agents, each via the respective management protocol. The use of different management protocols for different tiers of the management hierarchy may allow each protocol to be selected for the characteristics of its interface.

In various implementations, a management system for an Ultra Accelerator Link (UALink)-based network, comprising: a centralized controller; a first management agent associated with a switch platform comprising one or more switches, the first management agent configured to communicate with the centralized controller via a first management protocol and configured to communicate with the one or more switches via a hardware abstraction interface; and a second management agent associated with a system node comprising one or more accelerators, the second management agent configured to communicate with the centralized controller via a second management protocol different from the first management protocol; wherein the centralized controller is configured to transmit configuration to, and receive operational state from, the first management agent and the second management agent via the first management protocol and the second management protocol, respectively. The centralized controller may coordinate configuration and monitoring of both the switch platform and the system node by exchanging management information with the respective management agents. The first management protocol may be selected for real-time control plane operations requiring bidirectional streaming, while the second management protocol may be selected for resource-oriented management using a request-response model. The hardware abstraction interface may decouple the first management agent from the internal architecture of the one or more switches, allowing the first management agent to manage switches from different vendors without requiring vendor-specific logic. In some implementations, the switch may refer to a physical switch comprising hardware routing circuitry. In other implementations, the switch may refer to a logical switch representing a partition of a physical switch for bandwidth aggregation. The configuration may include intended values for device and port attributes, and the operational state may include current observed values for device and port attributes.

In some implementations of the system, the hardware abstraction interface comprises a vendor-neutral interface enabling the first management agent to manage the one or more switches from different vendors using a single codebase. The vendor-neutral interface may abstract vendor-specific hardware details behind a common set of operations, allowing the first management agent to interact with any switch that provides an implementation of the interface. A vendor-specific software development kit may implement the vendor-neutral interface for each switch vendor's hardware.

In some implementations of the system, the switch platform hosts a plurality of switches from different vendors, each switch comprising a vendor-specific software development kit implementing the hardware abstraction interface; and wherein the first management agent is configured to manage all of the plurality of switches through the hardware abstraction interface. A single switch platform may host switches from multiple vendors to provide flexibility in hardware selection or to support mixed-generation deployments. The first management agent may interact with each switch through the same set of operations regardless of the vendor, with the vendor-specific software development kit translating the operations to vendor-specific hardware commands.

In some implementations of the system, the hardware abstraction interface comprises operations to create, remove, get, and set objects, the objects representing switches, ports, neighbors, and route entries on the one or more switches. The object-oriented operations may allow the first management agent to manage the lifecycle and attributes of each object type independently. Creating a switch object may register the switch with the hardware abstraction interface. Creating port objects may enumerate the ports on the switch. Creating neighbor objects may configure expected neighbors for validation. Creating route entry objects may install forwarding entries into the switch route tables.

In some implementations of the system, the hardware abstraction interface further comprises an asynchronous notification mechanism, the one or more switches configured to report state changes to the first management agent via a registered callback function. The asynchronous notification mechanism may allow the first management agent to receive state change notifications from the switch hardware without polling. The first management agent may register a callback function during initialization, and the switch may invoke the callback when a state change occurs, such as a port state transition or a link quality change.

In some implementations of the system, the management system organizes attributes of the one or more switches and the one or more accelerators into four classifications comprising: identity attributes that are read-only and immutable, configuration attributes that are read-write and represent intended state, operational attributes that are read-only and represent current observed state, and telemetry attributes that are read-only and periodically sampled. The four-class data model may be unified across the first management protocol, the second management protocol, and the hardware abstraction interface, providing a consistent attribute organization regardless of which interface is used to access the attributes. Identity attributes may include device identifiers, firmware versions, and hardware capabilities. Configuration attributes may include administrative states, device identifiers, and port settings. Operational attributes may mirror configuration attributes and include current link states and neighbor validation states. Telemetry attributes may include counters, histograms, and timing measurements.

In some implementations of the system, the first management protocol comprises a gRPC-based interface supporting capabilities, get, set, subscribe, and control remote procedure calls; and wherein the first management agent is configured to operate as a server for the gRPC-based interface and the centralized controller is configured to operate as a client. The gRPC-based interface may provide management plane operations (capabilities, get, set, subscribe) for configuration and monitoring, and a control plane operation (control) for phased state synchronization. The first management agent operating as the server may allow the centralized controller to initiate connections as a client.

In some implementations of the system, the second management protocol comprises a RESTful interface, the second management agent configured to present resource schemas for a manager entity representing the second management agent, processor entities representing the one or more accelerators, and port entities representing ports on the one or more accelerators. The RESTful interface may conform to a management schema standard. The manager entity may represent the second management agent itself. The processor entities may represent individual accelerators hosted on the system node. The port entities may represent the network ports on each accelerator.

In some implementations of the system, the second management agent is configured to communicate with the one or more accelerators via a vendor-defined interface; and wherein the second management agent is configured to present a uniform interface to the centralized controller via the second management protocol regardless of the vendor-defined interface used to communicate with the one or more accelerators. Different accelerator vendors may use different internal management interfaces between the second management agent and the accelerator hardware. The second management agent may translate between the vendor-defined interface and the uniform second management protocol, enabling the centralized controller to manage accelerators from different vendors through the same protocol.

In some implementations of the system, the second management protocol requires mutual TLS authentication between the centralized controller and the second management agent; and wherein the first management protocol requires TLS encryption with mutual TLS authentication recommended between the centralized controller and the first management agent. The asymmetric security requirements may reflect different trust models for switch platforms and system nodes. The stricter mutual TLS requirement for the second management protocol may reflect the sensitivity of accelerator management in multi-tenant environments where system nodes host workloads from different tenants.

In some implementations of the system, the switch platform and the system node each comprise a root of trust; wherein the first management agent and the second management agent are each configured to execute on an attested processor; and wherein the first management agent is configured to attest hardware and firmware of the one or more switches, and the second management agent is configured to attest hardware and firmware of the one or more accelerators. The attestation chain may establish a trust hierarchy from the hardware root of trust through the management agent to the managed devices. The root of trust may provide a hardware anchor for cryptographic identity. The management agents executing on attested processors may verify their own integrity before attesting the hardware and firmware of the devices they manage.

In some implementations, the system further comprises a telemetry collector separate from the centralized controller, the telemetry collector configured to connect to the first management agent via the first management protocol; wherein the telemetry collector has read-only access and is not configured to transmit configuration to the first management agent. Separating the telemetry collection role from the centralized controller may allow dedicated telemetry infrastructure to collect and process performance and diagnostic data without interfering with control plane operations. Multiple telemetry collectors may connect to the same first management agent concurrently.

In some implementations of the system, the centralized controller is configured to run on hardware physically isolated from the UALink-based network, wherein failures of the one or more accelerators, the one or more switches, the first management agent, or the second management agent do not impact operation of the centralized controller. Physical isolation may allow the centralized controller to continue operating and coordinating recovery actions when devices or management agents in the UALink-based network experience failures. The centralized controller may communicate with the management agents via an out-of-band management network separate from the UALink data-plane network.

In some implementations of the system, the first management agent and the second management agent are configured to execute on a same processor within a combined platform comprising both the one or more switches and the one or more accelerators. In smaller deployments such as inference workloads, the switch platform and the system node may be combined into a single platform. The first management agent and the second management agent may run on the same processor or may be integrated into a single software entity that implements both management protocols.

In some implementations of the system, the second management agent is configured to communicate with the one or more accelerators via at least one of: Peripheral Component Interconnect Express (PCIe) sideband communication, mailbox registers accessible over a host bus, a shared memory region mapped into address spaces of both the second management agent and the one or more accelerators, or a combination thereof. The interface between the second management agent and the accelerators may use any communication mechanism available on the system node. PCIe sideband communication may use PCIe configuration space or vendor-specific extended capabilities. Mailbox registers may provide a low-latency command and response mechanism. Shared memory may enable bulk data transfer for telemetry or firmware updates.

In some implementations of the system, the hardware abstraction interface further comprises security mechanisms comprising at least one of: authenticated interface calls between the first management agent and the one or more switches, cryptographic verification of firmware loaded onto the one or more switches via the hardware abstraction interface, encrypted communication between the first management agent and the one or more switches, or a combination thereof. Security mechanisms at the hardware abstraction interface level may protect the communication between the first management agent and the switch hardware from tampering or eavesdropping. These mechanisms may be implemented by the vendor-specific software development kit and may be independent of the security mechanisms used on the management protocols between the centralized controller and the management agents.

In some implementations of the system, the second management agent is further configured to: collect telemetry data from the one or more accelerators via a vendor-defined interface, the telemetry data comprising at least one of: port byte counters, link quality indicators, error statistics, or a combination thereof; and report the telemetry data to at least one of the centralized controller or a telemetry collector via the second management protocol. Accelerator telemetry collection may enable performance monitoring and diagnostics for accelerator network ports. The telemetry data may be collected periodically by the second management agent and reported via the second management protocol using a subscription mechanism.

In some implementations, the system further comprises a federation controller coupled to a plurality of centralized controllers, each centralized controller managing a respective UALink-based network; wherein the federation controller is configured to provide a unified management interface across the plurality of UALink-based networks. A federation controller may enable management of multiple UALink-based networks from a single interface, providing cross-network resource visibility, coordinated virtual partition creation, and unified telemetry aggregation for deployments spanning multiple networks.

In some implementations of the system, the centralized controller is further configured to transmit, via the first management protocol to the first management agent, configuration for in-network collective operations on the one or more switches, the configuration comprising at least one of: group table entries mapping collective group identifiers to participating accelerators, queue allocation for collective operation submission queues on ports of the one or more switches, or a combination thereof. In-network collective operations may allow switches to perform reduction operations on data as it passes through the switch. The centralized controller may configure the group tables and queue allocations as part of virtual partition setup, associating collective groups with the accelerators in each virtual partition.

In some implementations of the system, the centralized controller is further configured to distribute, via the second management protocol, a list of tenant network addresses to the second management agent, the list identifying system nodes with accelerators in a virtual partition, enabling the system node to establish security associations with the identified system nodes. The list of tenant network addresses may include IP addresses for virtual machines or bare metal system nodes with accelerators assigned to the same virtual partition. The system node may use the list to establish encrypted communication channels for securing accelerator-to-accelerator traffic within the virtual partition. In some examples, a virtual partition refers to a virtual pod.

In some implementations of the system, the first management agent is configured to verify a cryptographic signature on an implementation of the hardware abstraction interface before loading it; wherein the implementation comprises a vendor-specific software development kit for the one or more switches. Verifying the cryptographic signature may prevent the first management agent from loading a tampered or unauthorized implementation of the hardware abstraction interface. The vendor may sign the software development kit using a private key, and the first management agent may verify the signature using a corresponding public key or certificate chain.

FIG. 11B illustrates a method for managing a UALink-based network using a three-tier management architecture with differentiated protocols and a hardware abstraction interface.

In various implementations, a method for managing an Ultra Accelerator Link (UALink)-based network, comprising: communicating, by a centralized controller, with a first management agent associated with a switch platform via a first management protocol, the switch platform comprising one or more switches; communicating, by the first management agent, with the one or more switches via a hardware abstraction interface; communicating, by the centralized controller, with a second management agent associated with a system node via a second management protocol different from the first management protocol, the system node comprising one or more accelerators; and transmitting, by the centralized controller, configuration to, and receiving operational state from, the first management agent and the second management agent via the first management protocol and the second management protocol, respectively. The communicating with the first management agent and the second management agent may occur concurrently over separate connections on an out-of-band management network. The hardware abstraction interface may decouple the first management agent from vendor-specific switch hardware, enabling the same method to be applied regardless of the switch vendor. The transmitting and receiving may occur over the same connections used for the communicating steps.

In some implementations of the method, a non-transitory computer-readable medium comprising instructions which, when executed by a processor, cause the processor to perform the method.

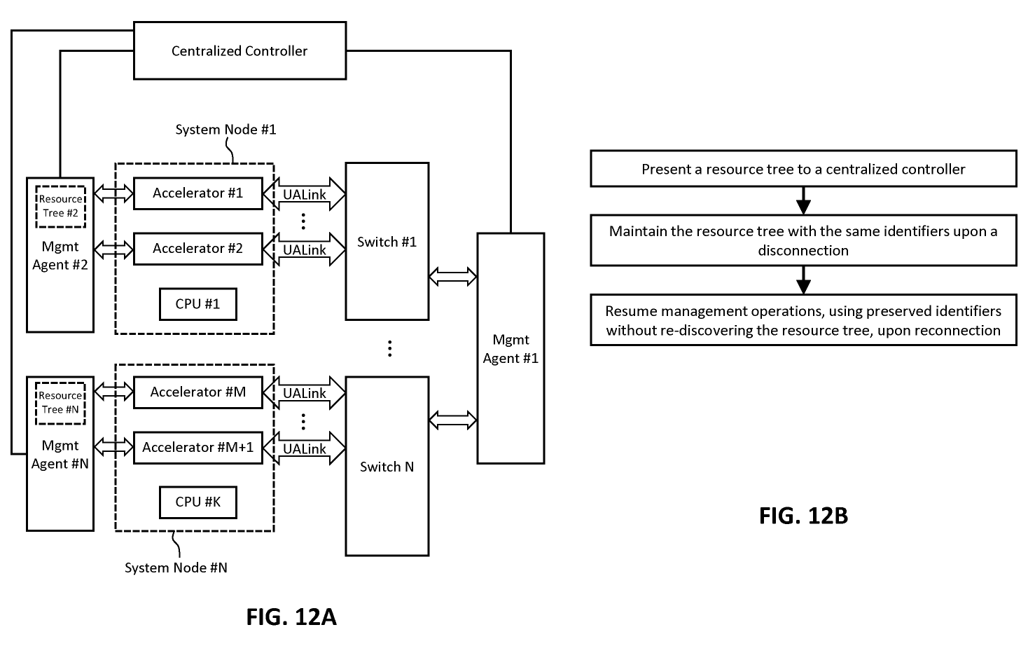

FIG. 12A illustrates a management system in which a management agent presents a resource tree describing accelerators and their ports to a centralized controller. The resource tree may use identifiers that remain stable across disconnections, agent restarts, and configuration changes, enabling the centralized controller to resume management operations upon reconnection without re-discovering the resource tree. In some implementations, the management agent may be a node management agent residing on a system node that hosts the accelerators. The identifiers may include uniform resource identifiers, paths, or other addressing schemes that uniquely identify each resource in the tree.

In various implementations, a management system for an Ultra Accelerator Link (UALink)-based network, comprising: a centralized controller; and a management agent associated with a system node comprising one or more accelerators, the management agent configured to present a resource tree to the centralized controller, the resource tree describing the one or more accelerators and ports on the one or more accelerators using identifiers; wherein the resource tree is configured to remain stable across at least one of: a disconnection of the centralized controller from the management agent, a restart of the management agent, or a configuration change to the one or more accelerators; wherein upon reconnection, the centralized controller resumes management operations using the same identifiers without re-discovering the resource tree. The resource tree may represent a hierarchical structure in which the management agent is a top-level resource, accelerators are child resources of the management agent, and ports are child resources of each accelerator. Each resource in the tree may be assigned an identifier that uniquely identifies it within the tree. The stability requirement may mean that the identifiers assigned to resources do not change when the centralized controller disconnects and reconnects, when the management agent restarts, or when configuration attributes of the accelerators are modified. This stability may enable the centralized controller to maintain a cached representation of the resource tree and resume operations using the cached identifiers upon reconnection, avoiding the latency of a full re-discovery.

In some implementations of the system, the identifiers comprise uniform resource identifiers in a RESTful schema, and wherein the resource tree comprises a hierarchy of resources accessible via the uniform resource identifiers. The uniform resource identifiers may follow a hierarchical path structure such that each accelerator and each port is addressable via a unique path. The RESTful schema may define resource types for the management agent, for each accelerator, and for each port on each accelerator.

In some implementations of the system, the resource tree stability is not required across: addition or removal of hardware components in the system node, a major firmware update to the one or more accelerators, or operation of multiple concurrent instances of the management agent on the system node. Hardware addition or removal may fundamentally change the set of resources in the tree, making identifier stability impractical. A major firmware update may alter the capabilities or structure of the accelerator, requiring new resource representations. Multiple concurrent instances of the management agent may each present their own resource tree, making cross-instance identifier stability undefined.

In some implementations of the system, the resource tree is configured to remain stable across all of: the disconnection of the centralized controller from the management agent, the restart of the management agent, and the configuration change to the one or more accelerators; and wherein the resource tree stability is not required across: the addition or removal of hardware components in the system node, the major firmware update to the one or more accelerators, or the operation of multiple concurrent instances of the management agent on the system node. Requiring stability across all three conditions may provide the strongest management continuity guarantee. The centralized controller may rely on the identifiers remaining stable regardless of which disconnection occurs, while acknowledging that fundamental hardware or software changes may invalidate the resource tree.

FIG. 12B illustrates a method for maintaining a stable resource tree to enable management continuity in a UALink-based network.

In various implementations, a method for managing accelerators in an Ultra Accelerator Link (UALink)-based network, comprising: presenting, by a management agent associated with a system node, a resource tree to a centralized controller, the resource tree describing one or more accelerators and ports on the one or more accelerators using identifiers; upon a disconnection comprising at least one of: a disconnection of the centralized controller from the management agent, a restart of the management agent, or a configuration change to the one or more accelerators, maintaining, by the management agent, the resource tree with the same identifiers; and upon reconnection of the centralized controller, resuming, by the centralized controller, management operations using the preserved identifiers without re-discovering the resource tree. The presenting may include the management agent exposing the resource tree via a management protocol upon initial connection from the centralized controller. The maintaining may include the management agent preserving the identifiers assigned to each resource in the tree during the disconnection, regardless of which specific disconnection occurs. The resuming may include the centralized controller reconnecting and accessing resources using the same identifiers that were valid before the disconnection, without querying the management agent for a new resource tree.

In some implementations of the method, the management agent comprises a node management agent executing on the system node, the node management agent configured to manage UALink network attributes of the one or more accelerators on behalf of the centralized controller. The node management agent may manage UALink network attributes including accelerator identifiers, port configurations, and operational states. In some implementations, the node management agent may communicate with the accelerators via a vendor-defined interface while presenting the resource tree to the centralized controller via a RESTful management protocol.

In some implementations of the method, a non-transitory computer-readable medium comprising instructions which, when executed by a processor, cause the processor to perform the method.

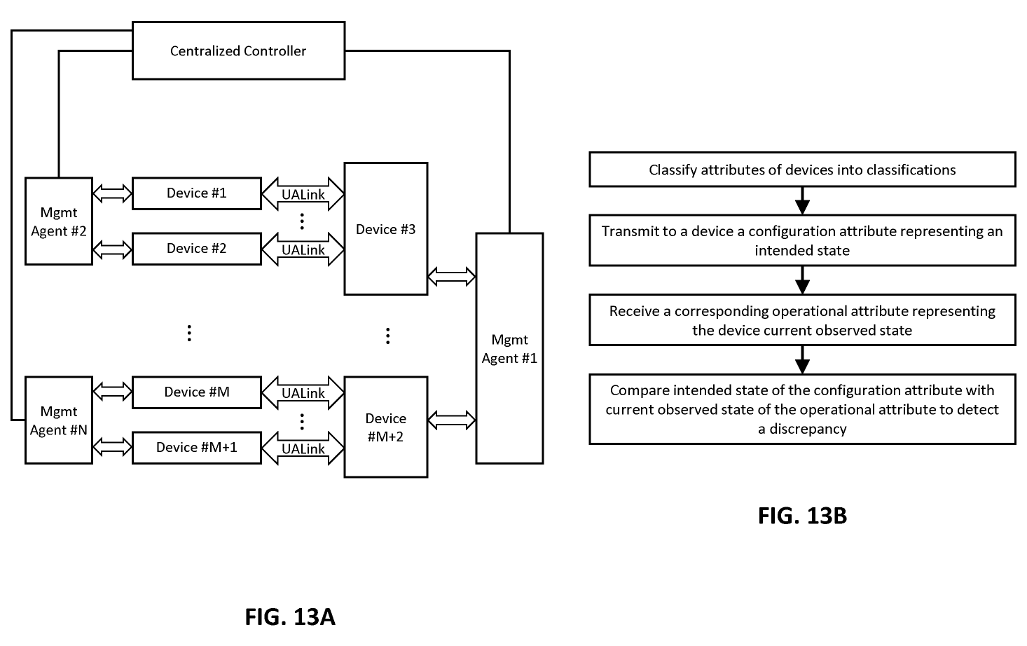

FIG. 13A illustrates a centralized controller managing a UALink-based network, which may classify attributes of managed devices into classifications that include identity attributes, configuration attributes, operational attributes, and telemetry attributes. Identity attributes may be read-only and immutable, representing hardware characteristics that do not change during operation. Configuration attributes may be read-write, representing the intended state that the centralized controller programs into the devices. Operational attributes may be read-only, representing the current observed state of the devices. Telemetry attributes may be read-only and periodically sampled, representing performance and diagnostic measurements. The centralized controller may communicate these attributes via multiple management protocols, each protocol mapping the classifications to protocol-specific data representations. The centralized controller may compare configuration attributes with corresponding operational attributes to detect discrepancies between intended state and current observed state.

In various implementations, a management system for an Ultra Accelerator Link (UALink)-based network, comprising: a plurality of devices, each device comprising at least one UALink-based port; a plurality of management agents coupled to a centralized controller via an out-of-band management network; and wherein the centralized controller is configured to: classify attributes of the plurality of devices into classifications comprising: identity attributes that are read-only and immutable, configuration attributes that are read-write and represent intended state, operational attributes that are read-only and represent current observed state, and telemetry attributes that are read-only and periodically sampled; communicate the attributes to and from the plurality of management agents via a plurality of management protocols, each management protocol mapping the classifications to protocol-specific data representations; and compare, for each device, a configuration attribute with a corresponding operational attribute to detect a discrepancy between the intended state and the current observed state. The centralized controller may manage devices comprising accelerators and switches coupled via UALink-based links. The classifications may provide a uniform attribute model across different management protocols, enabling the centralized controller to access attributes consistently regardless of which protocol is used for a particular device type. The identity attributes may include device identifiers, firmware versions, vendor information, and supported capabilities. The configuration attributes may represent values that the centralized controller intends the device to use, such as administrative states, device identifiers, and port settings. The operational attributes may represent what the device is actually doing, which may temporarily differ from the intended configuration during state transitions or after errors. The telemetry attributes may include counters, histograms, and timing measurements collected periodically for performance monitoring. The comparison between configuration and operational attributes may enable the centralized controller to detect when a device's actual state has diverged from the intended state, whether due to a hardware fault, a management agent failure, or a configuration that the device could not apply. In some implementations, the devices may include switches that route transactions between accelerators based on destination accelerator identifiers.

In some implementations of the system, the plurality of management protocols comprise: a gRPC-based protocol for communicating with a first type of management agent managing switches, a RESTful protocol for communicating with a second type of management agent managing accelerators, and a hardware abstraction interface for communicating between the first type of management agent and the switches, the hardware abstraction interface comprising operations to create, remove, get, and set objects representing switches, ports, neighbors, and route entries. The gRPC-based protocol may support capabilities, get, set, subscribe, and control remote procedure calls. The RESTful protocol may present resource schemas for management agent, accelerator, and port entities. The hardware abstraction interface may decouple the management agent from vendor-specific switch hardware, enabling a single management agent to manage switches from different vendors.

In some implementations of the system, the centralized controller supports notification modes for receiving attributes comprising: a first mode reporting changes to operational attributes upon occurrence, and a second mode reporting telemetry attributes at a configurable sampling interval; and wherein the telemetry attributes comprise credit utilization histograms per virtual channel on each UALink-based port. The first mode may enable the centralized controller to receive operational state changes as they occur without polling, reducing latency for detecting state transitions. The second mode may enable periodic collection of telemetry data at intervals appropriate for the measurement type. The credit utilization histograms may indicate time spent at different credit utilization levels per virtual channel, enabling assessment of flow control health.

In some implementations of the system, the identity attributes comprise at least one of: a device identifier, a vendor identifier, a firmware version, supported protocol versions, supported route types, or a combination thereof. The identity attributes may be gathered during device admission and may remain constant throughout the device's operational lifetime. The supported route types may indicate which forwarding entry formats the device can process.

In some implementations of the system, the configuration attributes comprise at least one of: a physical layer admin state, a transaction layer admin state, a bifurcation mode, an ordering mode, a neighbor validation configuration specifying expected neighbor device identifiers and port numbers, or a combination thereof. The configuration attributes may represent the intended state for each configurable parameter of the device. The transaction layer admin state may control whether a port is permitted to carry transactions. The neighbor validation configuration may specify the expected neighbor for each port, enabling topology verification before traffic flows.

In some implementations of the system, the centralized controller maps data types across the plurality of management protocols, each attribute having a protocol-specific representation in each management protocol while maintaining consistent semantics across all protocols. Data type mappings may include conversions between different representations of the same logical type, such as integer widths, string encodings, and enumeration formats. The consistent semantics may enable the centralized controller to interpret attributes uniformly regardless of the protocol used to access them.

In some implementations of the system, upon detecting the discrepancy between the configuration attribute and the corresponding operational attribute, the centralized controller is configured to transmit a corrective configuration to the device via the management agent to resolve the discrepancy. The corrective configuration may re-transmit the intended configuration attribute to the device, or may transmit a modified configuration that accounts for changed conditions discovered during the comparison.

In some implementations of the system, the centralized controller validates a configuration attribute against validation rules comprising at least one of: permitted value ranges, interdependencies between attributes, or a combination thereof, before transmitting the configuration attribute to a device via a management agent. Validation rules may prevent the centralized controller from transmitting configurations that the device cannot apply, reducing failed configuration attempts. Interdependencies may include relationships such as bifurcation mode constraining the number of available ports per station.

In some implementations of the system, the classifications further support vendor-defined attributes, each vendor-defined attribute having a vendor-defined data type, and wherein the management agents advertise supported vendor-defined attributes during admission to the UALink-based network. Vendor-defined attributes may enable device vendors to extend the attribute model with proprietary management parameters while maintaining compatibility with the classification structure. The management agents may advertise vendor-defined attributes alongside standard attributes during device admission.

In some implementations of the system, the management agents are configured to report changes to operational attributes asynchronously to the centralized controller, each reported change including a monotonic timestamp indicating when the change occurred, the timestamps having sufficient resolution to distinguish consecutive state changes. The monotonic timestamps may enable the centralized controller to order state changes chronologically and to detect stale updates by comparing timestamps. The resolution may be sufficient to distinguish state changes that occur in rapid succession, such as during port bringup sequences.

In some implementations of the system, when a device cannot push telemetry attributes to the management agent, the management agent is configured to poll the device for telemetry attributes via a hardware abstraction interface and report the polled attributes to the centralized controller or a telemetry collector. The poll-fallback may enable consistent telemetry collection regardless of whether the device hardware supports push-based telemetry reporting. The management agent may set a telemetry timer and poll the device when the timer expires if no telemetry has been received from the device since the last report.

In some implementations, the system further comprises a plurality of telemetry collectors, each telemetry collector configured to connect to the management agents via one of the plurality of management protocols, the telemetry collectors having read-only access and not being configured to transmit configuration attributes. Multiple telemetry collectors may enable separation of monitoring concerns, with different collectors gathering telemetry for different purposes such as performance analysis, capacity planning, and fault detection. The read-only access may prevent telemetry collectors from interfering with control plane operations.

In some implementations of the system, the telemetry attributes are structured per protocol layer, comprising: physical layer counters including error correction histograms, data link layer counters including flit transmission and reception counters, transaction layer counters including message counters, and protocol layer counters including byte transmission and reception counters. The per-layer structure may enable targeted diagnostics by isolating performance and error metrics to specific protocol layers. The error correction histograms at the physical layer may indicate link quality trends. The flit counters at the data link layer may indicate link utilization.

In some implementations of the system, the centralized controller is configured to maintain a history of changes to operational attributes for each device, the history comprising the attribute identifier, the previous value, the new value, and the change timestamp, enabling post-mortem analysis of state transitions. The change history may enable root cause analysis of failures by providing a timeline of state transitions leading up to the failure. The history may be stored on the centralized controller and may be retained across management agent disconnections.

In some implementations of the system, upon reconnection of the centralized controller to the management agents after a disconnection, the centralized controller is configured to: re-gather operational attributes from all devices via the management agents; compare each configuration attribute with its corresponding operational attribute across all devices; and prioritize corrective actions, resolving discrepancies in forwarding entries indexed by destination accelerator identifier before resolving discrepancies in port configuration attributes. Prioritizing forwarding entry discrepancies may restore data plane correctness before addressing management plane completeness, minimizing the impact of the disconnection on running workloads. The re-gathering may be performed across all management agents to obtain a complete snapshot of the network's operational state.

FIG. 13B illustrates a method for classifying attributes of devices in a UALink-based network and detecting discrepancies between intended state and current observed state.

In various implementations, a method for managing devices comprising Ultra Accelerator Link (UALink)-based ports, comprising: classifying, by a centralized controller, attributes of the devices into classifications comprising: identity attributes that are read-only and immutable, configuration attributes that are read-write representing intended state, operational attributes that are read-only representing current observed state, and telemetry attributes that are read-only and periodically sampled; transmitting, by the centralized controller via an out-of-band management network, a configuration attribute to a device via a management agent, the configuration attribute representing an intended state for the device; receiving, from the device via the management agent, an operational attribute corresponding to the configuration attribute, the operational attribute representing the current observed state of the device; and comparing the intended state of the configuration attribute with the current observed state of the operational attribute to detect a discrepancy. The classifying may establish a uniform attribute model that spans multiple management protocols used to communicate with different types of management agents. The transmitting may cause the device to apply the intended configuration, and the receiving may provide the centralized controller with the device's actual response to the configuration. The comparing may reveal whether the device successfully applied the intended configuration or whether a discrepancy exists that requires corrective action.

In some implementations, the method further comprises when the discrepancy is detected, transmitting, by the centralized controller, a corrective configuration attribute to the device via the management agent to align the current observed state with the intended state. The corrective configuration attribute may re-transmit the original intended value or may transmit a modified value that accounts for the reason the original configuration could not be applied.

In some implementations, the method further comprises receiving, from the management agent, an asynchronous notification of a change to an operational attribute of the device, the notification including a timestamp and the changed operational attribute, the operational attribute comprising at least one of: a port state, a link quality indicator, a neighbor validation state, or a combination thereof. The asynchronous notification may enable the centralized controller to detect operational state changes without polling. The port state, link quality indicator, and neighbor validation state may be among the most frequently changing operational attributes during network operation.

In some implementations of the method, a non-transitory computer-readable medium comprising instructions which, when executed by a processor, cause the processor to perform the method.

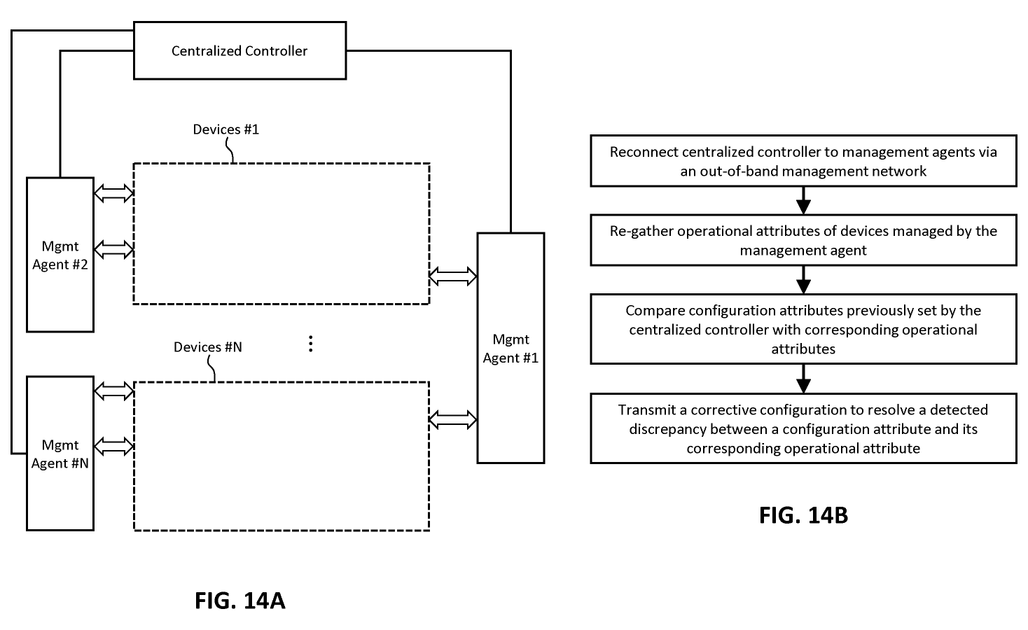

FIG. 14A illustrates a management system in which each device maintains a corresponding operational attribute for each configuration attribute, enabling the centralized controller to systematically compare intended state with current observed state across all configurable parameters of each device.

In various implementations, a management system for an Ultra Accelerator Link (UALink)-based network, comprising: a centralized controller coupled to a plurality of management agents via an out-of-band management network, the management agents managing devices comprising accelerators and switches coupled via UALink-based links; wherein each device maintains: configuration attributes representing intended state set by the centralized controller via the management agents, the configuration attributes comprising at least an administrative state and an accelerator identifier assigned by the centralized controller; and operational attributes representing current observed state, the operational attributes comprising a corresponding operational attribute for each configuration attribute; wherein the centralized controller is configured to detect a discrepancy between a configuration attribute and its corresponding operational attribute, the discrepancy indicating that the device's current state differs from the intended state set by the centralized controller. The correspondence between configuration and operational attributes may mean that for every configurable parameter, there is a readable parameter that reflects what the device is actually doing. For example, when the centralized controller sets an administrative state to "Up" (configuration), the operational administrative state may initially remain "Down" until the device completes the transition, after which it changes to "Up." If the operational state never reaches "Up," the centralized controller may detect the discrepancy and investigate the cause. The accelerator identifier may be a value assigned by the centralized controller and communicated to the device via the management agent. The correspondence may enable systematic reconciliation after management disruptions by comparing all configuration attributes with their operational counterparts.

In some implementations of the system, the operational attributes further comprise attributes not present in the configuration attributes, comprising at least one of: a port state, a physical layer link state, a data link layer state, a neighbor validation state, a link quality indicator, or a combination thereof. Operational-only attributes may represent device state that is not directly configurable by the centralized controller but is observable. The link quality indicator may transition between healthy, marginal, and unhealthy levels based on error rates measured by the device.

In some implementations of the system, each operational attribute includes a change timestamp indicating when the attribute last changed and a change count indicating a number of changes since device initialization, the timestamps being monotonic within a management connection. The change timestamp and change count may enable the centralized controller to determine whether an operational attribute has changed since a previous observation, and to order changes chronologically when multiple attributes change in rapid succession.

In some implementations of the system, the centralized controller is configured to classify detected discrepancies by severity comprising at least one of: a data-plane discrepancy where forwarding entries or port states differ from intended, or a management-plane discrepancy where administrative settings differ from intended; and wherein data-plane discrepancies are resolved before management-plane discrepancies. Prioritizing data-plane discrepancies may restore correct routing and traffic flow before addressing management settings, minimizing the impact of the discrepancy on active workloads.

In some implementations of the system, the centralized controller persists the configuration attributes for each device, and upon reconnection to a management agent after a disconnection, uses the persisted configuration attributes as the basis for comparison with the operational attributes reported by the management agent. Persisting the configuration attributes may enable the centralized controller to know what it previously intended for each device, even after a restart, without relying on the management agent to retain the centralized controller's intent.

In some implementations of the system, the centralized controller maintains a cached copy of a last-known operational state for each device, and upon reconnection, compares the re-gathered operational attributes with the cached operational state to identify changes that occurred during the disconnection. The differential comparison may identify the attributes that changed during the disconnection, reducing the number of corrective actions needed compared to a full re-configuration of all devices.

In some implementations of the system, upon detecting a discrepancy indicating that a device's operational state has changed during a disconnection, the centralized controller is configured to notify a workload orchestrator of the discrepancy, enabling the orchestrator to take corrective action at a workload level. The workload orchestrator may determine whether the discrepancy affects a running workload and may initiate workload migration, checkpointing, or restart depending on the nature and severity of the discrepancy.

In some implementations of the system, the configuration attributes further comprise a virtual partition identifier assigned to each accelerator, and wherein the centralized controller is configured to detect a discrepancy between the intended virtual partition assignment and the operational virtual partition state of the accelerator. A discrepancy in virtual partition assignment may indicate that an accelerator has been incorrectly associated with a different tenant's partition, which may have security and isolation implications requiring immediate corrective action. In some examples, a virtual partition refers to a virtual pod.

FIG. 14B illustrates a method for reconciling state in a UALink-based network after a disconnection of the centralized controller from management agents, by comparing intended configuration attributes with corresponding operational attributes and transmitting corrective configurations where discrepancies are detected.

In various implementations, a method for reconciling state in an Ultra Accelerator Link (UALink)-based network after a disconnection of a centralized controller from management agents, the method comprising: upon reconnection of the centralized controller to the management agents via an out-of-band management network: re-gathering, from each management agent, operational attributes of devices managed by the management agent, the devices comprising accelerators and switches coupled via UALink-based links; comparing, for each device, each configuration attribute previously set by the centralized controller with a corresponding operational attribute received from the management agent; and when a discrepancy is detected between a configuration attribute and its corresponding operational attribute, transmitting a corrective configuration to the device via the management agent to resolve the discrepancy. The re-gathering may involve the centralized controller re-establishing connections with all management agents and receiving current operational attributes for all managed devices. The comparing may involve checking each configuration attribute against its corresponding operational attribute to identify any that differ. The corrective configuration may restore the device to the intended state by re-transmitting the configuration attribute or by transmitting a modified configuration that accounts for changed conditions.

In some implementations of the method, the re-gathering from each management agent is performed concurrently across all management agents, minimizing total reconciliation time. Concurrent re-gathering may reduce the total reconciliation time compared to sequential re-gathering, which may be important when the UALink-based network comprises many management agents each managing multiple devices.

In some implementations of the method, a non-transitory computer-readable medium comprising instructions which, when executed by a processor, cause the processor to perform the method.

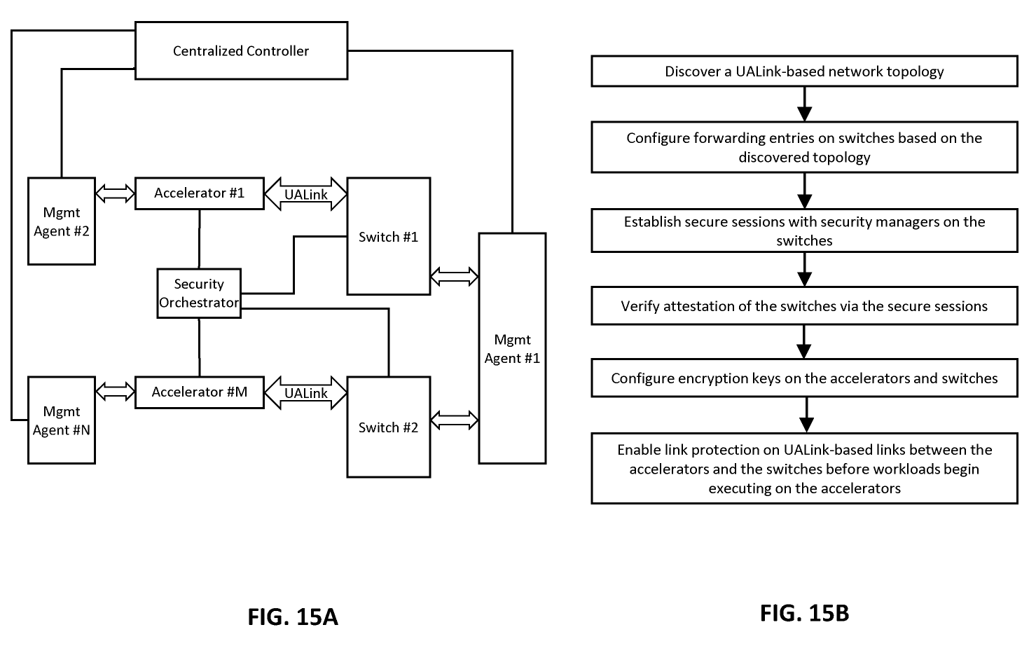

FIG. 15A illustrates a centralized controller and a security orchestrator operating in a sequenced workflow to configure a UALink-based network for secure workload execution. The centralized controller may first discover the network topology via management agents over an out-of-band management network and configure forwarding entries on switches. After the management-plane configuration is complete, the security orchestrator may establish secure sessions with security managers on the switches, verify switch attestation, and configure encryption keys for the accelerators and switches. Link protection on UALink-based links may be enabled before workloads begin executing. This sequencing may prevent encryption keys from being programmed for an incorrect topology and may prevent workloads from executing without link protection.

In various implementations, a system for configuring an Ultra Accelerator Link (UALink)-based network comprising accelerators and switches coupled via UALink-based links, the system comprising: a centralized controller configured to discover a topology of the UALink-based network via management agents over an out-of-band management network, and to configure forwarding entries on the switches; a security orchestrator configured to establish secure sessions with security managers on the switches, verify attestation of the switches, and configure encryption keys for the accelerators and switches; and wherein the centralized controller and the security orchestrator operate in a sequenced workflow comprising: the centralized controller discovering the topology and configuring the forwarding entries before the security orchestrator configures the encryption keys; and the security orchestrator configuring the encryption keys and enabling link protection on the UALink-based links before workloads begin executing on the accelerators. The centralized controller may discover the topology by receiving identity information and operational state from management agents associated with switches and accelerators. The forwarding entries may be installed on the switches via management agents that communicate with the switches through a hardware abstraction interface. The security orchestrator may be implemented as trusted software executing on a host processor or on a dedicated security management platform. The secure sessions may use an authenticated protocol that provides mutual authentication and encryption for the security management channel. The sequenced workflow may be enforced by the security orchestrator requiring topology information from the centralized controller before proceeding with key configuration, creating a dependency that prevents the security orchestrator from configuring keys without a verified management-plane configuration. In some implementations, the security orchestrator may include a trusted virtual machine that orchestrates security configuration across all devices in a virtual partition. In some examples, a virtual partition refers to a virtual pod (vPod).

In some implementations of the system, link protection between the accelerators and the switches is configured before the accelerators transition to a run state for secure workload execution, and wherein the link protection cannot be enabled after the accelerators are in the run state. The constraint that link protection cannot be enabled after the run state may prevent disruption of an active workload by security configuration changes. Both end-to-end link protection between accelerators and accelerator-to-switch link protection may be configured before the run state transition.

In some implementations of the system, the security orchestrator is further configured to, before enabling link protection: verify that switch identifiers and port numbers are unique within a virtual partition; verify that forwarding entries installed by the centralized controller are consistent with the verified topology; and verify that security settings are correctly configured on all switches and accelerators in the virtual partition. Verifying forwarding entry consistency may prevent the security orchestrator from enabling link protection for a topology that does not match the installed routes. Verifying unique identifiers may prevent identity conflicts that could cause encryption key mismatches.

In some implementations of the system, the centralized controller communicates with the management agents via management protocols comprising a gRPC-based protocol and a RESTful protocol, and the security orchestrator communicates with the security managers via a security protocol different from the management protocols. The use of different protocols for the management plane and the security plane may reflect different requirements for each plane. The management protocols may be optimized for configuration and monitoring, while the security protocol may be optimized for mutual authentication, attestation verification, and key exchange.

In some implementations of the system, each security manager on a switch is configured to manage a virtual partition security state comprising transitions between a locked state, a run state, and a stop state; and wherein the security orchestrator transitions the virtual partition security state from the locked state to the run state after verifying attestation and configuring encryption keys. The locked state may prevent modification of the switch configuration for the virtual partition while the security orchestrator verifies and programs keys. The run state may enable secure workload execution. The stop state may be entered when a security violation is detected, halting traffic for the affected virtual partition.

In some implementations of the system, the security orchestrator is configured to configure independent sets of encryption keys comprising: a first set for end-to-end encryption between accelerators via UALink-based links, and a second set for encryption between accelerators and switches for collective operations; and wherein the first set and the second set have independent key lifecycles. The first set of keys may protect unicast traffic that passes through switches without decryption. The second set of keys may protect collective traffic that is decrypted at the switch for in-network computation and re-encrypted before delivery. Independent key lifecycles may allow different rotation frequencies for unicast and collective traffic.

In some implementations of the system, the centralized controller is further configured to distribute a list of tenant network addresses to management agents associated with system nodes comprising accelerators in a virtual partition, the list enabling the accelerators to establish security associations with peer accelerators in the virtual partition. The list of tenant network addresses may include IP addresses for virtual machines or bare metal system nodes with accelerators assigned to the same virtual partition. The accelerators may use the list to establish encrypted communication channels for securing accelerator-to-accelerator traffic.

In some implementations of the system, the security orchestrator is configured to: generate collective master keys; distribute the collective master keys to all accelerators in a virtual partition via secure sessions with device security managers on the accelerators; and distribute the collective master keys to all switches in the virtual partition via secure sessions with switch security managers. Distributing identical collective master keys to all devices in the virtual partition may enable all devices to derive the same encryption keys for collective traffic, ensuring that any accelerator can communicate with any switch for collective operations within the partition.

In some implementations of the system, upon recovery from a failure: the centralized controller first reconciles management state with the management agents by re-gathering identity, configuration, and operational attributes; and after management reconciliation is complete, the security orchestrator re-establishes security sessions and re-verifies attestation before re-enabling link protection on the UALink-based links. Recovery sequencing may follow the same management-before-security ordering as the initial configuration, ensuring that the security orchestrator operates on a verified and reconciled topology. Re-verifying attestation after a failure may detect device compromises that occurred during the failure period.

In some implementations of the system, when an accelerator is added to an existing virtual partition: the centralized controller first installs forwarding entries for the added accelerator on the switches and enables switch ports associated with the added accelerator to carry transactions; and after the forwarding entries are installed, the security orchestrator configures encryption keys for the added accelerator and enables link protection on new UALink-based links, without disrupting existing encryption sessions on other links in the virtual partition. Incremental addition may enable elastic workloads to scale by adding accelerators without reconfiguring security for the entire virtual partition. The sequencing of forwarding entry installation before key configuration may be maintained for each incremental addition.

In some implementations of the system, the centralized controller collects attestation-related identity attributes from devices during admission to the UALink-based network, comprising firmware versions, hardware versions, and security versions; and provides the attestation-related identity attributes to the security orchestrator to assist in attestation verification. Sharing attestation-related attributes from the management plane may reduce the information the security orchestrator needs to gather independently, accelerating the attestation verification process. The centralized controller may have already verified these attributes during device admission.

In some implementations, the system further comprises a security policy engine configured to determine, based on a workload security requirement, which switches require encryption key configuration and which switches are excluded from the security domain, enabling partial trust elevation where switches performing collective operations for the workload receive encryption keys. Partial trust elevation may reduce the security surface by limiting the number of switches that receive encryption keys to those participating in collective operations. Switches that only forward unicast traffic may remain outside the security domain.

In some implementations, the system further comprises a second UALink-based network with a second centralized controller and a second security orchestrator; wherein a federation security orchestrator coordinates encryption key configuration across both networks for a workload spanning both networks. A federation security orchestrator may distribute consistent encryption keys across multiple networks, enabling encrypted communication for workloads that span network boundaries.

In some implementations of the system, when a switch detects an integrity failure on a UALink-based link, a security manager on the switch transitions the virtual partition to a stop state and stops processing transactions for accelerators in the virtual partition; and wherein the security orchestrator is notified of the integrity failure via the centralized controller. The integrity failure may indicate data tampering or a compromised device. Transitioning to the stop state may prevent further communication until the failure is investigated. Notification via the centralized controller may enable coordinated recovery across both the management and security planes.

In some implementations of the system, both end-to-end link protection between accelerators and accelerator-to-switch link protection are configured before workload execution begins, the security orchestrator coordinating configuration of both types of link protection within the sequenced workflow. Configuring both types of link protection upfront may prevent a gap where one type of traffic is protected while another is not. The security orchestrator may coordinate the configuration to ensure both types are active before the virtual partition transitions to a run state.

FIG. 15B illustrates a method for configuring a UALink-based network by sequencing management-plane configuration before security-plane configuration, ensuring that forwarding entries are installed before encryption keys are configured and that link protection is enabled before workloads execute.

In various implementations, a method for configuring an Ultra Accelerator Link (UALink)-based network comprising accelerators and switches coupled via UALink-based links, the method comprising: discovering, by a centralized controller via management agents over an out-of-band management network, a topology of the UALink-based network; configuring, by the centralized controller, forwarding entries on the switches based on the discovered topology; after the forwarding entries are configured, establishing, by a security orchestrator, secure sessions with security managers on the switches; verifying, by the security orchestrator, attestation of the switches via the secure sessions; configuring, by the security orchestrator, encryption keys on the accelerators and switches; and enabling link protection on UALink-based links between the accelerators and the switches before workloads begin executing on the accelerators. The discovering may involve the centralized controller connecting to management agents and receiving identity and operational state from all managed devices. The configuring of forwarding entries may involve generating routes based on the discovered topology and distributing them to switches via the management agents. The establishing of secure sessions may involve mutual authentication between the security orchestrator and each switch's security manager. The verifying may involve checking attestation reports against expected firmware and hardware versions. The configuring of encryption keys may involve generating master keys and distributing them via the secure sessions. The enabling of link protection may involve activating encryption on the UALink-based links for both directions of traffic.

In some implementations, the method further comprises before configuring the encryption keys, verifying, by the security orchestrator, that switch identifiers and port numbers are unique within a virtual partition, and that forwarding entries installed by the centralized controller are consistent with the discovered topology. Verifying consistency between the installed forwarding entries and the discovered topology may prevent the security orchestrator from configuring keys for a topology that does not match the routing configuration.

In some implementations, the method further comprises , upon recovery from a failure of the centralized controller: the centralized controller first reconciling management state with the management agents; and after reconciliation, the security orchestrator re-establishing secure sessions with the security managers and re-enabling link protection on the UALink-based links. The recovery sequencing may follow the same management-before-security ordering as the initial configuration, ensuring that security sessions are re-established on a reconciled management state.

In some implementations of the method, a non-transitory computer-readable medium comprising instructions which, when executed by a processor, cause the processor to perform the method.

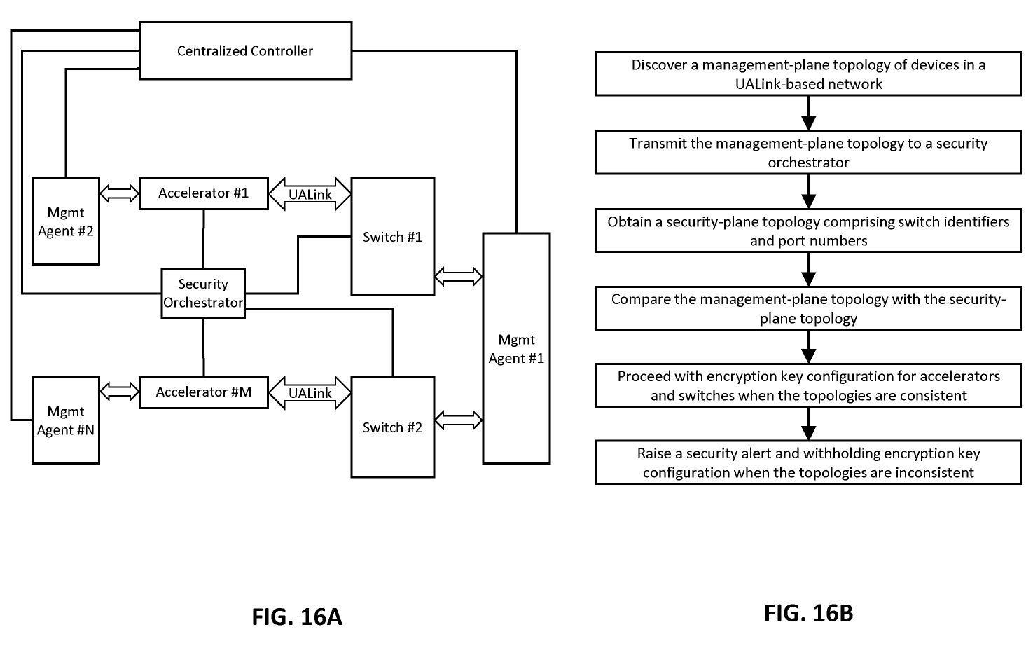

FIG. 16A illustrates a system performing cross-plane topology verification in a UALink-based network. A centralized controller may discover a topology via management agents, and a security orchestrator may independently verify the topology via secure sessions with security managers on switches. The security orchestrator may configure encryption keys when the verification confirms consistency between the management-plane topology and the security-plane topology. This cross-plane verification may detect topology inconsistencies that could indicate misconfiguration or security attacks.

In various implementations, a system for an Ultra Accelerator Link (UALink)-based network comprising accelerators and switches coupled via UALink-based links, the system comprising: a centralized controller configured to discover a topology of the UALink-based network via management agents over an out-of-band management network, the topology comprising device identifiers, port numbers, and neighbor connections; a security orchestrator configured to: receive the topology from the centralized controller; independently verify the topology by comparing the received topology with information obtained from secure sessions with security managers on the switches; and configure encryption keys on the accelerators and switches when the independent verification confirms consistency between the topology reported by the management agents and the topology reported by the security managers. The centralized controller may discover the topology by gathering identity and operational attributes from management agents during device admission. The topology may include device identifiers assigned by the centralized controller, port numbers assigned by the devices, and neighbor connections established through data link layer discovery. The security orchestrator may obtain topology information from the security managers independently of the management agents, creating two independent views of the same physical topology. Comparing these views may detect inconsistencies caused by miscabling, device impersonation, or compromised management agents. The security orchestrator may configure encryption keys when both views agree, preventing key programming for an incorrect or compromised topology. In some implementations, the security orchestrator may include a trusted virtual machine that coordinates security across all devices in a virtual partition.

In some implementations of the system, the neighbor connections in the topology are discovered via data link layer messages exchanged between devices after a data link layer reaches an operational state, the data link layer messages comprising device identifier requests and port number requests. The data link layer messages may be exchanged at each link after the physical and data link layers are operational, providing a hardware-level verification of which devices are physically connected. The discovered neighbor information may be compared with expected neighbor information configured by the centralized controller.

In some implementations of the system, when the independent verification detects an inconsistency between the topology reported by the management agents and the topology reported by the security managers, the security orchestrator raises a security alert and withholds encryption key configuration until the inconsistency is resolved. The security alert may be reported to an administrator or to an automated security response system. Withholding key configuration may prevent workloads from executing on a potentially compromised topology until the inconsistency is investigated and resolved.

In some implementations of the system, the topology received from the centralized controller further comprises forwarding entries installed on the switches, and wherein the security orchestrator verifies that the forwarding entries are consistent with the device identifiers and port numbers in the topology. Verifying forwarding entries against the topology may detect inconsistencies where routes are installed for devices that do not exist in the discovered topology or where routes are missing for devices that should be reachable.

In some implementations of the system, the information obtained from the secure sessions with the security managers comprises attestation reports from each switch, the attestation reports including switch identifiers, port numbers, and firmware integrity measurements; and wherein the security orchestrator compares the switch identifiers and port numbers in the attestation reports with the corresponding values in the topology received from the centralized controller. The attestation reports may provide a cryptographically signed view of the switch's identity and configuration, making it difficult for a compromised management agent to present false topology information. Comparing attested values with management-reported values may detect discrepancies caused by agent compromise.

In some implementations of the system, the centralized controller manages a plurality of virtual partitions on the UALink-based network, and wherein the security orchestrator performs the independent topology verification independently for each virtual partition before configuring encryption keys for that virtual partition. Independent per-virtual-partition verification may ensure that security configuration for one virtual partition does not depend on or interfere with verification for another virtual partition. Different virtual partitions may be at different stages of the sequenced workflow concurrently.

In some implementations of the system, the centralized controller and the security orchestrator operate concurrently on different virtual partitions, the centralized controller configuring forwarding entries for a first virtual partition while the security orchestrator configures encryption keys for a second virtual partition that has already completed topology verification. Concurrent operation may reduce total network provisioning time when multiple virtual partitions are being configured, as the management and security planes may overlap their work on different partitions.

In some implementations of the system, the security orchestrator is configured to periodically re-verify the topology consistency during workload execution by comparing current operational state received from the centralized controller with current information from the security managers, detecting topology changes that occur after initial verification. Periodic re-verification may detect topology changes that occur after the initial configuration, such as cable replacements, device additions, or device failures that alter the physical connectivity. Detecting such changes may enable proactive security response before the change impacts workload security.

FIG. 16B illustrates a method for verifying topology integrity by comparing management-plane topology with security-plane topology, configuring encryption keys when the topologies are consistent, and raising security alerts when inconsistencies are detected.

In various implementations, a method for verifying topology integrity in an Ultra Accelerator Link (UALink)-based network comprising accelerators and switches coupled via UALink-based links, the method comprising: discovering, by a centralized controller via management agents over an out-of-band management network, a management-plane topology comprising device identifiers, port numbers, and neighbor connections of devices in the UALink-based network; transmitting the management-plane topology from the centralized controller to a security orchestrator; obtaining, by the security orchestrator via secure sessions with security managers on the switches, a security-plane topology comprising switch identifiers and port numbers; comparing the management-plane topology with the security-plane topology; when the topologies are consistent, proceeding with encryption key configuration for the accelerators and switches; and when the topologies are inconsistent, raising a security alert and withholding encryption key configuration. The management-plane topology may be discovered through standard management admission flows where each management agent reports the identity and operational state of its managed devices. The security-plane topology may be obtained through authenticated sessions that provide cryptographically verified device identity information. The comparison may involve matching device identifiers, port numbers, and neighbor connections between the two topology views. Proceeding with key configuration on consistency may ensure that encryption keys are programmed for the correct physical topology.

In some implementations of the method, the neighbor connections in the management-plane topology are discovered via data link layer messages exchanged between devices, the data link layer messages comprising device identifier requests carrying device identifiers and device types, and port number requests carrying port numbers. The data link layer messages may provide hardware-level neighbor identification that is independent of the management agent software, providing a trustworthy basis for topology discovery.

In some implementations of the method, a non-transitory computer-readable medium comprising instructions which, when executed by a processor, cause the processor to perform the method.

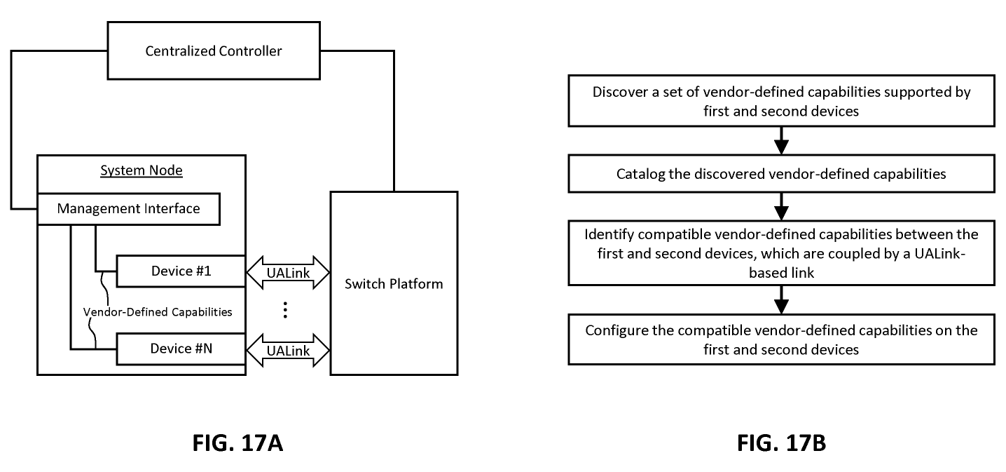

FIG. 17A illustrates a centralized controller that manages a plurality of devices including accelerators and switches, the centralized controller may orchestrate the lifecycle of vendor-defined extensions across the network. Vendor-defined extensions may span multiple functional domains, including vendor-defined commands, vendor-defined reduction operations, vendor-defined collective types, vendor-defined route types, vendor-defined messages, and vendor-defined chiplet capabilities. Each device in the network may support a different subset of vendor-defined extensions depending on the vendor, hardware revision, and firmware version. During admission of each device to the network, the centralized controller may query the device via a management interface to discover which vendor-defined capabilities the device supports. The centralized controller may then catalog the discovered capabilities to build a network-wide view of available vendor-defined features, and configure the devices to activate compatible vendor-defined features based on the catalog. The management interface may utilize an out-of-band management protocol separate from the data-plane links carrying accelerator traffic, and may be accessed through management agents associated with each device.

In various implementations, a management system for an Ultra Accelerator Link (UALink)-based network, comprising: a plurality of devices, each device comprising at least one UALink-based port, each device configured to advertise, via a management interface, vendor-defined capabilities supported by the device; and a centralized controller configured to: discover, during admission of each device to the UALink-based network, the vendor-defined capabilities advertised by the device via the management interface; catalog the discovered vendor-defined capabilities across the plurality of devices; and configure the plurality of devices based on the cataloged vendor-defined capabilities. The management system may orchestrate vendor-defined extension discovery as part of a broader admission flow that includes identity exchange, configuration synchronization, and operational state gathering. The centralized controller may maintain a catalog data structure indexed by device identifier, extension type, and extension identifier, providing a network-wide view of available vendor-defined features. The configuring may involve activating compatible vendor-defined extensions on linked devices, setting extension-specific parameters, or coordinating extension usage across virtual partitions. The management interface may be an out-of-band management interface separate from the data-plane UALink-based links, and different device types may utilize different management protocols via their respective management agents. The plurality of devices may include accelerators and switches, and the centralized controller may discover vendor-defined capabilities from both device types during their respective admission flows.

In some implementations of the management system, the vendor-defined capabilities of at least one device of the plurality of devices comprise supported vendor-defined command encodings within reserved command encoding ranges of a command type field of the at least one UALink-based port, the reserved command encoding ranges comprising at least one of: read class vendor-defined commands, write class vendor-defined commands, or atomic class vendor-defined commands. The three command classes may correspond to different data transfer patterns: read class for data retrieval without originator data transfer, write class for data storage with byte-level control via originator data, and atomic class for read-modify-write operations with operand data. For vendor-defined commands, all request fields including address, length, attribute, and metadata fields may be vendor-defined.

In some implementations of the management system, the vendor-defined capabilities of at least one device of the plurality of devices comprise supported vendor-defined route types within a reserved route type range, and the at least one device advertises the supported vendor-defined route types as an identity attribute queryable via the management interface. Vendor-defined route types may enable vendor-specific routing optimizations beyond predefined route types. The identity attribute may be queryable during admission, allowing the centralized controller to determine which route types each switch supports before generating forwarding entries conforming to the vendor-defined route format.

In some implementations of the management system, the vendor-defined capabilities of at least one device of the plurality of devices comprise supported vendor-defined reduction operations within reserved reduction operation encoding ranges, the reserved reduction operation encoding ranges comprising a first sub-range for integer vendor-defined reduction operations and a second sub-range for floating-point vendor-defined reduction operations. The first sub-range may cover vendor-defined integer operations including custom integer arithmetic and logic operations. The second sub-range may cover vendor-defined floating-point operations including custom floating-point formats and precision modes tailored to specific workload requirements.

In some implementations of the management system, the vendor-defined capabilities of at least one device of the plurality of devices comprise supported vendor-defined collective types within reserved collective type encoding ranges, the reserved collective type encoding ranges comprising a first range for non-strided vendor-defined collective types and a second range for strided vendor-defined collective types. Non-strided vendor-defined collective types may operate on contiguous data regions, while strided vendor-defined collective types may operate on data elements separated by a configurable stride, enabling vendor-specific collective patterns across multi-dimensional data structures.

In some implementations of the management system, the vendor-defined capabilities of at least one device of the plurality of devices comprise at least one of: supported vendor-defined write messages within a reserved message metadata range of the at least one UALink-based port, or vendor-defined chiplet capability information advertised via a die-to-die capability structure on a chiplet die of the at least one device. Vendor-defined write messages may utilize a reserved range of message metadata values to implement proprietary signaling between accelerators. Vendor-defined chiplet capability information may be advertised through a capability structure accessible via a die-to-die interface on chiplet-based devices, including vendor-specific configuration and status information.

In some implementations of the management system, at least one device of the plurality of devices comprises a switch, the switch configured to advertise, as part of the vendor-defined capabilities, vendor-defined commands that the switch is configured to process internally; and wherein the centralized controller is further configured to route requests specifying the vendor-defined commands to the switch for in-network processing based on the cataloged vendor-defined capabilities. A switch may process vendor-defined commands internally rather than merely forwarding them to a destination accelerator, enabling vendor-defined in-network operations such as custom reduction, filtering, or transformation of data in transit. The centralized controller may utilize the cataloged capabilities to determine which switches can process specific vendor-defined commands and route traffic accordingly.

In some implementations of the management system, the centralized controller is further configured to: determine, for a first device and a second device of the plurality of devices from different vendors, a compatible subset of the vendor-defined capabilities supported by both the first device and the second device; and configure the first device and the second device to utilize vendor-defined capabilities from the compatible subset on a link between the first device and the second device. In multi-vendor deployments, devices on the same link may support different vendor-defined capabilities. The centralized controller may compute the intersection of supported capabilities between linked devices and configure the link to utilize the mutually supported features, maintaining interoperability across vendor boundaries.

In some implementations of the management system, the centralized controller is further configured to configure different sets of vendor-defined capabilities for different virtual partitions on the UALink-based network, wherein a first virtual partition utilizes a first set of vendor-defined capabilities and a second virtual partition utilizes a second set of vendor-defined capabilities different from the first set. Different virtual partitions may serve different tenants or workloads with distinct requirements. Configuring vendor-defined capabilities per virtual partition may allow each tenant to utilize vendor-specific features independently without affecting other tenants on the same physical network. In some examples, virtual partitions refer to virtual pods.

FIG. 17B illustrates a method for managing the lifecycle of vendor-defined extensions in an accelerator network comprising admitted devices coupled by protocol-level interface links. The method may encompass discovery of vendor-defined capabilities during device admission, network-wide cataloging of discovered capabilities, identification of compatible capabilities between linked devices, and configuration of the compatible capabilities. The centralized controller may perform these steps as part of an orchestrated management workflow that integrates vendor-defined extension management with standard network management operations such as routing configuration, virtual partition management, and telemetry collection. The compatibility identification step may consider vendor identifiers, extension identifiers, version identifiers, and functional compatibility between vendor-defined capabilities advertised by devices on each side of a link.

In various implementations, a method for managing vendor-defined extensions in an Ultra Accelerator Link (UALink)-based network, comprising: during admissions of first and second devices to the UALink-based network, discovering, by a centralized controller via a management interface, a set of vendor-defined capabilities supported by the first and second devices; cataloging, by the centralized controller, the discovered vendor-defined capabilities supported by the first and second devices; identifying, by the centralized controller, compatible vendor-defined capabilities between the first and second devices, wherein the first and second devices are coupled by a UALink-based link; and configuring, by the centralized controller, the compatible vendor-defined capabilities on the first and second devices. The discovering step may be performed as part of a broader admission flow that includes identity exchange, configuration synchronization, and operational state gathering. The cataloging step may build and maintain a network-wide data structure of vendor-defined capabilities indexed by device, link, or extension type. The identifying step may determine compatibility by comparing vendor identifiers, extension identifiers, and version identifiers between devices coupled by a link. The configuring step may involve transmitting extension-specific parameters to each device and coordinating the activation sequence to avoid disrupting existing traffic on the link. The method may be repeated for each link in the network, building up a comprehensive set of activated vendor-defined features across the entire network topology.

In some implementations of the method, each vendor-defined capability of the set of vendor-defined capabilities comprises a version identifier, and wherein the identifying of the compatible vendor-defined capabilities comprises selecting, for a vendor-defined capability supported by both the first and second devices at different versions, a highest mutually supported version. Version identifiers may follow a semantic versioning scheme. When devices support the same vendor-defined extension at different versions, the centralized controller may negotiate the highest version supported by both devices, which may provide the most features while maintaining compatibility.

In some implementations, the method further comprises activating or deactivating, by the centralized controller, a vendor-defined capability of the compatible vendor-defined capabilities on the first and second devices at runtime by transmitting an activation command or a deactivation command via the management interface. Runtime activation and deactivation may allow the centralized controller to enable vendor-defined features on established links without requiring link retraining or device reset, and to deactivate features that are no longer needed or that cause operational issues.

In some implementations, the method further comprises collecting, by the centralized controller via the management interface, vendor-defined telemetry counters associated with the compatible vendor-defined capabilities configured on the first and second devices. Vendor-defined telemetry counters may include metrics specific to vendor-defined operations, such as operation execution counts, latencies, and error rates, providing visibility into the performance and health of vendor-defined features.

In some implementations, the method further comprises selecting, by the centralized controller, a data path between the first and second devices for traffic utilizing a vendor-defined capability of the compatible vendor-defined capabilities, the data path traversing admitted devices that support the vendor-defined capability. In networks with multiple paths between devices, the centralized controller may select paths that traverse devices supporting a required vendor-defined capability, avoiding devices that would be unable to process vendor-defined operations in transit.

In some implementations, the method further comprises exposing, by the centralized controller, a vendor extension catalog to a workload orchestrator, the vendor extension catalog listing the cataloged vendor-defined capabilities across admitted devices; and receiving, from the workload orchestrator, a request to allocate devices supporting a specified vendor-defined capability for a workload. The vendor extension catalog may provide a programmatic interface enabling a workload orchestrator to query available vendor-defined capabilities and request device allocations based on capability requirements, integrating vendor extension awareness into workload scheduling decisions.

In some implementations, the method further comprises updating, by the centralized controller via the management interface, firmware associated with a vendor-defined capability on the first device or the second device, wherein the updating modifies the vendor-defined capability while the first device or the second device remains operational on the UALink-based network. Firmware updates for vendor-defined capabilities may be delivered incrementally, modifying the implementation of a specific vendor-defined feature without requiring a complete device firmware update or device restart, reducing downtime for vendor extension upgrades.

In some implementations of the method, a non-transitory computer-readable medium comprising instructions which, when executed by a processor, cause the processor to perform the method.

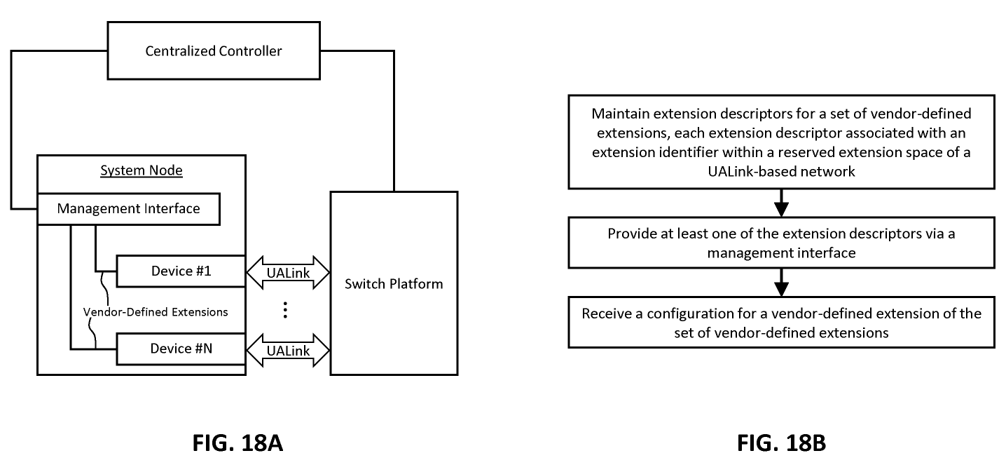

FIG. 18A illustrates a device supporting vendor-defined extensions within reserved extension spaces. The devices may provide self-describing extension descriptors that define the fields, semantics, and valid parameter ranges of each vendor-defined extension. These extension descriptors may enable management systems to discover, understand, and configure vendor-defined features without requiring vendor-specific management tools or prior knowledge of the vendor's implementation. Each vendor-defined extension may be identified by an extension identifier within a reserved extension space, and the corresponding extension descriptor may provide sufficient information for a management system to construct a valid configuration for the extension. The management interface through which the extension descriptors are accessible may be an out-of-band interface coupled to a management agent, and the extension descriptors may be provided during device admission or upon explicit request from the management system at any time during normal operation.

In various implementations, a device for an Ultra Accelerator Link (UALink)-based network, comprising: at least one UALink-based port; and a set of vendor-defined extensions, each vendor-defined extension of the set of vendor-defined extensions identified by an extension identifier within a reserved extension space of the UALink-based network; wherein the device is configured to provide, for each vendor-defined extension of the set of vendor-defined extensions, an extension descriptor via a management interface, the extension descriptor defining at least one of: fields and field semantics of the vendor-defined extension, or valid parameter ranges for the vendor-defined extension. A device in an accelerator network may support one or more vendor-defined extensions within reserved extension spaces. Each reserved extension space may correspond to a different functional domain, such as command extensions, operation extensions, collective type extensions, route type extensions, message extensions, or error record extensions. The extension identifier may be an encoding value within the reserved space that uniquely identifies the vendor-defined extension. The extension descriptor may be a structured data object that describes the vendor-defined extension in sufficient detail for a management system to understand and configure the extension. The management interface may be an out-of-band interface through which a management agent communicates with the device. Providing extension descriptors via the management interface may enable programmatic discovery and configuration of vendor-defined features.

In some implementations of the device, the extension descriptors are pre-stored in a register space on the device, the register space accessible via the management interface. Pre-storing extension descriptors in a register space may allow the management interface to read the descriptors directly without requiring the device to generate them on demand. The register space may be memory-mapped or accessible via a management protocol.

In some implementations of the device, the extension descriptor for each vendor-defined extension of the set of vendor-defined extensions defines fields and field semantics of the vendor-defined extension and valid parameter ranges for the vendor-defined extension; and wherein the device is further configured to receive, from a management system via the management interface, a configuration for the vendor-defined extension, the configuration comprising values for the fields defined in the extension descriptor, and apply the configuration to the vendor-defined extension. When the extension descriptor defines both the fields with their semantics and the valid parameter ranges, the management system may construct a complete configuration for the vendor-defined extension based solely on information in the descriptor. The device may validate received configuration values against the valid parameter ranges before applying the configuration.

In some implementations of the device, the extension descriptor comprises a machine-readable format comprising an extension identifier, a vendor identifier, a version, and a parameter table defining, for each configurable parameter of the vendor-defined extension, a parameter name, a data type, a valid range, and a default value. The machine-readable format may conform to a schema that management tools can parse automatically. The parameter table may define constraints that the management system validates before sending a configuration to the device, and the default values may be utilized when the management system does not explicitly configure a parameter.

In some implementations of the device, a vendor-defined extension of the set of vendor-defined extensions comprises a vendor-defined command within a reserved command encoding range, and the extension descriptor for the vendor-defined command defines semantics of vendor-defined fields of the vendor-defined command, the vendor-defined fields comprising at least one of: an address field, a length field, an attribute field, or a metadata field. For vendor-defined commands, all request fields may be vendor-defined. The extension descriptor may specify the meaning and valid values for each field, enabling a management system to understand how to invoke and parameterize the vendor-defined command correctly.

In some implementations of the device, a vendor-defined extension of the set of vendor-defined extensions comprises a vendor-defined error record section format, and the extension descriptor for the vendor-defined error record section format defines a structure and field semantics of vendor-defined error record sections generated by the device. Vendor-defined error record sections may contain device-specific diagnostic information. The extension descriptor may define the layout and field meanings of these sections, enabling management systems to parse and interpret vendor-defined error records consistently.

In some implementations of the device, the device comprises at least one of: an accelerator managed by a node management agent via the management interface, or a switch managed by a switch management agent via the management interface. An accelerator may be managed by a node management agent that communicates with the centralized controller via a first management protocol, while a switch may be managed by a switch management agent that communicates via a second management protocol different from the first management protocol.

FIG. 18B illustrates a method for device-side lifecycle for vendor-defined extensions, covering the maintenance, provision, and consumption of extension descriptors. The method may be performed by a device, by a management agent associated with the device, or by firmware executing on the device. Maintaining extension descriptors may involve storing pre-computed descriptors in non-volatile memory, generating descriptors dynamically from internal configuration tables, or a combination thereof. The providing step may be triggered by a query from a management system during device admission or at any time during normal operation. The configuration received from the management system may specify values for configurable parameters of the vendor-defined extension, and the device may validate received configurations against the extension descriptor before applying them.

In various implementations, a method for enabling vendor-defined extensions in an Ultra Accelerator Link (UALink)-based network, comprising: maintaining extension descriptors for a set of vendor-defined extensions, each extension descriptor associated with an extension identifier within a reserved extension space of the UALink-based network, each extension descriptor defining at least one of: fields and field semantics of a corresponding vendor-defined extension, or valid parameter ranges for the corresponding vendor-defined extension; upon request from a management system, providing at least one of the extension descriptors via a management interface; and receiving, from the management system, a configuration for a vendor-defined extension of the set of vendor-defined extensions, the configuration based on a corresponding extension descriptor of the extension descriptors. The maintaining may involve various storage and generation strategies depending on the implementation. The providing step may return one or more extension descriptors in response to a targeted query for a specific extension identifier or a broad query for all supported vendor-defined extensions. The configuration received from the management system may specify values for configurable parameters of the vendor-defined extension, activation state, or operational modes. The configuration may be validated against the extension descriptor before being applied, and configurations specifying values outside the valid parameter ranges defined in the descriptor may be rejected.

In some implementations of the method, the maintaining comprises dynamically generating the extension descriptors in response to a request from the management system. Dynamically generating extension descriptors may allow the descriptors to reflect the current state of the device, including available resources, current firmware capabilities, and hardware configuration, which may be useful for devices whose vendor-defined capabilities change over time.

In some implementations of the method, a vendor-defined extension of the set of vendor-defined extensions comprises a vendor-defined route type, and a corresponding extension descriptor of the extension descriptors defines fields of each route entry for the vendor-defined route type, a size of each field, and a routing behavior of the vendor-defined route type. For vendor-defined route types, the extension descriptor may specify the fields that comprise each route entry, the bit widths of those fields, and the forwarding semantics of the route type, enabling a centralized controller to generate and install forwarding entries conforming to the vendor-defined format.

In some implementations of the method, the set of vendor-defined extensions spans a plurality of reserved extension spaces of the UALink-based network, the plurality of reserved extension spaces comprising at least two of: a reserved command encoding range, a reserved reduction operation encoding range, a reserved collective type encoding range, a reserved message metadata range, or a reserved route type range. A single device may implement vendor-defined extensions across multiple functional domains. Maintaining descriptors across multiple reserved extension spaces may provide comprehensive coverage of the device's vendor-defined capabilities, enabling the management system to discover and configure all vendor-defined features through a unified descriptor mechanism.

In some implementations of the method, each extension descriptor further comprises a descriptor version; and wherein upon modification of a vendor-defined extension of the set of vendor-defined extensions, the method further comprises providing an updated extension descriptor with an incremented descriptor version via the management interface. The descriptor version may allow management systems to track changes to vendor-defined extensions and determine when to re-read and re-apply configurations. Incrementing the descriptor version upon modification may trigger the management system to refresh its cached representation of the extension.

In some implementations of the method, a non-transitory computer-readable medium comprising instructions which, when executed by a processor, cause the processor to perform the method.

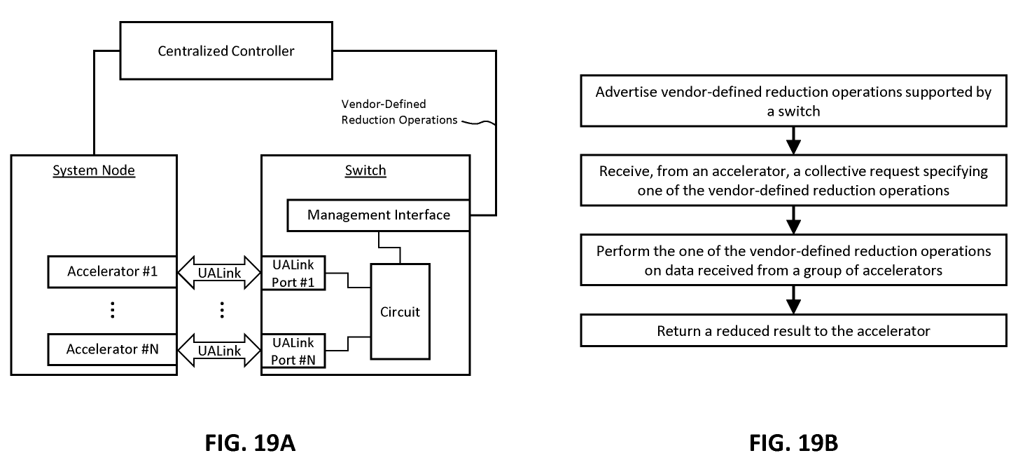

FIG. 19A illustrates switches performing in-network computation such as reduction operations on data flowing between accelerators. The switch may support vendor-defined reduction operations in addition to predefined reduction operations. These vendor-defined operations may enable vendors to implement custom arithmetic, logic, or data transformation operations tailored to specific workload requirements, such as custom quantized arithmetic for AI training or sparsity-aware operations that skip zero-valued elements. The switch may advertise which vendor-defined reduction operations it supports via a management interface, enabling a centralized controller to configure collective groups and route collective traffic to switches that support the operations. Each vendor-defined reduction operation may be identified by an operation encoding within a reserved range of a reduction operation field, and may utilize the same request format and response format as predefined reduction operations, so that accelerators may invoke vendor-defined operations using the same collective request mechanism.

In various implementations, a switch for an Ultra Accelerator Link (UALink)-based network, comprising: a plurality of UALink-based ports coupled to a plurality of accelerators; a circuit configured to perform reduction operations on data received from the plurality of accelerators via the plurality of UALink-based ports, the reduction operations comprising vendor-defined reduction operations; wherein the switch is configured to advertise, via a management interface, the vendor-defined reduction operations supported by the switch, each of the vendor-defined reduction operations identified by an operation encoding within a reserved operation encoding range; and wherein the switch is configured to receive a collective request from an accelerator of the plurality of accelerators, the collective request specifying one of the vendor-defined reduction operations via the operation encoding and comprising a group identifier for routing the collective request to a group of accelerators of the plurality of accelerators, and execute the one of the vendor-defined reduction operations on data received from the group of accelerators. The switch may be deployed in an accelerator network comprising up to 1024 accelerators coupled via UALink-based links. The circuit may implement reduction operations using dedicated hardware logic, firmware-programmable logic, or a combination thereof. The reduction operations may include predefined operations such as minimum, maximum, addition, and bitwise operations, as well as vendor-defined operations that extend these capabilities with custom computation. The management interface may be an out-of-band interface accessed through a management agent, separate from the data-plane UALink-based ports. The advertised vendor-defined reduction operations may be discoverable during device admission and may be updated when the switch firmware is modified. The collective request may be a collective primitive command that carries the operation encoding and is routed to the switch based on the group identifier. The group of accelerators may be defined by a collective group configuration received from a centralized controller via the management interface.

In some implementations of the switch, the reserved operation encoding range comprises a first sub-range for integer vendor-defined reduction operations and a second sub-range for floating-point vendor-defined reduction operations. The first sub-range may cover vendor-defined integer operations including custom integer arithmetic and logic operations. The second sub-range may cover vendor-defined floating-point operations including custom floating-point formats and precision modes tailored to specific workload requirements.

In some implementations of the switch, at least one of the vendor-defined reduction operations comprises at least one of: a top-k selection operation returning a specified number of largest values from the data, a quantized reduction operation performing reduction in a compressed numerical format, or a sparsity-aware reduction operation skipping zero-valued elements in the data. A top-k selection operation may be utilized for sparse gradient communication in AI training, returning the most significant gradient values. A quantized reduction operation may reduce data in lower-precision formats to conserve bandwidth. A sparsity-aware reduction operation may accelerate reduction of sparse tensors by skipping zero-valued elements.

In some implementations of the switch, the switch is further configured to receive, from a centralized controller via the management interface, a collective group configuration associating the group identifier with a subset of the vendor-defined reduction operations to be performed on collective requests from the group of accelerators. The collective group configuration may associate each group identifier with a specific set of vendor-defined reduction operations that the switch performs when receiving collective requests from the corresponding group. Different groups may utilize different vendor-defined operations based on workload requirements.

In some implementations of the switch, the collective request specifying the one of the vendor-defined reduction operations uses a same request command, a same set of request fields, and a same response format as a collective request specifying another reduction operation of the reduction operations. Utilizing a same request command and field structure for vendor-defined and other reduction operations may simplify switch implementation and accelerator software, as the same request generation and response handling logic may be utilized regardless of whether the operation encoding falls within the reserved operation encoding range.

In some implementations of the switch, the switch is further configured to report, via the management interface, telemetry associated with the vendor-defined reduction operations, the telemetry comprising at least one of: a per-operation execution count, a per-operation execution latency, or a per-operation error count. Per-operation telemetry may enable a centralized controller to monitor the performance and reliability of individual vendor-defined operations. The execution latency may indicate processing time, the execution count may indicate utilization, and the error count may indicate operational issues requiring attention.

In some implementations of the switch, the circuit comprises at least one of: hardware logic configured to execute the vendor-defined reduction operations, or firmware-programmable logic configured to execute the vendor-defined reduction operations based on firmware loaded via the management interface. Hardware logic may provide deterministic latency for vendor-defined operations. Firmware-programmable logic may allow the vendor to add or modify vendor-defined operations by loading updated firmware via the management interface without requiring hardware changes to the switch.

FIG. 19B illustrates a method for extending the in-network computation capabilities of a switch in an accelerator network through vendor-defined reduction operations. The method may encompass advertising supported vendor-defined operations via a management interface, receiving and processing collective requests that specify vendor-defined operations, and returning results to requesting accelerators. The vendor-defined reduction operations may be invoked using the same collective request mechanism as predefined operations, with the operation encoding within the reserved range distinguishing vendor-defined operations from predefined operations. The method may be performed by a switch, by firmware executing on the switch, or by a combination of hardware and firmware within the switch.

In various implementations, a method for extending in-network reduction operations in an Ultra Accelerator Link (UALink)-based network, comprising: advertising, by a switch via a management interface, vendor-defined reduction operations supported by the switch, each vendor-defined reduction operation identified by an operation encoding within a reserved encoding range; receiving, at the switch from an accelerator coupled to the switch via a UALink-based port, a collective request specifying one of the vendor-defined reduction operations via the operation encoding, the collective request comprising a group identifier for routing the collective request to a group of accelerators; performing, by the switch, the one of the vendor-defined reduction operations on data received from the group of accelerators; and returning, by the switch, a reduced result to the accelerator. The advertising step may occur during admission of the switch to the network or upon request from a centralized controller. The reserved encoding range may include distinct sub-ranges for integer and floating-point vendor-defined operations. The receiving step may involve the switch accepting the collective request on a UALink-based port, the collective request specifying both the vendor-defined reduction operation to perform and the group of accelerators participating in the collective. The performing step may involve the switch collecting data from the group of accelerators via respective UALink-based ports, applying the vendor-defined reduction operation to the collected data, and producing the reduced result. The returning step may involve transmitting the reduced result to the requesting accelerator via the UALink-based port on which the collective request was received.

In some implementations of the method, each of the vendor-defined reduction operations supports a set of rounding modes comprising at least one of: round to nearest with ties to even, round towards zero, round towards positive infinity, round towards negative infinity, or stochastic rounding with a seed value. The rounding modes may be applicable to floating-point vendor-defined reduction operations. Stochastic rounding with a seed value may be utilized in AI training workloads to reduce rounding bias during gradient accumulation across multiple accelerators.

In some implementations, the method further comprises performing, by the switch, a second reduction operation on a result of the one of the vendor-defined reduction operations within a same collective invocation, wherein the one of the vendor-defined reduction operations and the second reduction operation are chained sequentially on the data received from the group of accelerators. Chaining vendor-defined and other reduction operations may allow complex multi-stage computations to be performed within the switch in a single collective invocation, reducing the number of collective round-trips between accelerators and the switch.

In some implementations, the method further comprises selecting, by a centralized controller, a collective path between the accelerator and the group of accelerators for the collective request, the collective path traversing switches that each support the one of the vendor-defined reduction operations specified in the collective request. In networks with multiple switching planes, the centralized controller may select collective paths that traverse switches supporting the required vendor-defined operation, avoiding switches that lack support for the operation.

In some implementations, the method further comprises verifying correctness of the one of the vendor-defined reduction operations by executing a test vector comprising known input data on the switch and comparing a result to an expected output. Test vectors may be provided by the vendor and executed on the switch during admission or periodic verification. Comparing results to expected outputs may verify that the vendor-defined operation produces correct results before utilizing the operation in production workloads.

In some implementations of the method, the performing of the one of the vendor-defined reduction operations is scheduled at a configurable priority relative to other operations on the switch, the configurable priority settable via the management interface. Configurable scheduling priority may allow a centralized controller to prioritize latency-sensitive vendor-defined operations over less time-sensitive operations, or to deprioritize vendor-defined operations that consume significant switch resources relative to other traffic.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

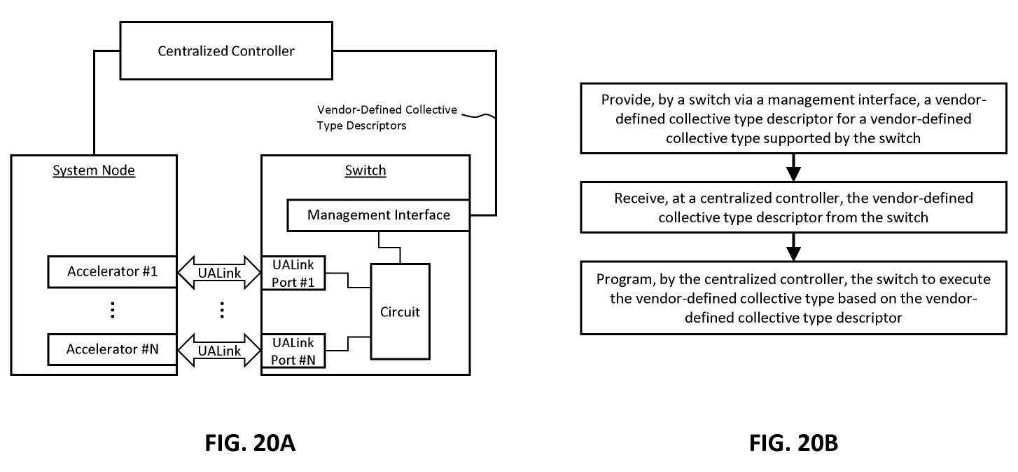

FIG. 20A illustrates switches that coordinate collective operations among groups of accelerators. The switch may support vendor-defined collective types in addition to predefined collective types such as broadcast, reduce, and all-reduce. Vendor-defined collective types may enable vendors to implement custom collective communication patterns tailored to specific workload requirements, such as gradient compression collectives that selectively transmit significant gradient values, reduce-scatter collectives that distribute portions of reduced data, or all-to-all exchange collectives that transfer distinct data segments between all participating accelerators. To enable centralized management of vendor-defined collective types, the switch may provide self-describing vendor-defined collective type descriptors that define the collective behavior of each supported vendor-defined collective type. A centralized controller may receive these descriptors and program the switch to execute the vendor-defined collective types, including verifying that all switches in a collective group support the required vendor-defined collective types before activation.

In various implementations, a system for an Ultra Accelerator Link (UALink)-based network, comprising: a switch comprising a plurality of UALink-based ports coupled to a plurality of accelerators, and a circuit configured to process vendor-defined collective types, each vendor-defined collective type of the vendor-defined collective types identified by a type encoding within a reserved collective type range; wherein the switch is configured to provide, via a management interface, a vendor-defined collective type descriptor for each of the vendor-defined collective types supported by the switch, each vendor-defined collective type descriptor defining a collective behavior of a corresponding vendor-defined collective type; and a centralized controller configured to program the switch to execute the vendor-defined collective types based on the vendor-defined collective type descriptors. The system may enable centralized management of vendor-defined collective types across the accelerator network. The circuit on the switch may process vendor-defined collective types by executing the collective behavior described in the corresponding vendor-defined collective type descriptor. The vendor-defined collective type descriptor may be a structured data object that describes the collective's communication pattern, data transformation behavior, and address computation rules. The centralized controller may receive descriptors from multiple switches and program each switch to execute the vendor-defined collective types that are supported across the relevant collective groups. The management interface may be accessed via a management agent associated with the switch, and the vendor-defined collective type descriptors may be discoverable during switch admission to the network.

In some implementations of the system, the reserved collective type range comprises a first range for non-strided vendor-defined collective types and a second range for strided vendor-defined collective types. Non-strided vendor-defined collective types may operate on contiguous data regions, while strided vendor-defined collective types may operate on data elements separated by a configurable stride, enabling vendor-specific collective patterns across multi-dimensional data structures.

In some implementations of the system, the switch is further configured to: receive a collective invocation from an accelerator of the plurality of accelerators, the collective invocation specifying one of the vendor-defined collective types via the type encoding; and execute the one of the vendor-defined collective types on data from the plurality of accelerators according to the collective behavior defined in a corresponding vendor-defined collective type descriptor. The collective invocation may be a command issued by an accelerator to the switch, specifying the vendor-defined collective type via the type encoding carried in a collective type field. The switch may execute the collective by coordinating data transfers and applying data transformations as defined in the corresponding descriptor.

In some implementations of the system, the centralized controller is further configured to: for a collective group spanning a plurality of switches, verify that each switch of the plurality of switches supports a vendor-defined collective type based on the vendor-defined collective type descriptors provided by each switch, and activate the vendor-defined collective type on the collective group after the verifying. Verifying support across all switches in a collective group may prevent runtime failures from unsupported vendor-defined collective types. The centralized controller may compare vendor-defined collective type descriptors from each switch to determine mutual support before activating the vendor-defined collective type on the group.

In some implementations of the system, the switch is further configured to receive a collective invocation command from an accelerator of the plurality of accelerators, the collective invocation command comprising parameter data on a data channel, the parameter data specifying the type encoding and operational parameters for executing one of the vendor-defined collective types. The parameter data may be carried in a fixed-size payload accompanying the collective invocation command on a data channel. The operational parameters may include collective-specific settings such as data offsets, stride values, rounding modes, and dimension sizes for multi-dimensional collectives.

In some implementations of the system, one of the vendor-defined collective types comprises a reduce-scatter collective configured to reduce data from the plurality of accelerators and distribute distinct portions of reduced data to respective accelerators of the plurality of accelerators. A reduce-scatter collective may be utilized in distributed AI training to reduce gradients and distribute distinct gradient partitions to accelerators for parameter updates. Each accelerator may receive a unique portion of the reduced result, enabling parallel parameter updates across accelerators.

In some implementations of the system, the centralized controller is further configured to verify that the switch has available resources for a vendor-defined collective type and that the vendor-defined collective type does not interfere with collective groups already configured on the switch, before programming the switch to execute the vendor-defined collective type. Available resources may include submission queue entries, buffer space, and processing capacity on the switch. Non-interference verification may confirm that the vendor-defined collective type does not conflict with the scheduling or resource allocation of existing collective groups on the switch.

FIG. 20B illustrates a method for configuring vendor-defined collective types on switches in an accelerator network through self-describing behavioral descriptors. The method may encompass the switch providing vendor-defined collective type descriptors that define the collective behavior, the centralized controller receiving and interpreting the descriptors, and the centralized controller programming the switch to execute the vendor-defined collective types based on the behavioral information in the descriptors. The vendor-defined collective type descriptor may describe the collective behavior in sufficient detail for the centralized controller to determine how to configure the collective group, including which accelerators participate, how data flows between accelerators, and what transformation is applied to the data.

In various implementations, a method for configuring vendor-defined collective types in an Ultra Accelerator Link (UALink)-based network comprising a switch and a plurality of accelerators coupled to the switch via UALink-based ports, comprising: providing, by the switch via a management interface, a vendor-defined collective type descriptor for a vendor-defined collective type supported by the switch, the vendor-defined collective type identified by a type encoding within a reserved collective type range, the vendor-defined collective type descriptor defining a collective behavior of the vendor-defined collective type; receiving, at a centralized controller, the vendor-defined collective type descriptor from the switch; and programming, by the centralized controller, the switch to execute the vendor-defined collective type based on the vendor-defined collective type descriptor. The providing step may be triggered during switch admission or upon explicit request from the centralized controller. The vendor-defined collective type descriptor may describe the collective behavior including communication patterns, data transformation operations, and addressing schemes. The programming step may involve the centralized controller transmitting collective group configurations and operational parameters to the switch based on the behavioral information in the descriptor. The centralized controller may program multiple switches with vendor-defined collective types that are mutually supported across the switches in a collective group.

In some implementations of the method, the collective behavior defined in the vendor-defined collective type descriptor comprises at least one of: a data flow direction specifying a communication pattern among the plurality of accelerators, reduction semantics specifying how data from the plurality of accelerators is combined, or an address generation pattern specifying how addresses are computed for data transfers within the vendor-defined collective type. A data flow direction may specify patterns such as one-to-all, all-to-one, or all-to-all. Reduction semantics may specify the arithmetic or logical operation applied to data from multiple accelerators. An address generation pattern may specify how input and output addresses are computed across participating accelerators.

In some implementations of the method, the vendor-defined collective type implements a gradient compression collective configured to selectively transmit gradient values from the plurality of accelerators that exceed a threshold, and reduce the transmitted gradient values. The gradient compression collective may reduce the volume of data transferred during distributed AI training by selectively communicating gradient values that exceed a significance threshold. Gradient values below the threshold may be accumulated locally for transmission in a subsequent collective invocation.

In some implementations of the method, the vendor-defined collective type descriptor further comprises a descriptor version, and upon modification of the vendor-defined collective type, the method further comprises providing, by the switch, an updated vendor-defined collective type descriptor with an incremented descriptor version. The descriptor version may allow the centralized controller to detect when a vendor-defined collective type has been modified and re-program the switch accordingly. Incrementing the version may trigger re-validation of collective groups utilizing the modified collective type.

In some implementations of the method, the vendor-defined collective type implements an all-to-all exchange collective configured to transfer distinct data segments from each accelerator of the plurality of accelerators to every other accelerator of the plurality of accelerators. An all-to-all exchange collective may be utilized in model-parallel AI workloads where each accelerator holds a different partition of a model and transmits its partition results to every other accelerator for aggregation or further processing.

In some implementations, the method further comprises updating, by the centralized controller via the management interface, firmware on the switch implementing the vendor-defined collective type, wherein the updating modifies the collective behavior of the vendor-defined collective type; and receiving, at the centralized controller, an updated vendor-defined collective type descriptor from the switch reflecting the modified collective behavior. Updating firmware on the switch may add new vendor-defined collective types or modify the behavior of existing ones. The updated descriptor may reflect the modified collective behavior, enabling the centralized controller to re-program the switch based on the current capabilities after the firmware update.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

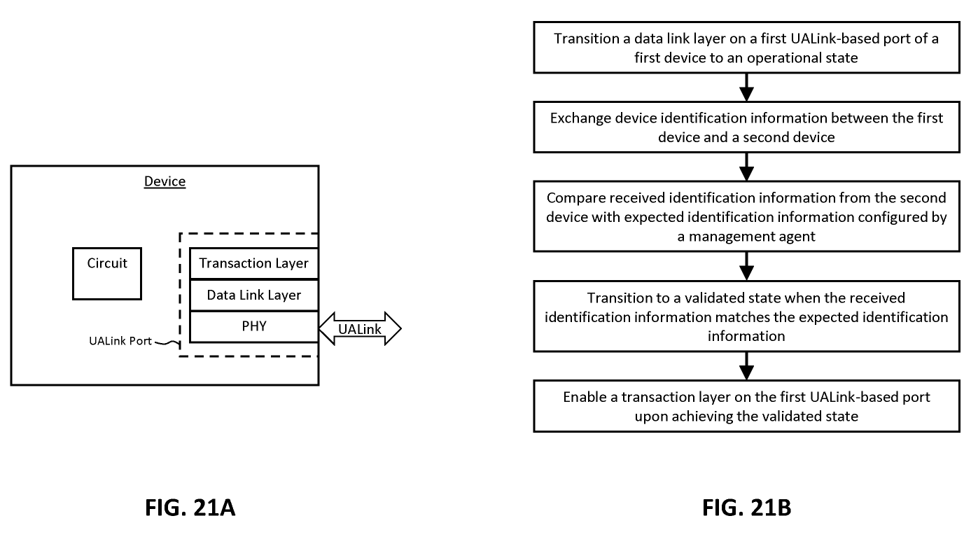

FIG. 21A illustrates accelerators coupled to one or more switches via high-bandwidth links supporting a protocol level interface. Each link may connect an accelerator port to a switch port. Before higher-layer protocols are enabled on a port, the device may verify that the link partner on the other end of the physical link is the expected device. This verification may be performed at the data link layer by exchanging device identification messages after the data link layer reaches an operational state. A circuit on each device may compare the received identification information with expected values pre-configured by a management agent. When the received information matches the expected information, the circuit may transition to a validated state, enabling the transaction layer and protocol level interface on that port. When the information does not match, the circuit may transition to an invalid state, and the port may be blocked from carrying transactions regardless of administrative configuration. This hardware-enforced gate may prevent misrouted transactions due to incorrect cabling, unauthorized cross-tenant communication, or silent data corruption. The mechanism may operate at each port independently, and each device in the network may implement the validation circuit.

In various implementations, a device for an Ultra Accelerator Link (UALink)-based network, comprising: a UALink-based port comprising a data link layer and a transaction layer; the data link layer configured to exchange device identification messages with a link partner after the data link layer reaches an operational state; a circuit configured to compare received device identification information from the link partner with expected device identification information configured by a management agent; and wherein the transaction layer is gated by the circuit, the transaction layer being enabled when the circuit indicates a validated state, and the UALink-based port being blocked from carrying transactions when the circuit indicates an invalid state. The device may be an accelerator or a switch in the network. The port may include a physical layer, a data link layer, a transaction layer, and a protocol level interface arranged in a protocol stack, where enabling each higher layer depends on successful operation of the lower layers. The circuit may be implemented as hardware logic within the device, and the validated and invalid states may be maintained in registers accessible to the management agent for reporting but not overridable by software. The data link layer may reach the operational state after completing link training at the physical layer and exchanging a series of initialization messages at the data link layer. The expected device identification information may include a device identifier, a device type, and a port number that the management agent programs into the circuit before enabling the physical layer and data link layer on the port.

In some implementations of the device, the device identification messages comprise: a device identifier request carrying a device identifier and a device type field indicating at least one of: a switch or an accelerator, and a corresponding response; and a port number request carrying a port number and a corresponding response. The device identifier request may carry the requesting device's own identifier and type, and the link partner may respond with its own identifier and type. Similarly, the port number request may carry the requesting device's own port number. Each message type may follow a request-response pattern where one outstanding request is permitted at a time.

In some implementations of the device, the link partner is required to respond to each device identification message within a response timeout, and wherein the circuit transitions to the invalid state when the response is not received within the response timeout. The response timeout may prevent the circuit from remaining indefinitely in a discovering state when the link partner is unresponsive or malfunctioning. Upon timeout, the circuit may report the invalid state to the management agent for diagnostic purposes.

In some implementations of the device, the circuit supports independently configurable checks comprising: a device identifier and type check, and a port number check, each independently enabled or disabled by the management agent; and wherein when all checks are disabled, the circuit transitions directly to the validated state without performing comparisons. The independently configurable checks may allow flexible deployment configurations. In environments where cabling is pre-verified, all checks may be disabled to reduce initialization latency. In multi-tenant environments, all checks may be enabled for maximum safety. Partial configurations may enable device identifier checking while disabling port number checking, or vice versa.

In some implementations of the device, enabling the transaction layer further requires: a configured transaction layer admin state of enabled, and the data link layer being in an operational-up state; and wherein all three conditions are required for the transaction layer to be enabled. The three-condition gate may provide defense-in-depth: the administrative state allows management control, the data link operational state confirms link health, and the validation state confirms correct connectivity. All three conditions being true may be required before the transaction layer begins credit exchange and protocol level interface connection handshake.

In some implementations of the device, the invalid state is hardware-enforced, and the UALink-based port remains blocked from carrying transactions in the invalid state regardless of a configuration of the transaction layer admin state by the management agent. The hardware enforcement may prevent a compromised or misconfigured management agent from overriding the validation gate to force traffic on a miscabled link. The invalid state may be exited by re-executing the validation sequence with correct expected neighbor information.

In some implementations of the device, the UALink-based port transitions through ordered initialization sub-steps comprising physical layer training, data link layer bringup, neighbor validation, route installation, and transaction layer bringup, wherein each sub-step gates enablement of the subsequent sub-step. The ordered gating may prevent higher-layer protocols from being enabled prematurely. For example, neighbor validation may complete before forwarding entries are installed, and forwarding entries may be installed before the transaction layer begins credit exchange. This ordering may prevent transactions from flowing through incorrect routes during initialization.

In some implementations of the device, when any sub-step fails, the UALink-based port transitions to an operationally-down state with a reason identifying which protocol layer failed, and a management agent reports the reason to a centralized controller. The reason may distinguish between physical layer failure, data link layer failure, transaction layer failure, and protocol level interface failure. The centralized controller may use the reason to select an appropriate recovery strategy targeting the specific failed layer.

In some implementations of the device, the UALink-based port supports a degraded operational state in which the UALink-based port continues to carry transactions despite recoverable errors exceeding a threshold, with a link quality indicator reporting a health level of the UALink-based port. The link quality indicator may transition between healthy, marginal, and unhealthy levels based on error rate heuristics. The degraded state may allow continued operation while alerting the management plane that the port is experiencing elevated errors and may require maintenance.

In some implementations of the device, upon a link width change event on the UALink-based port, the data link layer re-exchanges device identification messages with the link partner, and the circuit re-validates the received device identification information against the expected device identification information. Link width changes may occur during link folding or link resiliency events where the number of active physical lanes changes. Re-validation after a width change may confirm that the link partner has not changed and that the connection remains correctly established.

In some implementations of the device, the circuit transitions through states comprising: a none state upon reset; a configured state when the management agent programs the expected device identification information; a discovering state when the data link layer reaches the operational state; the validated state when received information matches expected information; the invalid state when received information does not match or a timeout occurs; and an operating state when the transaction layer is enabled. The six states may represent a complete lifecycle of the validation process from initial reset through active operation. The none state may be the default after device power-on or reset. The transition from validated to operating may occur when all enablement preconditions are satisfied.

In some implementations of the device, the management agent configures the expected device identification information on the circuit before enabling a physical layer and the data link layer of the UALink-based port. Configuring expected neighbor information before enabling the physical and data link layers may allow the circuit to begin validation as soon as the data link layer reaches the operational state, without requiring a separate configuration step after link training completes.

FIG. 21B illustrates a method for validating connectivity in an accelerator interconnect network, which may be performed at each device in the network. The method may involve exchanging device identification information at the data link layer after the link is established, comparing the received information with expected values, and conditionally enabling the transaction layer and protocol level interface based on the comparison result. The method may be implemented in firmware, hardware logic, or a combination thereof, and may be performed on every port of the device independently.

In various implementations, a method for validating connectivity in an Ultra Accelerator Link (UALink)-based network, comprising: transitioning a data link layer on a first UALink-based port of a first device to an operational state, the first UALink-based port coupled to a second UALink-based port of a second device; exchanging, via data link layer messages, device identification information between the first device and the second device; comparing, at the first device, received identification information from the second device with expected identification information configured by a management agent; transitioning to a validated state when the received identification information matches the expected identification information; and enabling a transaction layer on the first UALink-based port upon the validated state being achieved. The method may be performed at both ends of the link independently and concurrently. Each device may compare the identification information it receives from the link partner with the expected values that the management agent programmed before the physical layer and data link layer were enabled. The transition to the validated state may trigger the enablement of the transaction layer and the protocol level interface, which may then begin credit exchange and connection handshake procedures. The method may be performed during initial network bringup, after a link failure and recovery, or after a physical cable change.

In some implementations, the method further comprises transitioning to an invalid state when the received identification information does not match the expected identification information; and blocking the first UALink-based port from carrying transactions in the invalid state regardless of a configuration of a transaction layer admin state. Blocking the port in the invalid state may prevent any transactions from traversing a miscabled link. The blocking may be hardware-enforced, meaning that software configuration of the administrative state may not override the invalid state.

In some implementations of the method, the exchanging comprises: transmitting a device identifier request carrying a device identifier and a device type indicating at least one of: a switch or an accelerator; receiving a corresponding response from the second device; transmitting a port number request carrying a port number; and receiving a corresponding port number response from the second device. The device identifier and port number may be exchanged as separate message types at the data link layer. Each request may carry the transmitting device's own information, and the response may carry the link partner's corresponding information.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

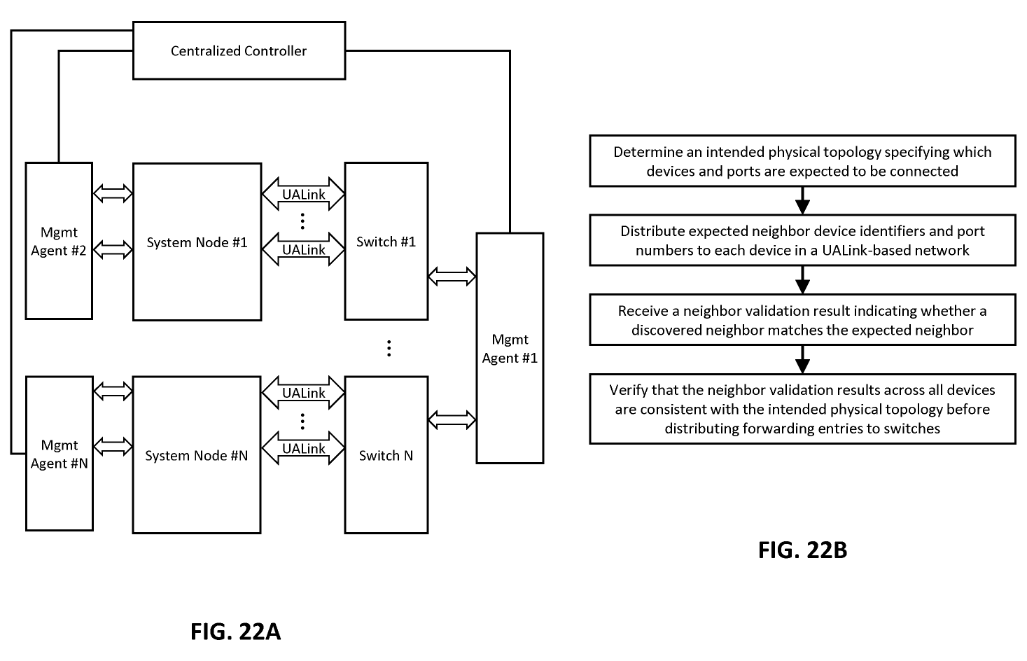

FIG. 22A illustrates a centralized controller that may verify the topology of an accelerator interconnect network at the system level by aggregating neighbor validation results from all devices. The centralized controller may distribute expected neighbor identifiers to each device based on an intended physical topology, and after each device performs its local neighbor validation, the centralized controller may collect the results and verify that the complete set of validation results is consistent with the intended topology. This system-level verification may be performed before the centralized controller distributes forwarding entries, preventing traffic from flowing through an incompletely verified or incorrectly cabled network. The verification may detect individual miswired connections, asymmetric failures, and topology configurations that violate connectivity rules.

In various implementations, a system for verifying topology of an Ultra Accelerator Link (UALink)-based network, comprising: a centralized controller coupled to switches and accelerators via an out-of-band management network; management agents, each managing one or more of the switches or the accelerators; wherein the centralized controller is configured to: distribute expected neighbor identifiers for each port to each device via the management agents based on an intended physical topology; receive neighbor validation results from each device via the management agents; and verify that a complete set of the neighbor validation results is consistent with the intended physical topology before distributing forwarding entries to the switches. The centralized controller may determine the intended physical topology from a configuration database, an administrator-provided specification, or a previously discovered topology. The expected neighbor identifiers may include a device identifier, a device type, and a port number for each port on each device. The centralized controller may distribute these expected values to switch management agents via a control plane protocol and to node management agents via a device management protocol. The centralized controller may wait until all devices report their validation results before verifying topology consistency. The verification may compare each reported neighbor against the expected neighbor and confirm that the aggregated results form a consistent, fully connected topology. Forwarding entries may be withheld until verification completes, preventing transactions from flowing through an unverified network.

In some implementations of the system, the centralized controller is further configured to construct a topology graph from the neighbor validation results and verify that the topology graph satisfies connectivity rules comprising: each of the accelerators has a same number of ports, each of the switches is coupled to each of the accelerators, and all ports use a same bifurcation mode. The connectivity rules may reflect architectural requirements of the network. The uniform port count rule may allow each accelerator to have equal bandwidth to the switches. The full connectivity rule may allow any accelerator to reach any other accelerator through any switch. The uniform bifurcation rule may allow consistent routing across all switches.

In some implementations of the system, the centralized controller is configured to verify that for each link, a switch port's discovered neighbor identifier matches the accelerator port's discovered neighbor identifier, detecting asymmetric failures. Asymmetric failures may occur when one end of a link reports a validated neighbor while the other end reports an invalid neighbor, potentially due to a unidirectional cable fault or a device firmware issue. Cross-validation may catch such failures before traffic is enabled.

In some implementations of the system, the centralized controller is configured to verify that no accelerator in one virtual partition shares a physical switch port with an accelerator in a different virtual partition. Virtual partitions may provide multi-tenant isolation. Verifying physical topology isolation may confirm that routing isolation between virtual partitions is supported by the physical connectivity, preventing potential traffic leakage between tenants. In some examples, a virtual partition refers to a virtual pod (vPod).

In some implementations of the system, when tearing down a virtual partition, a data link layer on affected ports remains active and neighbor validation states remain in the validated state, enabling creation of a new virtual partition on the same physical links without re-executing neighbor discovery. Preserving the data link layer and validation states during teardown may reduce the time required to create a subsequent virtual partition from the same accelerators, because physical layer training and neighbor discovery do not need to be re-executed.

In some implementations of the system, when one or more ports report an invalid neighbor validation result, the centralized controller is configured to identify specific miswired connections based on the invalid results and generate a diagnostic report indicating which ports have incorrect neighbors. The diagnostic report may indicate which physical cable should be moved, what the expected and actual neighbors are for each invalid port, and whether the issue is a cable swap, a missing connection, or an incorrect device placement. The report may reduce mean-time-to-repair during deployment.

In some implementations of the system, after a physical cable change, the centralized controller triggers re-validation on affected ports by cycling a configured neighbor state on the affected ports, without disrupting validated neighbors on unaffected ports. Cycling the configured neighbor state may cause the affected ports to re-enter the discovering state and re-exchange device identification messages with the new link partner. Unaffected ports may remain in the operating state and continue carrying transactions.

FIG. 22B illustrates a method for verifying topology of an accelerator interconnect network at the system level, which may involve a centralized controller determining an intended physical topology, distributing expected neighbor identifiers to each device, receiving validation results, and verifying consistency before enabling traffic. The method may be performed during initial network bringup, after error recovery, or after physical cable changes.

In various implementations, a method for verifying topology of an Ultra Accelerator Link (UALink)-based network, comprising: determining, by a centralized controller, an intended physical topology specifying which devices and ports are expected to be connected; distributing, via management agents over an out-of-band management network, expected neighbor device identifiers and port numbers to each device in the UALink-based network; receiving, from each device via the management agents, a neighbor validation result indicating whether a discovered neighbor matches the expected neighbor; and verifying, by the centralized controller, that the neighbor validation results across all devices are consistent with the intended physical topology before distributing forwarding entries to switches. The centralized controller may determine the intended physical topology from a configuration file, a hardware inventory system, or a previously validated topology stored in non-volatile storage. The expected neighbor identifiers may be distributed to switch management agents via a control plane protocol and to node management agents via a device management protocol. The centralized controller may collect validation results asynchronously as each device completes its local validation, and may proceed with verification once all expected results are received. The method may be performed during initial pod bringup, after a device failure and recovery, or after maintenance operations involving physical cable changes.

In some implementations, the method further comprises constructing, by the centralized controller, a topology graph from the neighbor validation results; and verifying that the topology graph satisfies connectivity rules comprising: each accelerator has a same number of ports, each switch is coupled to each accelerator, and all ports use a same bifurcation mode. The topology graph may represent devices as nodes and validated links as edges. The connectivity rules may be checked against the graph structure to confirm that the network meets architectural requirements before forwarding entries are computed and distributed.

In some implementations, the method further comprises when one or more ports report an invalid neighbor validation result, identifying specific miswired connections based on the invalid results; and generating a diagnostic report indicating which ports have incorrect neighbors. The diagnostic report may include the expected and actual device identifiers and port numbers for each invalid port, enabling an operator to locate and correct the miswired cables. The method may continue without enabling traffic on the invalid ports.

In some implementations, the method further comprises upon determining that the neighbor validation results are not consistent with the intended physical topology, withholding distribution of the forwarding entries and generating an alert indicating which portions of the topology do not match. Withholding forwarding entries may prevent transactions from flowing through an incorrectly cabled network. The alert may be transmitted to an operator or a workload orchestrator, enabling corrective action before traffic is enabled.

In some implementations of the method, a non-transitory computer-readable medium comprising instructions which, when executed by a processor, cause the processor to perform the method.

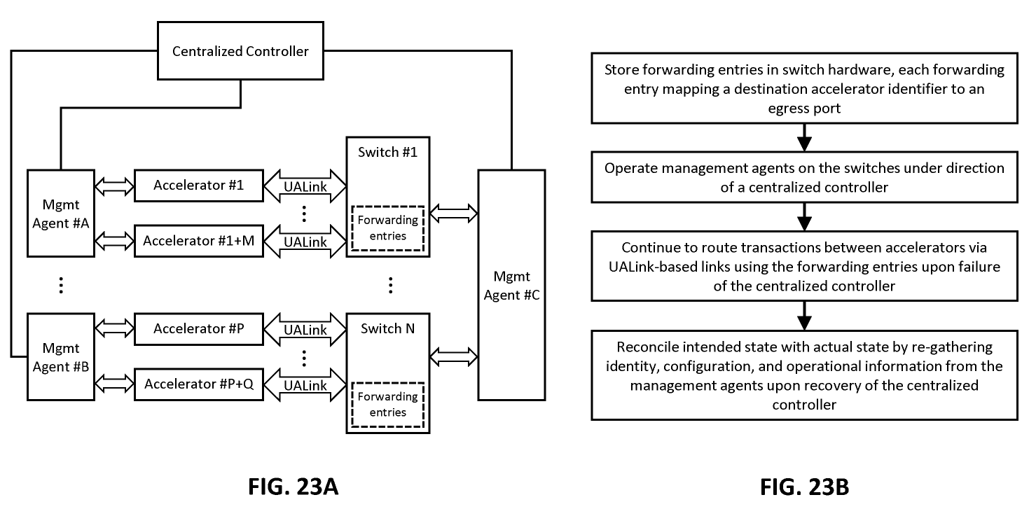

FIG. 23A illustrates a centralized controller generating forwarding entries that direct traffic between accelerators through switches. The forwarding entries may be distributed to the switches via management agents and installed into route tables in the switch hardware. Each forwarding entry may map a destination accelerator identifier to an egress port on a switch, enabling the switch to forward transactions addressed to a particular accelerator out the correct port. A key architectural property of the network may be that the forwarding entries are stored in the switch hardware and persist independently of the centralized controller and the management agents. This hardware persistence may enable continued data plane operation when management plane components fail. No timeout mechanism may cause the forwarding entries to expire, and the management agents may not hold route state that would be lost upon agent failure. When the centralized controller or a management agent fails, executing workloads on the accelerators may continue because the switches continue routing transactions using the persisted forwarding entries. Upon recovery of the centralized controller, the controller may reconcile its intended state with the actual state of the network by re-gathering information from the management agents and correcting any discrepancies.

In various implementations, a system for an Ultra Accelerator Link (UALink)-based network, comprising: a plurality of accelerators coupled to a plurality of switches via UALink-based links, the switches storing forwarding entries in hardware, each forwarding entry mapping a destination accelerator identifier to an egress port; a centralized controller coupled to management agents on the switches via an out-of-band management network, the centralized controller configured to generate and distribute the forwarding entries to the switches via the management agents; wherein the forwarding entries persist in the switches independently of the centralized controller; and wherein when the centralized controller fails, the switches continue routing transactions between the accelerators using the persisted forwarding entries, and executing workloads on the accelerators continue. The switches may store the forwarding entries in hardware route tables within the switch silicon. The route tables may be indexed by destination accelerator identifier and may contain an allow or deny indication and an egress port designation for each entry. The forwarding entries may remain in the route tables regardless of the state of the centralized controller or the management agents, because the route tables are implemented in persistent hardware registers that do not depend on software processes for retention. The centralized controller may generate the forwarding entries based on a topology constructed from identity information and operational state received from the management agents, and may distribute the entries to the switches via the management agents for installation into the route tables. When the centralized controller fails, the management agents may continue operating locally, and the switches may continue forwarding transactions between accelerators using the route tables without any software intervention.

In some implementations of the system, when a management agent managing one or more of the switches fails, executing workloads continue, and the forwarding entries persist in the switch hardware. The management agent managing switches may fail due to software errors, platform reboot, or resource exhaustion. Because the forwarding entries are in switch hardware, the management agent failure may not affect the data plane. The management agent may recover independently and re-gather state from the switches upon restart.

In some implementations of the system, when a management agent managing one or more of the accelerators fails, executing workloads continue. The management agent managing accelerators may fail without affecting executing workloads because the accelerators continue to send and receive transactions via the protocol level interface, and the switches continue routing using the persisted forwarding entries. Recovery of this management agent may be performed in a targeted time to minimize management plane downtime.

In some implementations of the system, no timeout mechanism causes the forwarding entries to expire during failure of the centralized controller. The absence of a route expiration timeout may prevent a scenario where forwarding entries are silently removed after a fixed duration, causing workload failures that would be difficult to diagnose. The forwarding entries may remain installed indefinitely until explicitly modified by the centralized controller upon recovery.

In some implementations of the system, each device in the UALink-based network generates error records in a common platform error record format upon workload-impacting failures, the error records persisting across device reboots and comprising a creator identifier matching a unique device identifier of the generating device. The error records may follow a standardized format that includes a valid record header, a creator identifier field, and a section containing vendor-defined diagnostic information sufficient for debugging common failures. The creator identifier may match the device's unique identifier assigned during device admission, enabling correlation of error records with specific devices during root cause analysis.

In some implementations of the system, the workload-impacting failures are recorded with a fatal error severity classification in the error records. The fatal error severity classification may distinguish workload-impacting failures from informational or warning-level events, enabling automated monitoring systems to prioritize fatal events for immediate attention.

In some implementations of the system, the centralized controller monitors management agent health via keepalive messages over the out-of-band management network, and detects a management agent failure when keepalive responses are not received within a dead interval. The keepalive messages may be exchanged at a configurable interval. The dead interval may be configured as a multiple of the keepalive interval with a jitter factor to avoid synchronized timeouts across multiple management agents. Upon detecting a management agent failure, the centralized controller may prepare for reconnection.

In some implementations of the system, during failure of the centralized controller, ports on the switches that are in an operationally-up state continue to carry transactions, and port operational states persist. Port operational states may include operationally-up, operationally-down, initializing, and degraded. Ports that were operationally-up before the centralized controller failure may remain in that state and continue forwarding transactions. Port state transitions that occur during headless operation, such as a transition from operationally-up to degraded due to increasing errors, may be recorded locally by the management agent for reporting upon controller recovery.

In some implementations, the system further comprises a secondary centralized controller configured to monitor a health of the centralized controller and assume management responsibilities upon failure of the centralized controller. The secondary centralized controller may maintain a synchronized copy of the intended network state and may take over management responsibilities upon detecting primary controller failure. This may provide continuous management without entering headless operation, and may enable faster recovery of the management plane.

In some implementations of the system, during failure of the centralized controller, the management agents continue local management operations comprising monitoring device health and collecting operational state changes from the switches and the accelerators. The management agents may continue to receive asynchronous notifications from the devices, monitor keepalive mechanisms local to each switch platform or system node, and accumulate operational state changes. Upon controller recovery, the management agents may report the accumulated changes to the centralized controller as part of the reconciliation process.

FIG. 23B illustrates a method for maintaining workload continuity during a management failure, comprising the continued use of forwarding entries stored in switch hardware while the centralized controller is unavailable. The method may further involve reconciling the intended network state with the actual state upon controller recovery, including re-gathering identity, configuration, and operational state from all management agents and correcting any discrepancies.

In various implementations, a method for maintaining workload continuity in an Ultra Accelerator Link (UALink)-based network during a management failure, comprising: storing forwarding entries in switch hardware, each forwarding entry mapping a destination accelerator identifier to an egress port; operating management agents on the switches under direction of a centralized controller via an out-of-band management network; upon failure of the centralized controller, continuing to route transactions between accelerators via UALink-based links using the forwarding entries stored in the switch hardware; and upon recovery of the centralized controller, reconciling intended state with actual state by re-gathering identity, configuration, and operational information from the management agents. The method may be applicable to failures of the centralized controller, management agents managing switches, and management agents managing accelerators. In each case, the data plane may continue operating using the forwarding entries stored in switch hardware. The reconciliation upon recovery may involve the centralized controller re-establishing connections to all management agents, comparing re-gathered state with the controller's intended state, and correcting any discrepancies found. The method may enable workload continuity across all management failure types without requiring workload checkpoint or restart.

In some implementations of the method, upon failure of the centralized controller, the management agents continue local management operations comprising monitoring device health and collecting operational state changes. The continued local operations may allow the management agents to maintain an accurate representation of device state that can be reported to the centralized controller upon recovery, enabling efficient differential reconciliation.

In some implementations of the method, no timeout mechanism causes the forwarding entries to expire during failure of the centralized controller. The indefinite persistence of forwarding entries may allow workloads to execute for an unbounded duration during controller failure, limited by factors external to the management plane.

In some implementations of the method, a non-transitory computer-readable medium comprising instructions which, when executed by a processor, cause the processor to perform the method.

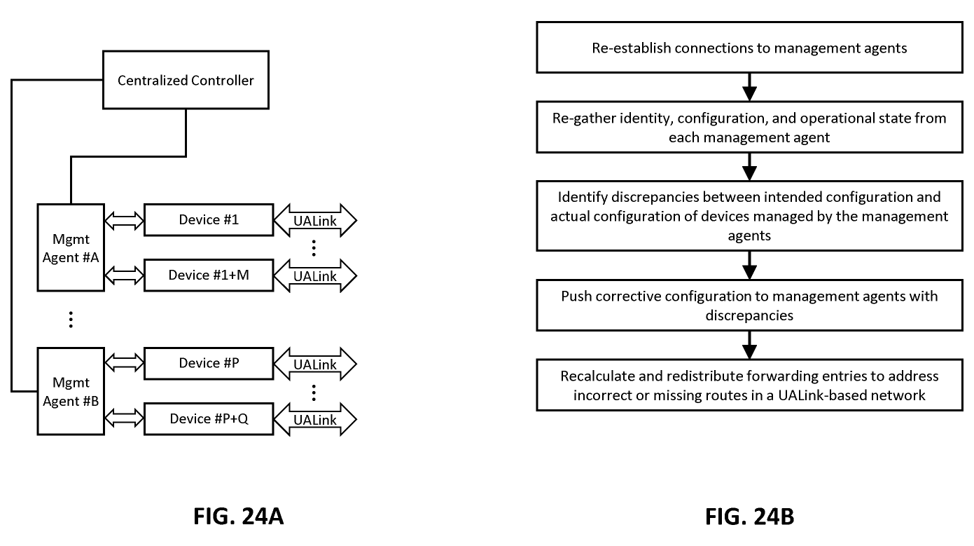

FIG. 24A illustrates system comprising a centralized controller that upon recovery from a failure may execute a reconciliation pipeline to restore management plane consistency. The reconciliation pipeline may involve re-establishing connections to all management agents, re-gathering the current identity, configuration, and operational state of all devices, comparing this re-gathered state with the controller's intended state, identifying and correcting any discrepancies, and recalculating and redistributing forwarding entries to address incorrect or missing routes. The pipeline may be designed to restore data plane correctness as quickly as possible, prioritizing forwarding entry reconciliation over configuration attribute reconciliation. The centralized controller may maintain a cached copy of the last-known state for each management agent, enabling differential reconciliation that identifies the changes that occurred during the disconnection rather than requiring a full re-sweep of all state.

In various implementations, a management system for an Ultra Accelerator Link (UALink)-based network, comprising: a centralized controller coupled to a plurality of management agents via an out-of-band management network, each management agent managing one or more devices in the UALink-based network; wherein upon failure and recovery of the centralized controller, the centralized controller is configured to: re-establish connections to the plurality of management agents via the out-of-band management network; re-gather identity, configuration, and operational state from each management agent; identify discrepancies between intended configuration and actual configuration; push corrective configuration to management agents with discrepancies; and recalculate and redistribute forwarding entries to address incorrect or missing routes in the UALink-based network. The centralized controller may maintain an intended state representing the desired configuration and route tables for the entire network. Upon recovery, the centralized controller may compare the re-gathered state from each management agent with the intended state to determine whether any configuration was lost, modified, or corrupted during the disconnection. The corrective configuration may include device identifiers, virtual partition membership, port administrative states, and neighbor validation parameters. Forwarding entries may be recalculated based on the current operational state, which may have changed if devices failed and recovered during the controller's absence. The redistributed forwarding entries may be installed into switch route tables via the management agents, restoring correct routing for all active virtual partitions.

In some implementations of the system, the centralized controller maintains a cached copy of a last-known state for each management agent, and upon reconnection, performs differential reconciliation by comparing re-gathered state with the cached state to identify changes that occurred during the disconnection. Differential reconciliation may be more efficient than a full re-sweep because the changed state elements need correction. The cached state may include operational attributes of ports, neighbor validation states, and forwarding entry contents at the time of the last successful synchronization.

In some implementations of the system, the centralized controller re-establishes connections to the plurality of management agents concurrently. Concurrent re-connection may minimize total recovery time by initiating connection establishment to all management agents in parallel rather than sequentially. The centralized controller may proceed with re-gathering from each management agent as soon as its connection is established.

In some implementations of the system, the centralized controller prioritizes reconciliation of the forwarding entries over configuration attributes, restoring data plane correctness before management plane completeness. Prioritizing forwarding entry reconciliation may reduce the time during which incorrect routes could affect executing workloads. Configuration attributes such as port naming, administrative metadata, and monitoring parameters may be reconciled after the data plane is confirmed correct.

In some implementations of the system, a management agent presenting a resource tree describing accelerators maintains the resource tree in a stable state across disconnections from the centralized controller and across management agent restarts. The stable resource tree may allow the centralized controller to find the same device model upon reconnection, simplifying the re-gathering process. The resource tree may persist in non-volatile storage or be reconstructed deterministically from hardware enumeration.

In some implementations of the system, upon recovery of a management agent managing one or more switches, the centralized controller collects all forwarding entries from the switches via the recovered management agent to confirm that forwarding state did not change during management agent downtime. Collecting all forwarding entries may allow the centralized controller to compare each installed entry against the intended entry. If all entries match, the centralized controller may confirm that no corrective action is needed and may proceed to reconcile configuration attributes.

In some implementations of the system, upon recovery, the centralized controller gathers error records from all devices, correlates records with matching timestamps across devices to identify systemic failures, and generates a correlated failure report. Correlated error records may indicate systemic issues such as power supply failures, cable degradation, or environmental conditions affecting multiple devices simultaneously. The correlated failure report may assist operators in identifying root causes that individual device error records would not reveal.

In some implementations of the system, upon completing the reconciliation, the centralized controller notifies a workload orchestrator of configuration changes that occurred during the disconnection, enabling the workload orchestrator to take corrective action at an application level. The notification may include which virtual partitions were affected, whether any forwarding entries were modified, and whether any devices experienced failures during the controller's absence. The workload orchestrator may use this information to determine whether workloads need to be restarted, migrated, or can continue operating.

In some implementations of the system, after recovering a failed switch, the centralized controller triggers re-execution of a port bringup sequence on affected ports of the switch, the sequence comprising re-enabling data link layers, re-validating neighbors, and re-installing forwarding entries before enabling the affected ports to carry transactions. The port bringup sequence may follow an ordered set of sub-steps where each sub-step gates the next. Re-enabling data link layers may trigger neighbor discovery, neighbor validation may confirm correct connectivity, and forwarding entry installation may restore correct routing before transactions are permitted.

In some implementations of the system, the centralized controller pre-computes recovery actions for anticipated failure scenarios, enabling faster reconciliation upon actual failure by executing a pre-computed plan rather than computing corrections in real time. Pre-computed recovery plans may include alternate forwarding entry sets for common failure scenarios such as the loss of a single switch, a single accelerator, or a single link. Upon detecting the specific failure, the centralized controller may apply the pre-computed plan, reducing the time required to restore correct routing.

FIG. 24B illustrates a method for recovering management of an accelerator interconnect network, which may be executed by a centralized controller upon recovering from a failure. The method may involve re-establishing connections to all management agents, re-gathering the current state of all devices, and identifying and correcting any discrepancies between the intended and actual network state. The method may prioritize restoring data plane correctness and may use differential comparison with cached pre-failure state to efficiently identify changes.

In various implementations, a method for recovering management of an Ultra Accelerator Link (UALink)-based network after a centralized controller failure, comprising: re-establishing, by the centralized controller, connections to a plurality of management agents via an out-of-band management network; re-gathering identity, configuration, and operational state from each management agent; identifying discrepancies between intended configuration and actual configuration of devices managed by the management agents; pushing corrective configuration to management agents with discrepancies; and recalculating and redistributing forwarding entries to address incorrect or missing routes in the UALink-based network. The method may be performed each time the centralized controller recovers from a failure, whether the failure was caused by a software crash, a hardware reboot, or a network partition. The re-establishing step may involve the centralized controller initiating connection setup with each management agent, including mutual authentication and protocol capability negotiation. The re-gathering step may involve requesting identity information describing device types and firmware versions, configuration information describing assigned identifiers and virtual partition membership, and operational state including port states, neighbor validation results, and link quality indicators. The identifying step may compare the re-gathered state against the intended state that the centralized controller maintained before the failure. The corrective configuration may include any intended configuration that was not yet applied or that was lost during device events that occurred during the failure. The forwarding entry recalculation may account for devices that failed and recovered during the controller's absence.

In some implementations of the method, the re-establishing comprises connecting to the plurality of management agents concurrently, tracking a connection state for each management agent independently, and proceeding with re-gathering from each management agent upon successful connection without waiting for all connections to be established. Independent tracking may allow the centralized controller to begin reconciling devices managed by an already-connected management agent while other management agents are still being contacted. This progressive approach may reduce total recovery time compared to waiting for all connections before beginning any re-gathering.

In some implementations of the method, the identifying discrepancies comprises: comparing the re-gathered identity, configuration, and operational state with a cached copy of a last-known state maintained by the centralized controller before the failure, the cached state comprising operational attributes of ports, neighbor validation states, and forwarding entry contents; and categorizing discrepancies as additions, deletions, or modifications that occurred during the centralized controller failure. Categorizing discrepancies may enable the centralized controller to apply targeted corrections. Additions may represent new devices admitted during the failure. Deletions may represent devices that were removed or failed. Modifications may represent configuration changes made by management agents acting on local policies.

In some implementations, the method further comprises verifying forwarding entries installed in the switches against intended forwarding entries computed by the centralized controller; correcting any forwarding entry mismatches before verifying configuration attributes; and upon completing forwarding entry correction, verifying and correcting configuration attributes comprising accelerator identifiers, virtual partition membership, and port administrative states. Verifying forwarding entries first may minimize the window during which incorrect routes could affect executing workloads. Accelerator identifiers, virtual partition membership, and port administrative states may be reconciled after the data plane routing is confirmed correct.

In some implementations, the method further comprises upon completing the reconciliation, generating a reconciliation report identifying which virtual partitions were affected by changes during the centralized controller failure, whether any forwarding entries were modified or missing, and whether any devices experienced failures; and transmitting the reconciliation report to a workload orchestrator, enabling the workload orchestrator to determine whether affected workloads require restart or can continue. The reconciliation report may include a per-virtual-partition summary of changes, a list of devices that experienced failures and their recovery status, and an overall network health assessment. The workload orchestrator may use this information to reschedule workloads, trigger checkpoints, or confirm that running workloads are unaffected.

In some implementations of the method, a non-transitory computer-readable medium comprising instructions which, when executed by a processor, cause the processor to perform the method.

The term "Ultra Accelerator Link" (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term "PCI Express" (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

Various implementations described herein involve circuits. The term "circuit" refers to a device, an integrated circuit (IC), a die, a chiplet, or a system that includes at least a processing element configured to perform a function. This definition encompasses a wide range of implementations, including but not limited to: combinational logic, sequential logic, discrete logic circuits, programmable logic devices, embedded controllers, computers, accelerators, GPUs, FPGAs, ASICs, DSPs, System-on-Chip (SoC) designs, chiplet dies, accelerator dies, System-in-Package (SiP) devices, switch devices, and ICs incorporating processing capabilities. The processing element may be of any type, including combinational logic gates, a state machine, a lookup table, a microcontroller, a microprocessor, a single-core or multi-core processor, a firmware-controlled engine, or any combination thereof. The circuit may optionally include memory, which may include registers, buffers, volatile or non-volatile storage media, or retention memory that preserves state across reset events. The circuit may optionally include a communication interface allowing the processing element to send and/or receive data, signals, or instructions, which may include die-to-die interfaces, UALink-based ports, data link layers, physical layers, out-of-band management interfaces, or other arrangements facilitating data exchange. References to a "circuit" include any collection of one or more circuits that individually or jointly perform a function, meaning that the singular term "circuit" is intended to imply one or more circuits, which jointly perform the functions attributed to "the circuit."

The terms "port" and "interface" may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context.

Herein, terms such as send/ sending, receive/ receiving, communicate/ communicating, or exchange/ exchanging when used to describe elements (e.g., circuit, processor, computer, host, semiconductor device, switch, port, interface) involved in data, message, packet, or other information exchanges, may refer to direct or indirect operation(s) that facilitate information transfer to/ from/ between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of "a port/interface configured to communicate with an entity" refer to direct or indirect coupling between the port/interface and the entity.

References to a protocol "based on" a specific standard or an industry standard (such as a protocol based on UALink, a UALink-based protocol, a protocol based on CXL, or a CXL-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a UALink-based protocol may encompass implementations that add vendor-defined fields, packets, or commands while preserving the essential accelerator-to-accelerator communication model.

References to a protocol-based port (such as a CXL-based port or a UALink-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a UALink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, "non-transitory computer-readable medium" refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The "computer-implemented methods" described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as "an implementation”, "various implementations”, "some implementations”, "one or more implementations”, "an embodiment”, "some embodiments”, "one embodiment”, "an aspect”, "a configuration”, "an example”, and similar phrases are used herein for convenience and do not imply that a disclosure relating to such phrase(s) is essential to the subject technology or that such disclosure applies to all implementations of the subject technology. Phrases such as "an implementation", "some implementations", or “various implementations” may refer to one or more implementations and vice versa, and this applies similarly to other foregoing phrases. Distinct references, including terms such as "one implementation”, "another implementation”, "various implementations”, or "some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of "X is indicative of Y" mean that X includes information correlated with Y and/or describing Y, up to the case wherein X equals Y. Sentences in the form of "provide/receive an indication (of whether X happened)" may refer to any indication method. The word "most" of something is defined as above 51% of the something (including 100% of the something). The words "portion", "subset", "region", and "area" of something refer to a value between a non-zero fraction of the something and 100% of the something, inclusive; they indicate an open-ended claim language, thus, for example, sentences in the form of "a portion of the memory" or "a subset of the memory" encompass anything from just a small part of the memory to the entire memory, optionally together with additional memory region(s). Sentences in the form of "access the memory" encompass accessing at least a portion of the memory, where the portion may range from a minimal addressable unit to the entire memory capacity, indicating an open-ended claim language. "Coupled" indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of "a" or "an" refers to one or more things. The phrase "based on" indicates an open-ended claim language, and encompasses "based, at least in part, on". Additionally, stating that a value is calculated "based on X" and following that, in a certain implementation, that the value is calculated "also based on Y", means that in the certain implementation, the value is calculated based on X and Y. Variations of the terms "utilize" and "use" indicate an open-ended claim language, such that sentences in the form of "detecting X utilizing Y" are intended to mean "detecting X utilizing at least Y", and sentences in the form of "use X to calculate Y" are intended to mean "calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction 'and' or 'or'. A predetermined, predefined, or preselected value is a fixed value and/or a value determined before performing a calculation that utilizes the predetermined value. When appropriate, the word "value" may indicate a predetermined value. The word "threshold" indicates a threshold whose value, and/or the logic used to determine whether the threshold is reached, is established prior to performing the computation that utilizes the threshold, whether the threshold value is fixed, predefined, or dynamically determined.

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of "One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages" are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of "An active cable comprising first and second pluggable modules coupled by a physical medium; wherein the active cable further comprises hardware circuitry, integrated into the active cable, configured to perform the method of claim X" are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of "An apparatus configured to operate as a switch, wherein the apparatus comprises switching circuitry and is configured to perform the method of claim X" are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

1. A network management system comprising: a centralized controller; a management agent associated with one or more switches in an Ultra Accelerator Link (UALink)-based network, the management agent configured to locally manage the one or more switches on behalf of the centralized controller; and a connection between the centralized controller and the management agent; wherein the centralized controller and the management agent are configured to synchronize state through a plurality of ordered phases over the connection comprising: the centralized controller and the management agent negotiate communication parameters; the management agent transmits identity information of the one or more switches and ports on the one or more switches to the centralized controller; the centralized controller transmits intended configuration for the one or more switches and the ports to the management agent; the management agent transmits current operational state of the one or more switches and the ports to the centralized controller; and the centralized controller transmits forwarding entries to the management agent for installation on the one or more switches.

2. The system of claim 1, wherein the ordered phases are executed in a sequential order such that each phase completes before a subsequent phase begins; and wherein upon disconnection and reconnection of the connection, the centralized controller and the management agent are configured to re-execute the ordered phases from a first phase of the ordered phases.

3. The system of claim 1, wherein the negotiation of communication parameters comprises a three-way exchange in which: the centralized controller is configured to transmit first communication parameters including a keepalive interval and a dead interval, with active interval values set to zero; the management agent is configured to validate the first communication parameters, compute active keepalive and active dead intervals as a maximum of received values and locally configured values, and transmit a response comprising the computed active intervals; and the centralized controller is configured to independently compute the active intervals and close the connection when the independently computed active intervals do not match the active intervals received from the management agent.

4. The system of claim 1, wherein the connection includes a keepalive mechanism, the keepalive mechanism comprising: the management agent configured to transmit a keepalive message when no other message has been transmitted within an active keepalive interval; the centralized controller configured to respond to the keepalive message; and the centralized controller and the management agent each configured to close the connection when no message is received within an active dead interval; wherein the active dead interval is greater than the active keepalive interval, and wherein a timer for the active dead interval is reset upon receipt of a message on the connection.

5. The system of claim 1, wherein during the phase in which the management agent transmits identity information, the management agent is configured to transmit the identity information in an order comprising: identity of the management agent, followed by identity of the one or more switches, followed by identity of the ports on the one or more switches.

6. The system of claim 1, wherein during the phase in which the centralized controller transmits intended configuration, the centralized controller is configured to transmit switch-level configuration before port-level configuration for the one or more switches; and wherein the management agent is configured to not transmit operational state updates during the phase in which the centralized controller transmits intended configuration.

7. The system of claim 1, wherein the ordered phases further comprise a subsequent phase following the phase in which the centralized controller transmits forwarding entries; wherein the centralized controller is configured to transmit a transition message indicating entry into the subsequent phase; and wherein during the subsequent phase, configuration updates, forwarding entry updates, and operational state changes are exchanged bidirectionally between the centralized controller and the management agent over the connection.

8. The system of claim 1, wherein the centralized controller is configured to maintain independent connections with a plurality of management agents, each connection progressing through the ordered phases independently of other connections; and wherein the centralized controller is further configured to aggregate operational state received from the plurality of management agents and generate the forwarding entries based on the aggregated operational state.

9. The system of claim 1, wherein the one or more switches comprise UALink-based switches coupling a plurality of accelerators, and wherein the forwarding entries each map a destination accelerator identifier to an egress port on a respective UALink-based switch; and wherein the centralized controller is configured to assign a unique accelerator identifier to each of the plurality of accelerators.

10. The system of claim 1, wherein the negotiation of communication parameters further comprises negotiation of message encoding formats between the centralized controller and the management agent, wherein both the centralized controller and the management agent support at least one common encoding format; and wherein at least two messages sent over the connection are encoded utilizing at least two different encoding formats, respectively.

11. The system of claim 1, further comprising a standby controller configured to receive replicated state from the centralized controller; wherein the standby controller does not maintain an active connection with the management agent; and wherein upon failure of the centralized controller, the standby controller is configured to promote to a primary role and establish a connection with the management agent, executing the ordered phases from a first phase of the ordered phases.

12. A method for synchronizing state between a centralized controller and a management agent in an Ultra Accelerator Link (UALink)-based network, comprising: negotiating, between the centralized controller and the management agent, communication parameters over a connection; receiving, at the centralized controller from the management agent, identity information of one or more switches and ports on the one or more switches; transmitting, from the centralized controller to the management agent, intended configuration for the one or more switches and the ports; receiving, at the centralized controller from the management agent, current operational state of the one or more switches and the ports; and transmitting, from the centralized controller to the management agent, forwarding entries for installation on the one or more switches.

13. The method of claim 12, further comprising: receiving, at the centralized controller, a workload communication pattern from a workload orchestrator; and generating the forwarding entries based on the workload communication pattern to reduce latency for collective operations specified in the workload communication pattern.

14. The method of claim 12, further comprising: comparing, by the centralized controller, timestamps associated with the current operational state against previously cached timestamps for the same state objects; discarding operational state updates having timestamps older than the cached timestamps; and logging the discarded operational state updates for diagnostic purposes.

15. The method of claim 12, further comprising: receiving, at the centralized controller from the management agent, an operational state change indicating a port failure on a switch of the one or more switches; recalculating affected forwarding entries based on the operational state change; and distributing updated forwarding entries to the management agent.

16. The method of claim 12, further comprising: maintaining, by the centralized controller, independent connections with a plurality of management agents; receiving identity information and current operational state from the plurality of management agents via the independent connections; and generating the forwarding entries based on aggregated operational state received from the plurality of management agents.

17. A non-transitory computer-readable medium comprising instructions which, when executed by a processor, cause the processor to perform the method of claim 12.

18. A network management system comprising: a centralized controller; a management agent associated with one or more switches in an Ultra Accelerator Link (UALink)-based network, the management agent configured to locally manage the one or more switches on behalf of the centralized controller; and a bidirectional streaming connection between the centralized controller and the management agent, the bidirectional streaming connection configured to carry messages in both directions concurrently, each message comprising a phase identifier indicating a current protocol phase; wherein the centralized controller and the management agent are configured to synchronize state over the bidirectional streaming connection through a plurality of ordered phases comprising: the centralized controller and the management agent negotiate communication parameters including keepalive and dead interval values; the management agent transmits identity information of the one or more switches and ports on the one or more switches to the centralized controller; the centralized controller transmits intended configuration for the one or more switches and the ports to the management agent; the management agent transmits current operational state of the one or more switches and the ports to the centralized controller; and the centralized controller transmits forwarding entries to the management agent for installation on the one or more switches.

19. The system of claim 18, wherein the ordered phases are executed in a sequential order such that each phase completes before a subsequent phase begins; and wherein the centralized controller and the management agent are each configured to close the bidirectional streaming connection upon receiving a message with a phase identifier inconsistent with the current protocol phase.

20. The system of claim 18, wherein the one or more switches couple a plurality of accelerators via the UALink-based network; wherein the forwarding entries are installed into route tables on the one or more switches, each route table indexed by a destination accelerator identifier;
and wherein the route tables control routing of UALink Protocol Level Interface (UPLI) transactions between the plurality of accelerators.
